(19) United States
(12) Patent Application Publication
(10) Pub. No.: US 2006/0064716 A1
(43) Pub. Date: Mar. 23, 2006

(54) Techniques for navigating multiple video streams

(75) Inventors: Sanghoon Sull, Seoul (KR); Hyeokman Kim, Seoul (KR); Yeon-Seok Seong, Incheon (KR); Michael D. Rostoker, Boulder Creek, CA (US); Jung Rim Kim, Seoul (KR)

Correspondence Address: D.A. STAUFFER PATENT SERVICES LLC, 1006 MONTFORD ROAD, CLEVLAND HTS., OH, 44121-2016, US

(73) Assignee: Vivcom, Inc., Palo Alto, CA (US)

(21) Appl. No.: 11/221,397

(22) Filed: Sep. 7, 2005

Related U.S. Application Data
(63) Continuation-in-part of application No. 09/911,293, filed on Jul. 23, 2001.
(60) Provisional application No. 60/221,394, filed on Jul. 24, 2000.
(60) Provisional application No. 60/221,843, filed on Jul. 28, 2000.
(60) Provisional application No. 60/222,373, filed on Jul. 31, 2000.
(60) Provisional application No. 60/271,908, filed on Feb. 27, 2001.
(60) Provisional application No. 60/291,728, filed on May 17, 2001.

(51) Int. Cl. H04N 5/445; H04N 5/44; G06F 17/00; G06F 17/21

(52) U.S. Cl. 725/37; 715/716; 715/838; 715/500.1

(57) ABSTRACT

Techniques for poster-thumbnail and/or animated thumbnail development and/or usage to effectively navigate for potential selection between a plurality of images or programs/video files or video segments. The poster and animated thumbnail images are presented in a GUI on adapted apparatus to provide an efficient system for navigating, browsing and/or selecting images or programs or video segments to be viewed by a user. The poster and animated thumbnails may be automatically produced without human-necessary editing and may also have one or more various associated data (such as text overlay, image overlay, cropping, text or image deletion or replacement, and/or associated audio).

### CROSS-REFERENCE TO RELATED APPLICATIONS

All of the below-referenced applications for which priority claims are being made, or for which this application is a continuation-in-part of, are incorporated in their entirety by reference herein.

This application is a continuation-in-part of U.S. patent application Ser. No. 09/911,293 filed 23 Jul. 2001 which claims benefit of the following five provisional patent applications:
U.S. Provisional Application No. 60/221,394 filed 24 Jul. 2000;
U.S. Provisional Application No. 60/221,843 filed 28 Jul. 2000;
U.S. Provisional Application No. 60/222,373 filed 31 Jul. 2000;
U.S. Provisional Application No. 60/271,908 filed 27 Feb. 2001; and
U.S. Provisional Application No. 60/291,728 filed 17 May 2001.

This application is a continuation-in-part of U.S. patent application Ser. No. 10/361,794 filed Feb. 10, 2003 (published as U.S. 2004/0126021 on Jul. 1, 2004), which claims benefit of U.S. Provisional Application No. U.S. Ser. No. 60/359,564 filed Feb. 25, 2002, and which is a continuation-in-part of the above-referenced U.S. patent application Ser. No. 09/911,293 filed Jul. 23, 2001 which claims benefit of the five provisional applications listed above.

This application is a continuation-in-part of U.S. patent application Ser. No. 10/365,576 filed Feb. 12, 2003 (published as U.S. 2004/0128317 on Jul. 1, 2004), which claims benefit of U.S. Provisional Application No. 60/359,566 filed Feb. 25, 2002 and of U.S. Provisional Application No. 60/434,173 filed Dec. 17, 2002, and of U.S. Provisional Application No. 60/359,564 filed Feb. 25, 2002, and which is a continuation-in-part of U.S. patent application Ser. No. 10/361,794 filed Feb. 10, 2003 (published as U.S. 2004/0126021 on Jul. 1, 2004), which claims benefit of U.S. Provisional Application No. U.S. Ser. No. 60/359,564 filed Feb. 25, 2002, and which is a continuation-in-part of the above-referenced U.S. patent application Ser. No. 09/911,293 filed Jul. 23, 2001 which claims benefit of the five provisional applications listed above.

This application is a continuation-in-part of U.S. patent application Ser. No. 10/369,333 filed Feb. 19, 2003 (published as U.S. 2003/0177503 on Sep. 18, 2003), which is a continuation-in-part of the above-referenced U.S. patent application Ser. No. 09/911,293 filed Jul. 23, 2001 which claims benefit of the five provisional applications listed above.

This application is a continuation-in-part of U.S. patent application Ser. No. 11/071,895 filed Mar. 3, 2005, which claims benefit of U.S. Provisional Application No. 60/549,624 filed Mar. 3, 2004 of U.S. Provisional Application No. 60/549,605 filed Mar. 3, 2004 U.S. Provisional Application No. 60/550,534 filed Mar. 5, 2004 and of U.S. Provisional Application No. 60/610,074 filed Sep. 15, 2004, and which is a continuation-in-part of U.S. patent application Ser. No. 09/911,293 filed Jul. 23, 2001 which claims benefit of the five provisional applications listed above, and which is a continuation-in-part of the above-referenced U.S. patent application Ser. No. 10/365,576 filed Feb. 12, 2003 (published as U.S. 2004/0128317 on Jul. 1, 2004), and which is a continuation-in-part of the above-referenced U.S. patent application Ser. No. 10/369,333 filed Feb. 19, 2003 (published as U.S. 2003/0177503 on Sep. 18, 2003), and which is a continuation-in-part of U.S. patent application Ser. No. 10/368,304 filed Feb. 18, 2003 (published as U.S. 2004/0125124 on Jul. 1, 2004) which claims benefit of U.S. Provisional Application No. 60/359,567 filed Feb. 25, 2002.

This application is a continuation-in-part of U.S. patent application Ser. No. 11/071,894 filed Mar. 3, 2005, which claims benefit of U.S. Provisional Application No. 60/550,200 filed Mar. 4, 2004 and of U.S. Provisional Application No. 60/550,534 filed Mar. 5, 2004, and which is a continuation-in-part of U.S. patent application Ser. No. 09/911,293 filed Jul. 23, 2001 which claims benefit of the five provisional applications listed above, and which is a continuation-in-part of the above-referenced U.S. patent application Ser. No. 10/361,794 filed Feb. 10, 2003 (published as U.S. 2004/0126021 on Jul. 1, 2004), and which is a continuation-in-part of the above-referenced U.S. patent application Ser. No. 10/365,576 filed Feb. 12, 2003 (published as U.S. 2004/0128317 on Jul. 1, 2004).

### TECHNICAL FIELD

This disclosure relates to the processing of video signals, and more particularly to techniques for listing and navigating multiple TV programs or video streams using visual representation of their contents.

### BACKGROUND

Digital vs. Analog Television

In December 1996 the Federal Communications Commission (FCC) approved the U.S. standard for a new era of digital television (DTV) to replace the analog television (TV) system currently used by consumers. The need for a DTV system arose due to the demands for a higher picture quality and enhanced services required by television viewers. DTV has been widely adopted in various countries, such as Korea, Japan and throughout Europe. The DTV system has several advantages over conventional analog TV system to fulfill the needs of TV viewers. The standard definition television (SDTV) or high definition television (HDTV) system allows for much clearer picture viewing, compared to a conventional analog TV system. HDTV viewers may receive high-quality pictures at a resolution of 1920×1080 pixels displayed in a wide screen format with a 16 by 9 aspect (width to height) ratio (as found in movie theatres) compared to analog's traditional analog 4 by 3 aspect ratio. Although the conventional TV aspect ratio is 4 by 3, wide screen programs can still be viewed on conventional TV screens in letter box format leaving a blank screen area at the top and bottom of the screen, or more commonly, by cropping part of each scene, usually at both sides of the image to show only the center 4 by 3 area. Furthermore, the DTV system allows multicasting of multiple TV programs and may also contain ancillary data, such as subtitles, optional, varied or different audio options (such as optional languages), broader formats (such as letterbox) and additional scenes. For example, audiences may have the benefits of better associated audio, such as current 5.1-channel compact disc (CD)-quality surround sound for viewers to enjoy a more complete “home” theater experience.

The U.S. FCC has allocated 6 MHz (megaHertz) bandwidth for each terrestrial digital broadcasting channel which is the same bandwidth as used for an analog National Television System Committee (NTSC) channel. By using video compression, such as MPEG-2, one or more high picture quality programs can be transmitted within the same bandwidth. A DTV broadcaster thus may choose between various standards (for example, HDTV or SDTV) for transmission of programs. For example, Advanced Television Systems Committee (ATSC) has 18 different formats at various resolutions, aspect ratios, frame rates examples and descriptions of which may be found at “ATSC Standard A/53C with Amendment No. 1: ATSC Digital Television Standard”, Rev. C, 21 May 2004 (see World Wide Web at atsc.org). Pictures in digital television system are scanned in either progressive or interlaced modes. In progressive mode, a frame picture is scanned in a raster-scan order, whereas, in interlaced mode, a frame picture consists of two temporally-alternating field pictures each of which is scanned in a raster-scan order. A more detailed explanation on interlaced and progressive modes may be found at “Digital Video: An Introduction to MPEG-2 (Digital Multimedia Standards Series)” by Barry G., Atul Puri, Arun N. Netravali. Although SDTV will not match HDTV in quality, it will offer a higher quality picture than current or recent analog TV.

Digital broadcasting also offers entirely new options and forms of programming. Broadcasters will be able to provide additional video, image and/or audio (along with other possible data transmission) to enhance the viewing experience of TV viewers. For example, one or more electronic program guides (EPGs) which may be transmitted with a video (usually a combined video plus audio with possible additional data) signal can guide users to channels of interest. An EPG contains the information on programming characteristics such as program title, channel number, start time, duration, genre, rating, and a brief description of a program's content. The most common digital broadcasts and replays (for example, by video compact disc (VCD) or digital video disc (DVD)) involve compression of the video image for storage and/or broadcast with decompression for program presentation. Among the most common compression standards (which may also be used for associated data, such as audio) are JPEG and various MPEG standards.

Digital TV Formats

The 1080i (1920×1080 pixels interlaced), 1080p (1920×1080 pixels progressive) and 720p (1280×720 pixels progressive) formats in a 16:9 aspect ratio are the commonly adopted acceptable HDTV formats. The 480i (640×480 pixels interlaced in a 4:3 aspect ratio or 704×480 in a 16:9 aspect ratio), and 480p (640×480 pixels progressive in a 4:3 aspect ratio or 704×480 in a 16:9 aspect ratio) formats are SDTV formats. A more detailed explanation can be found at “Digital Video: An Introduction to MPEG-2 (Digital Multimedia Standards Series)” by Barry G. Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org).

JPEG

JPEG (Joint Photographic Experts Group) is a standard for still image compression. The JPEG committee has developed standards for the lossy, lossless, and nearly lossless compression of still images, and the compression of continuous-tone, still-frame, monochrome, and color images. The JPEG standard provides three main compression techniques from which applications can select elements satisfying their requirements. The three main compression techniques are (i) Baseline system, (ii) Extended system and (iii) Lossless mode technique. The Baseline system is a simple and efficient Discrete Cosine Transform (DCT)-based algorithm with Huffman coding restricted to 8 bits/pixel inputs in sequential mode. The Extended system enhances the baseline system to satisfy broader application with 12 bits/pixel inputs in hierarchical and progressive mode and the Lossless mode is based on predictive coding, DPCM (Differential Pulse Coded Modulation), independent of DCT with either Huffman or arithmetic coding.

JPEG Compression

An example of JPEG encoder block diagram may be found at Compressed Image File Formats: JPEG, PNG, GIF, XBM, BMP (ACM Press) by John Miano, more complete technical description may be found ISO/IEC International Standard 10918-1 (see World Wide Web at jpeg.org/jpeg/). An original picture, such as a video frame image is partitioned into 8×8 pixel blocks, each of which is independently transformed using DCT. DCT is a transform function from spatial domain to frequency domain. The DCT transform is used in various lossy compression techniques such as MPEG-1, MPEG-2, MPEG-4 and JPEG. The DCT transform is used to analyze the frequency component in an image and discard frequencies which human eyes do not usually perceive. A more complete explanation of DCT may be found at “Discrete-Time Signal Processing” (Prentice Hall, 2nd edition, February 1999) by Alan V. Oppenheim, Ronald W. Schafer, John R. Buck. All the transform coefficients are uniformly quantized with a user-defined quantization table (also called a q-table or normalization matrix). The quality and compression ratio of an encoded image can be varied by changing elements in the quantization table. Commonly, the DC coefficient in the top-left of a 2-D DCT array is proportional to the average brightness of the spatial block and is variable-length coded from the difference between the quantized DC coefficient of the current block and that of the previous block. The AC coefficients are rearranged to a 1-D vector through zigzag scan and encoded with run-length encoding. Finally, the compressed image is entropy coded, such as by using Huffman coding. The Huffman coding is a variable-length coding based on the frequency of a character. The most frequent characters are coded with fewer bits and rare characters are coded with many bits. A more detailed explanation of Huffman coding may be found at “Introduction to Data Compression” (Morgan Kaufmann, Second Edition, February, 2000) by Khalid Sayood.

A JPEG decoder operates in reverse order. Thus, after the compressed data is entropy decoded and the 2-dimensional quantized DCT coefficients are obtained, each coefficient is de-quantized using the quantization table. JPEG compression is commonly found in current digital still camera systems and many Karaoke “sing-along” systems.

Wavelet

Wavelets are transform functions that divide data into various frequency components. They are useful in many different fields, including multi-resolution analysis in computer vision, sub-band coding techniques in audio and video compression and wavelet series in applied mathematics. They are applied to both continuous and discrete signals. Wavelet compression is an alternative or adjunct to DCT type transformation compression and is considered or adopted for various MPEG standards, such as MPEG-4. A more complete description may be found at “Wavelet transforms: Introduction to Theory and Application” by Raghuveer M. Rao.

MPEG

The MPEG (Moving Pictures Experts Group) committee started with the goal of standardizing video and audio for compact discs (CDs). A meeting between the International Standards Organization (ISO) and the International Electrotechnical Commission (IEC) finalized a 1994 standard titled MPEG-2, which is now adopted as a video coding standard for digital television broadcasting. MPEG may be more completely described and discussed on the World Wide Web at mpeg.org along with example standards. MPEG-2 is further described at “Digital Video: An Introduction to MPEG-2 (Digital Multimedia Standards Series)” by Barry G. Haskell, Atul Puri, Arun N. Netravali and the MPEG-4 described at “The MPEG-4 Book” by Touradj Ebrahimi, Fernando Pereira.

MPEG Compression

The goal of MPEG standards compression is to take analog or digital video signals (and possibly related data such as audio signals or text) and convert them to packets of digital data that are more bandwidth efficient. By generating packets of digital data it is possible to generate signals that do not degrade, provide high quality pictures, and to achieve high signal to noise ratios.

MPEG standards are effectively derived from the JPEG standard for still images. The MPEG-2 video compression standard achieves high data compression ratios by producing information for a full frame video image only occasionally. These full-frame images or intra-coded frames (pictures) are referred to as I-frames. Each I-frame contains a complete description of a single video frame (image or picture) independent of any other frame, and takes advantage of the nature of the human eye and removes redundant information in the high frequency which humans traditionally cannot see. These I-frame images act as anchor frames (sometimes referred to as reference frames) that serve as reference images within an MPEG-2 stream. Between the I-frames, delta-coding, motion compensation, and a variety of interpolative/predictive techniques are used to produce intervening frames. Inter-coded P-frames (predictive-coded frames) and B-frames (bidirectionally predictive-coded frames) are examples of such in-between frames encoded between the I-frames, storing only information about differences between the intervening frames they represent with respect to the I-frames (reference frames). The MPEG system consists of two major layers namely, the System Layer (timing information to synchronize video and audio) and Compression Layer.

The MPEG standard stream is organized as a hierarchy of layers consisting of Video Sequence layer, Group-Of-Pictures (GOP) layer, Picture layer, Slice layer, Macroblock layer and Block layer.

The Video Sequence layer begins with a sequence header (and optionally other sequence headers), and usually includes one or more groups of pictures and ends with an end-of-sequence-code. The sequence header contains the basic parameters such as the size of the coded pictures, the size of the displayed video pictures, bit rate, frame rate, aspect ratio of a video, the profile and level identification, interlace or progressive sequence identification, private user data, plus other global parameters related to a video.

The GOP layer consists of a header and a series of one or more pictures intended to allow random access, fast search and edition. The GOP header contains a time code used by certain recording devices. It also contains editing flags to indicate whether B-pictures following the first I-picture of the GOP can be decoded following a random access called a closed GOP. In MPEG, a video picture is generally divided into a series of GOPs.

The Picture layer is the primary coding unit of a video sequence. A picture consists of three rectangular matrices representing luminance (Y) and two chrominance (Cb and Cr or U and V) values. The picture header contains information on the picture coding type (intra (I), predicted (P), Bidirectional (B) picture), the structure of a picture (frame, field picture), the type of the zigzag scan and other information related for the decoding of a picture. For progressive mode video, a picture is identical to a frame and can be used interchangeably, while for interlaced mode video, a picture refers to the top field or the bottom field of the frame.

A slice is composed of a string of consecutive macroblocks which is commonly built from a 2 by 2 matrix of blocks and it allows error resilience in case of data corruption. Due to the existence of a slice in an error resilient environment, a partial picture can be constructed instead of the whole picture being corrupted. If the bitstream contains an error, the decoder can skip to the start of the next slice. Having more slices in the bitstream allows better error hiding, but it can use space that could otherwise be used to improve picture quality. The slice is composed of macroblocks traditionally running from left to right and top to bottom where all macroblocks in the I-pictures are transmitted. In P- and B-pictures, typically some macroblocks of a slice are transmitted and some are not, that is, they are skipped. However, the first and last macroblock of a slice should always be transmitted. Also the slices should not overlap.

A block consists of the data for the quantized DCT coefficients of an 8 by 8 block in the macroblock. The 8 by 8 blocks of pixels in the spatial domain are transformed to the frequency domain with the aid of DCT and the frequency coefficients are quantized. Quantization is the process of approximating each frequency coefficient as one of a limited number of allowed values. The encoder chooses a quantization matrix that determines how each frequency coefficient in the 8 by 8 block is quantized. Human perception of quantization error is lower for high spatial frequencies (such as color), so high frequencies are typically quantized more coarsely (with fewer allowed values).

The combination of the DCT and quantization results in many of the frequency coefficients being zero, especially those at high spatial frequencies. To take maximum advantage of this, the coefficients are organized in a zigzag order to produce long runs of zeros. The coefficients are then converted to a series of run-amplitude pairs, each pair indicating a number of zero coefficients and the amplitude of a non-zero coefficient. These run-amplitudes are then coded with a variable-length code, which uses shorter codes for commonly occurring pairs and longer codes for less common pairs. This procedure is more completely described in “Digital Video: An Introduction to MPEG-2” (Chapman & Hall, December, 1996) by Barry G. Haskell, Atul Puri, Arun N. Netravali. A more detailed description may also be found at “Generic Coding of Moving Pictures and Associated Audio Information—Part 2: Videos”, ISO/IEC 13818-2 (MPEG-2), 1994 (see World Wide Web at mpeg.org).

Inter-Picture Coding

Inter-picture coding is a coding technique used to construct a picture by using previously encoded pixels from the previous frames. This technique is based on the observation that adjacent pictures in a video are usually very similar. If a picture contains moving objects and if an estimate of their translation in one frame is available, then the temporal prediction can be adapted using pixels in the previous frame that are appropriately spatially displaced. The picture type in MPEG is classified into three types of picture according to the type of inter prediction used. A more detailed description of Inter-picture coding may be found at “Digital Video: An Introduction to MPEG-2” (Chapman & Hall, December, 1996) by Barry G. Haskell, Atul Puri, Arun N. Netravali.

Picture Types

The MPEG standards (MPEG-1, MPEG-2, MPEG-4) specifically define three types of pictures (frames) Intra (I), Predictive (P), and Bidirectionally-predictive (B).

Intra (I) pictures are pictures that are traditionally coded separately only in the spatial domain by themselves. Since intra pictures do not reference any other pictures for encoding and the picture can be decoded regardless of the reception of other pictures, they are used as an access point into the compressed video. The intra pictures are usually compressed in the spatial domain and are thus large in size compared to other types of pictures.

Predictive (P) pictures are pictures that are coded with respect to the immediately previous I- or P-picture. This technique is called forward prediction. In a P-picture, each macroblock can have one motion vector indicating the pixels used for reference in the previous I- or P-pictures. Since the P-picture can be used as a reference picture for B-pictures and future P-pictures, it can propagate coding errors. Therefore the number of P-pictures in a GOP is often restricted to allow for a clearer video.

Bidirectionally-predictive (B) pictures are pictures that are coded by using immediately previous I- and/or P-pictures as well as immediately next I- and/or P-pictures. This technique is called bidirectional prediction. In a B-picture, each macroblock can have one motion vector indicating the pixels used for reference in the previous I- or P-pictures and another motion vector indicating the pixels used for reference in the next I- or P-pictures. Since each macroblock in a B-picture can have up to two motion vectors, where the macroblock is obtained by averaging the two macroblocks referenced by the motion vectors, this results in the reduction of noise. In terms of compression efficiency, the B-pictures are the most efficient, P-pictures are somewhat worse, and the I-pictures are the least efficient. The B-pictures do not propagate errors because they are not traditionally used as a reference picture for inter-prediction.

Video Stream Composition

The number of I-frames in a MPEG stream (MPEG-1, MPEG-2 and MPEG-4) may be varied depending on the applications needed for random access and the location of scene cuts in the video sequence. In applications where random access is important, I-frames are used often, such as two times a second. The number of B-frames in between any pair of reference (I or P) frames may also be varied depending on factors such as the amount of memory in the encoder and the characteristics of the material being encoded. A typical display order of pictures may be found at “Digital Video: An Introduction to MPEG-2 (Digital Multimedia Standards Series)” by Barry G. Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org). The sequence of pictures is re-ordered in the encoder such that the reference pictures needed to reconstruct B-frames are sent before the associated B-frames. A typical encoded order of pictures may be found at “Digital Video: An Introduction to MPEG-2 (Digital Multimedia Standards Series)” by Barry G. Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org).

Motion Compensation

In order to achieve a higher compression ratio, the temporal redundancy of a video is eliminated by a technique called motion compensation. Motion compensation is utilized in P- and B-pictures at macro block level where each macroblock has a motion vector between the reference macroblock and the macroblock being coded and the error between the reference and the coded macroblock. The motion compensation for macroblocks in P-picture may only use the macroblocks in the previous reference picture (I-picture or P-picture), while macroblocks in a B-picture may use a combination of both the previous and future pictures as a reference pictures (I-picture or P-picture). A more extensive description of aspects of motion compensation may be found at “Digital Video: An Introduction to MPEG-2 (Digital Multimedia Standards Series)” by Barry G. Haskell, Atul Puri, Arun N. Netravali and “Generic Coding of Moving Pictures and Associated Audio Information—Part 2: Videos,” ISO/IEC 13818-2 (MPEG-2), 1994 (see World Wide Web at iso.org).

MPEG-2 System Layer

A main function of MPEG-2 systems is to provide a means of combining several types of multimedia information into one stream. Data packets from several elementary streams (ESs) (such as audio, video, textual data, and possibly other data) are interleaved into a single stream. ESs can be sent either at constant-bit rates or at variable-bit rates simply by varying the lengths or frequency of the packets. The ESs consist of compressed data from a single source plus ancillary data needed for synchronization, identification, and characterization of the source information. The ESs themselves are first packetized into either constant-length or variable-length packets to form a Packetized Elementary Stream (PES).

MPEG-2 system coding is specified in two forms: the Program Stream (PS) and the Transport Stream (TS). The PS is used in relatively error-free environment such as DVD media, and the TS is used in environments where errors are likely, such as in digital broadcasting. The PS usually carries one program where a program is a combination of various ESs. The PS is made of packs of multiplexed data. Each pack consists of a pack header followed by a variable number of multiplexed PES packets from the various ESs plus other descriptive data. The TSs consists of TS packets, such as of 188 bytes, into which relatively long, variable length PES packets are further packetized. Each TS packet consists of a TS header followed optionally by ancillary data (called an adaptation field), followed typically by one or more PES packets. The TS header usually consists of a sync (synchronization) byte, flags and indicators, packet identifier (PID), plus other information for error detection, timing and other functions. It is noted that the header and adaptation field of a TS packet shall not be scrambled.

In order to maintain proper synchronization between the ESs, for example, containing audio and video streams, synchronization is commonly achieved through the use of time stamp and clock reference. Time stamps for presentation and decoding are generally in units of 90 kHz, indicating the appropriate time according to the clock reference with a resolution of 27 MHz that a particular presentation unit (such as a video picture) should be decoded by the decoder and presented to the output device. A time stamp containing the presentation time of audio and video is commonly called the Presentation Time Stamp (PTS) that maybe present in a PES packet header, and indicates when the decoded picture is to be passed to the output device for display whereas a time stamp indicating the decoding time is called the Decoding Time Stamp (DTS). Program Clock Reference (PCR) in the Transport Stream (TS) and System Clock Reference (SCR) in the Program Stream (PS) indicate the sampled values of the system time clock. In general, the definitions of PCR and SCR may be considered to be equivalent, although there are distinctions. The PCR that maybe be present in the adaptation field of a TS packet provides the clock reference for one program, where a program consists of a set of ESs that has a common time base and is intended for synchronized decoding and presentation. There may be multiple programs in one TS, and each may have an independent time base and a separate set of PCRs. As an illustration of an exemplary operation of the decoder, the system time clock of the decoder is set to the value of the transmitted PCR (or SCR), and a frame is displayed when the system time clock of the decoder matches the value of the PTS of the frame. For consistency and clarity, the remainder of this disclosure will use the term PCR. However, equivalent statements and applications apply to the SCR or other equivalents or alternatives except where specifically noted otherwise. A more extensive explanation of MPEG-2 System Layer can be found in “Generic Coding of Moving Pictures and Associated Audio Information—Part 2: Systems,” ISO/IEC 13818-1 (MPEG-2), 1994.

Differences Between MPEG-1 and MPEG-2

The MPEG-2 Video Standard supports both progressive scanned video and interlaced scanned video while the MPEG-1 Video standard only supports progressive scanned video. In progressive scanning, video is displayed as a stream of sequential raster-scanned frames. Each frame contains a complete screen-full of image data, with scanlines displayed in sequential order from top to bottom on the display. The “frame rate” specifies the number of frames per second in the video stream. In interlaced scanning, video is displayed as a stream of alternating, interlaced (or interleaved) top and bottom raster fields at twice the frame rate, with two fields making up each frame. The top fields (also called “upper fields” or “odd fields”) contain video image data for odd numbered scanlines (starting at the top of the display with scanline number 1), while the bottom fields contain video image data for even numbered scanlines. The top and bottom fields are transmitted and displayed in alternating fashion, with each displayed frame comprising a top field and a bottom field. Interlaced video is different from non-interlaced video, which paints each line on the screen in order. The interlaced video method was developed to save bandwidth when transmitting signals but it can result in a less detailed image than comparable non-interlaced (progressive) video.

The MPEG-2 Video Standard also supports both frame-based and field-based methodologies for DCT block coding and motion prediction while MPEG-1 Video Standard only supports frame-based methodologies for DCT. A block coded by field DCT method typically has a larger motion component than a block coded by the frame DCT method.

MPEG-4

MPEG-4 is a Audiovisual (AV) encoder/decoder (codec) framework for creating and enabling interactivity with a wide set of tools for creating enhanced graphic content for objects organized in a hierarchical way for scene composition. The MPEG-4 video standard was started in 1993 with the object of video compression and to provide a new generation of coded representation of a scene. For example, MPEG-4 encodes a scene as a collection of visual objects where the objects (natural or synthetic) are individually coded and sent with the description of the scene for composition. Thus MPEG-4 relies on an object-based representation of a video data based on video object (VO) defined in MPEG-4 where each VO is characterized with properties such as shape, texture and motion. To describe the composition of these VOs to create audiovisual scenes, several VOs are then composed to form a scene with Binary Format for Scene (BIFS) enabling the modeling of any multimedia scenario as a scene graph where the nodes of the graph are the VOs. The BIFS describes a scene in the form a hierarchical structure where the nodes may be dynamically added or removed from the scene graph on demand to provide interactivity, mix/match of synthetic and natural audio or video, manipulation/composition of objects that involves scaling, rotation, drag, drop and so forth. Therefore the MPEG-4 stream is composed BIFS syntax, video/audio objects and other basic information such as synchronization configuration, decoder configurations and so on. Since BIFS contains information on the scheduling, coordinating in temporal and spatial domain, synchronization and processing interactivity, the client receiving the MPEG-4 stream needs to firstly decode the BIFS information that which composes the audio/video ES. Based on the decoded BIFS information the decoder accesses the associated audio-visual data as well as other possible supplementary data. To apply MPEG-4 object-based representation to a scene, objects included in the scene should first be detected and segmented which cannot be easily automated by using the current state-of-art image analysis technology. A more extensive information of MPEG-4 can be found at “H.264 and MPEG-4 Video Compression” (John Wiley & Sons, August, 2003) by lain E. G. Richardson and “The MPEG-4 Book” (Prentice Hall PTR, July, 2002) by Touradj Ebrahimi and Fernando Pereira.

MPEG-4 Time Stamps

In order to synchronize the clock of the decoder and the encoder, samples of time base can be transmitted to the decoder by means of Object Clock Reference (OCR). The OCR is a sample value of the Object Time Base which is the system clock of the media object encoder. The OCR is located in the AL-PDU (Access-unit Layer-Protocol Data Unit) header and inserted at regular interval specified by the MPEG-4 specification. Based on the OCR, the intended time at which each Access Unit must be decoded is indicated by a time stamp called Decoding Time Stamp (DTS). The DTS is located in the Access Unit header if it exits. The Composition Time Stamp (CTS), on the other hand, is a time stamp indicating the intended time at which the Composition Unit must be composed. The CTS is also located in the access unit if it exits.

DMB (Digital Multimedia Broadcasting)

Digital Multimedia Broadcasting (DMB), commercialized in Korea, is a new multimedia broadcasting service providing CD-quality audio, video, TV programs as well as a variety of information (for example, news, traffic news) for portable (mobile) receivers (small TV, PDA and mobile phones) that can move at high speeds. The DMB is classified into terrestrial DMB and satellite DMB according to transmission means.

Eureka-147 DAB (Digital Audio Broadcasting) was chosen as a transmission standard for domestic terrestrial DMB. MPEG-4 and Advanced Video Coding (AVC) was selected for video encoding, MPEG-4 Bit Sliced Arithmetic Coding for audio encoding, MPEG-2 and MPEG-4 for multiplexing and synchronization. In case of terrestrial DMB, the system synchronization is achieved by PCR, and media synchronization among ESs is achieved by using OCR, CTS, and DTS together with the PCR. A more extensive information of DMB can be found at “TTAS.KO-07.0026: Radio Broadcasting Systems; Specification of the video services for VHF Digital Multimedia Broadcasting (DMB) to mobile, portable and fixed receivers” (see World Wide Web at tta.or.kr).

H.264 (AVC)

H.264 also called Advanced Video Coding (AVC) or MPEG-4 part 10 is the newest international video coding standard. Video coding standards such as MPEG-2 enabled the transmission of HDTV signals over satellite, cable, and terrestrial emission and the storage of video signals on various digital storage devices (such as disc drives, CDs, and DVDs). However, the need for H.264 has arisen to improve the coding efficiency over prior video coding standards such MPEG-2.

Relative to prior video coding standards, H.264 has features that allow enhanced video coding efficiency. H.264 allows for variable block-size quarter-sample-accurate motion compensation with block sizes as small as 4×4 allowing more flexibility in the selection of motion compensation block size and shape over prior video coding standards.

H.264 has an advanced reference picture selection technique such that the encoder can select the pictures to be referenced for motion compensation compared to P- or B-pictures in MPEG-1 and MPEG-2 which may only reference a combination of adjacent future and previous pictures. Therefore a high degree of flexibility is provided in the ordering of pictures for referencing and display purposes compared to the strict dependency between the ordering of pictures for motion compensation in the prior video coding standard.

Another technique of H.264 absent from other video coding standards is that H.264 allows the motion-compensated prediction signal to be weighted and offset by amounts specified by the encoder to improve the coding efficiency dramatically.

All major prior coding standards (such as JPEG, MPEG-1, MPEG-2) use a block size of 8 by 8 for transform coding while H.264 design uses a block size of 4 by 4 for transform coding. This allows the encoder to represent signals in a more adaptive way, enabling more accurate motion compensation and reducing artifacts. H.264 also uses two entropy coding methods, called Context-Adaptive Variable Length Coding (CAVLC) and Context-Adaptive Binary Arithmetic Coding (CABAC), using context-based adaptivity to improve the performance of entropy coding relative to prior standards.

H.264 also provides robustness to data error/losses for a variety of network environments. For example, a parameter set design provides for robust header information which is sent separately for handling in a more flexible way to ensure that no severe impact in the decoding process is observed even if a few bits of information are lost during transmission. In order to provide data robustness H.264 partitions pictures into a group of slices where each slice may be decoded independent of other slices, similar to MPEG-1 and MPEG-2. However the slice structure in MPEG-2 is less flexible compared to H.264, reducing the coding efficiency due to the increasing quantity of header data and decreasing the effectiveness of prediction.

In order to enhance the robustness, H.264 allows regions of a picture to be encoded redundantly such that if the primary information regarding a picture is lost, the picture can be recovered by receiving the redundant information on the lost region. Also H.264 separates the syntax of each slice into multiple different partitions depending on the importance of the coded information for transmission.

ATSC/DVB

The ATSC is an international, non-profit organization developing voluntary standards for DTV including digital HDTV and SDTV. The ATSC digital TV standard, Revision B (ATSC Standard A/53B) defines a standard for digital video based on MPEG-2 encoding, and allows video frames as large as 1920×1080 pixels/pels (2,073,600 pixels) at 19.29 Mbps, for example. The Digital Video Broadcasting Project (DVB—an industry-led consortium of over 300 broadcasters, manufacturers, network operators, software developers, regulatory bodies and others in over 35 countries) provides a similar international standard for DTV. Digitalization of cable, satellite and terrestrial television networks within Europe is based on the Digital Video Broadcasting (DVB) series of standards while USA and Korea utilize ATSC for digital TV broadcasting.

In order to view ATSC and DVB compliant (or Internet Protocol (IP) TV) digital streams, digital STBs which may be connected inside or associated with user's TV set began to penetrate TV markets. For purpose of this disclosure, the term STB is used to refer to any and all such display, memory, or interface devices intended to receive, store, process, decode, repeat, edit, modify, display, reproduce or perform any portion of a TV program or video stream, including personal computer (PC) and mobile device. With this new consumer device, television viewers may record broadcast programs into the local or other associated data storage of their Digital Video Recorder (DVR) in a digital video compression format such as MPEG-2. A DVR is usually considered a STB having recording capability, for example in associated storage or in its local storage or hard disk. A DVR allows television viewers to watch programs in the way they want (within the limitations of the systems) and when they want (generally referred to as “on demand”). Due to the nature of digitally recorded video, viewers should have the capability of directly accessing a certain point of a recorded program (often referred to as “random access”) in addition to the traditional video cassette recorder (VCR) type controls such as fast forward and rewind.

In standard DVRs, the input unit takes video streams in a multitude of digital forms, such as ATSC, DVB, Digital Multimedia Broadcasting (DMB) and Digital Satellite System (DSS), most of them based on the MPEG-2 TS, from the Radio Frequency (RF) tuner, a communication network (for example, Internet, Public Switched Telephone Network (PSTN), wide area network (WAN), local area network (LAN), wireless network, optical fiber network, or other equivalents) or auxiliary read-only disks such as CD and DVD.

The DVR memory system usually operates under the control of a processor which may also control the demultiplexor of the input unit. The processor is usually programmed to respond to commands received from a user control unit manipulated by the viewer. Using the user control unit, the viewer may select a channel to be viewed (and recorded in the buffer), such as by commanding the demultiplexor to supply one or more sequences of frames from the tuned and demodulated channel signals which are assembled, in compressed form, in the random access memory, which are then supplied via memory to a decompressor/decoder for display on the display device(s).

The DVB Service Information (SI) and ATSC Program Specific Information Protocol (PSIP) are the glue that holds the DTV signal together in DVB and ATSC, respectively. ATSC (or DVB) allow for PSIP (or SI) to accompany broadcast signals and is intended to assist the digital STB and viewers to navigate through an increasing number of digital services. The ATSC-PSIP and DVB-SI are more fully described in “ATSC Standard A/53C with Amendment No. 1: ATSC Digital Television Standard”, Rev. C, and in “ATSC Standard A/65B: Program and System Information Protocol for Terrestrial Broadcast and Cable”, Rev. B 18 Mar. 2003 (see World Wide Web at atsc.org) and “ETSI EN 300 468 Digital Video Broadcasting (DVB); Specification for Service Information (SI) in DVB Systems” (see World Wide Web at etsi.org).

Within DVB-SI and ATSC-PSIP, the Event Information Table (EIT) is especially important as a means of providing program (“event”) information. For DVB and ATSC compliance it is mandatory to provide information on the currently running program and on the next program. The EIT can be used to give information such as the program title, start time, duration, a description and parental rating.

In the article “ATSC Standard A/65B: Program and System Information Protocol for Terrestrial Broadcast and Cable,” Rev. B, 18 Mar. 2003 (see World Wide Web at atsc.org), it is noted that PSIP is a voluntary standard of the ATSC and only limited parts of the standard are currently required by the Federal Communications Commission (FCC). PSIP is a collection of tables designed to operate within a TS for terrestrial broadcast of digital television. Its purpose is to describe the information at the system and event levels for all virtual channels carried in a particular TS. The packets of the base tables are usually labeled with a base packet identifier (PID, or base PID). The base tables include System Time Table (STT), Rating Region Table (RRT), Master Guide Table (MGT), Virtual Channel Table (VCT), EIT and Extent Text Table (ETT), while the collection of PSIP tables describe elements of typical digital TV service.

The STT defines the current date and time of day and carries time information needed for any application requiring synchronization. The time information is given in system time by the system_time field in the STT based on current Global Positioning Satellite (GPS) time, from 12:00 a.m. Jan. 6, 1980, in an accuracy of within 1 second. The DVB has a similar table called Time and Date Table (TDT). The TDT reference of time is based on the Universal Time Coordinated (UTC) and Modified Julian Date (MJD) as described in Annex C at “ETSI EN 300 468 Digital Video Broadcasting (DVB); Specification for Service Information (SI) in DVB systems” (see World Wide Web at etsi.org).

The Rating Region Table (RTT) has been designed to transmit the rating system in use for each country having such as system. In the United States, this is incorrectly but frequently referred to as the “V-chip” system; the proper title is “Television Parental Guidelines” (TVPG). Provisions have also been made for multi-country systems.

The Master Guide Table (MGT) provides indexing information for the other tables that comprise the PSIP Standard. It also defines table sizes necessary for memory allocation during decoding, defines version numbers to identify those tables that need to be updated, and generates the packet identifiers that label the tables. An exemplary Master Guide table (MGT) and its usage may be found at “ATSC Standard A/65B: Program and System Information Protocol for Terrestrial Broadcast and Cable, Rev. B 18 Mar. 2003” (see World Wide Web at atsc.org).

The Virtual Channel Table (VCT), also referred to as the Terrestrial VCT (TVCT), contains a list of all the channels that are or will be on-line, plus their attributes. Among the attributes given are short channel name, channel number (major and minor), the carrier frequency and modulation mode to identify how the service is physically delivered. The VCT also contains a source identifier (ID) which is important for representing a particular logical channel. Each EIT contains a source ID to identify which minor channel will carry its programming for each 3 hour period. Thus the source ID may be considered as a Universal Resource Locator (URL) scheme that could be used to target a programming service. Much like Internet domain names in regular Internet URLs, such a source ID type URL does not need to concern itself with the physical location of the referenced service, providing a new level of flexibility into the definition of source ID. The VCT also contains information on the type of service indicating whether analog TV, digital TV or other data is being supplied. It also may contain descriptors indicating the PIDs to identify the packets of service and descriptors for extended channel name information.

The EIT table is a PSIP table that carries information regarding the program schedule information for each virtual channel. Each instance of an EIT traditionally covers a three hour span, to provide information such as event duration, event title, optional program content advisory data, optional caption service data, and audio service descriptor(s). There are currently up to 128 EITs—EIT-0 through EIT-127—each of which describes the events or television programs for a time interval of three hours. EIT-0 represents the “current” three hours of programming and has some special needs as it usually contains the closed caption, rating information and other essential and optional data about the current programming. Because the current maximum number of EITs is 128, up to 16 days of programming may be advertised in advance. At minimum, the first four EITs should always be present in every TS, and 24 are recommended. Each EIT-k may have multiple instances, one for each virtual channel in the VCT. The current EIT table contains information only on the current and future events that are being broadcast and that will be available for some limited amount of time into the future. However, a user might wish to know about a program previously broadcast in more detail.

The ETT table is an optional table which contains a detailed description in various languages for an event and/or channel. The detailed description in the ETT table is mapped to an event or channel by a unique identifier.

In the Article “ATSC Standard A/65B: Program and System Information Protocol for Terrestrial Broadcast and Cable,” Rev. B, 18 Mar. 2003 (see World Wide Web at atsc.org), it is noted that there may be multiple ETTs, one or more channel ETT sections describing the virtual channels in the VCT, and an ETT-k for each EIT-k, describing the events in the EIT-k. The ETTs are utilized in case it is desired to send additional information about the entire event since the number of characters for the title is restricted in the EIT. These are all listed in the MGT. An ETT-k contains a table instance for each event in the associated EIT-k. As the name implies, the purpose of the ETT is to carry text messages. For example, for channels in the VCT, the messages can describe channel information, cost, coming attractions, and other related data. Similarly, for an event such as a movie listed in the EIT, the typical message would be a short paragraph that describes the movie itself. ETTs are optional in the ATSC system.

The PSIP tables carry a mixture of short tables with short repeat cycles and larger tables with long cycle times. The transmission of one table must be complete before the next section can be sent. Thus, transmission of large tables must be complete within a short period in order to allow fast cycling tables to achieve specified time interval. This is more completely discussed at “ATSC Recommended Practice: Program and System Information Protocol Implementation Guidelines for Broadcasters” (see World Wide Web at atsc.org/standards/a_{—}69.pdf).

Closed Captioning

Closed captioning is a technology that provides visual text to describe dialogue, background noise, and sound effects on TV programs. The closed-caption text is superimposed over the displayed video in various fonts and layout. In case of analog TV such as NTSC, the closed-captions are encoded onto the Line 21 of the vertical blanking interval (VBI) of the video signal. The Line 21 of the VBI is specifically reserved to carry closed-caption text since it does not have any picture information. In case of digital TV such as ATSC, closed-caption text is carried in the picture user bits of MPEG-2 video bit stream. The information on the presence and format of closed-captions being carried is contained in the EIT and Program Map Table (PMT) which is a table in MPEG-2. The table maps a program with the elements that compose a program (video, audio and so forth). In case of MPEG-4, closed-caption text is delivered in the form of a BIFS stream that can be frame-by-frame synchronized with the video by sharing the same clock. A more extensive information on DTV closed captioning may be found at “EIA/CEA-708-B DTV Closed Captioning (DTVCC) standard” (see World Wide Web at ce.org).

DVD

Digital Video (or Versatile) Disc (DVD) is a multi-purpose optical disc storage technology suited to both entertainment and computer uses. As an entertainment product DVD allows home theater experience with high quality video, usually better than alternatives, such as VCR, digital tape and CD.

DVD has revolutionized the way consumers use pre-recorded movie devices for entertainment. With video compression standards such as MPEG-2, content providers can usually store over 2 hours of high quality video on one DVD disc. In a double-sided, dual-layer disc, the DVD can hold about 8 hours of compressed video which corresponds to approximately 30 hours of VHS TV quality video. DVD also has enhanced functions, such as support for wide screen movies; up to eight (8) tracks of digital audio each with as many as eight (8) channels; on-screen menus and simple interactive features; up to nine (9) camera angles; instant rewind and fast forward functionality; multi-lingual identifying text of title name; album name, song name, and automatic seamless branching of video. The DVD also allows users to have a useful and interactive way to get to their desired scenes with the chapter selection feature by defining the start and duration of a segment along with additional information such as an image and text (providing limited, but effective random access viewing). As an optical format, DVD picture quality does not degrade over time or with repeated usage, as compared to video tapes (which are magnetic storage media). The current DVD recording format uses 4:2:2 component digital video, rather than NTSC analog composite video, thereby greatly enhancing the picture quality in comparison to current conventional NTSC.

TV-Anytime and MPEG-7

TV viewers are currently provided with programming information such as channel number, program title, start time, duration, genre, rating (if available) and synopsis that are currently being broadcast or will be broadcast, for example, through an EPG At this time, the EPG contains information only on the current and future events that are being broadcast and that will be available for some limited amount of time into the future. However, a user might wish to know about a program previously broadcast in more detail. Such demands have arisen due to the capability of DVRs enabling recording of broadcast programs. A commercial DVR service based on proprietary EPG data format is available, as by the company TiVo (see World Wide Web at tivo.com).

The simple service information such as program title or synopsis that is currently delivered through the EPG scheme appears to be sufficient to guide users to select a channel and record a program. However, users might wish to fast access to specific segments within a recorded program in the DVR. In the case of current DVD movies, users can access to a specific part of a video through “chapter selection” interface. Access to specific segments of the recorded program requires segmentation information of a program that describes a title, category, start position and duration of each segment that could be generated through a process called “video indexing”. To access to a specific segment without the segmentation information of a program, viewers currently have to linearly search through the program from the beginning, as by using the fast forward button, which is a cumbersome and time-consuming process.

TV-Anytime

Local storage of AV content and data on consumer electronics devices accessible by individual users opens a variety of potential new applications and services. Users can now easily record contents of their interests by utilizing broadcast program schedules and later watch the programs, thereby taking advantage of more sophisticated and personalized contents and services via a device that is connected to various input sources such as terrestrial, cable, satellite, Internet and others. Thus, these kinds of consumer devices provide new business models to three main provider groups: content creators/owners, service providers/broadcasters and related third parties, among others. The global TV-Anytime Forum (see World Wide Web at tv-anytime.org) is an association of organizations which seeks to develop specifications to enable audio-visual and other services based on mass-market high volume digital local storage in consumer electronics platforms. The forum has been developing a series of open specifications since being formed on September 1999.

The TV-Anytime Forum identifies new potential business models, and introduced a scheme for content referencing with Content Referencing Identifiers (CRIDs) with which users can search, select, and rightfully use content on their personal storage systems. The CRID is a key part of the TV-Anytime system specifically because it enables certain new business models. However, one potential issue is, if there are no business relationships defined between the three main provider groups, as noted above, there might be incorrect and/or unauthorized mapping to content. This could result in a poor user experience. The key concept in content referencing is the separation of the reference to a content item (for example, the CRID) from the information needed to actually retrieve the content item (for example, the locator). The separation provided by the CRID enables a one-to-many mapping between content references and the locations of the contents. Thus, search and selection yield a CRID, which is resolved into either a number of CRIDs or a number of locators. In the TV-Anytime system, the main provider groups can originate and resolve CRIDs. Ideally, the introduction of CRIDs into the broadcasting system is advantageous because it provides flexibility and reusability of content metadata. In existing broadcasting systems, such as ATSC-PSIP and DVB-SI, each event (or program) in an EIT table is identified with a fixed 16-bit event identifier (EID). However, CRIDs require a rather sophisticated resolving mechanism. The resolving mechanism usually relies on a network which connects consumer devices to resolving servers maintained by the provider groups. Unfortunately, it may take a long time to appropriately establish the resolving servers and network.

TV-Anytime also defines the metadata format for metadata that may be exchanged between the provider groups and the consumer devices. In a TV-Anytime environment, the metadata includes information about user preferences and history as well as descriptive data about content such as title, synopsis, scheduled broadcasting time, and segmentation information. Especially, the descriptive data is an essential element in the TV-Anytime system because it could be considered as an electronic content guide. The TV-Anytime metadata allows the consumer to browse, navigate and select different types of content. Some metadata can provide in-depth descriptions, personalized recommendations and detail about a whole range of contents both local and remote. In TV-Anytime metadata, program information and scheduling information are separated in such a way that scheduling information refers its corresponding program information via the CRIDs. The separation of program information from scheduling information in TV-Anytime also provides a useful efficiency gain whenever programs are repeated or rebroadcast, since each instance can share a common set of program information.

The schema or data format of TV-Anytime metadata is usually described with XML Schema, and all instances of TV-Anytime metadata are also described in an eXtensible Markup Language (XML). Because XML is verbose, the instances of TV-Anytime metadata require a large amount of data or high bandwidth. For example, the size of an instance of TV-Anytime metadata might be 5 to 20 times larger than that of an equivalent EIT (Event Information Table) table according to ATSC-PSIP or DVB-SI specification. In order to overcome the bandwidth problem, TV-Anytime provides a compression/encoding mechanism that converts an XML instance of TV-Anytime metadata into equivalent binary format. According to TV-Anytime, compression specification, the XML structure of TV-Anytime metadata is coded using BiM, an efficient binary encoding format for XML adopted by MPEG-7. The Time/Date and Locator fields also have their own specific codecs. Furthermore, strings are concatenated within each delivery unit to ensure efficient Zlib compression is achieved in the delivery layer. However, despite the use of the three compression techniques in TV-Anytime, the size of a compressed TV-Anytime metadata instance is hardly smaller than that of an equivalent EIT in ATSC-PSIP or DVB-SI because the performance of Zlib is poor when strings are short, especially fewer than 100 characters. Since Zlib compression in TV-Anytime is executed on each TV-Anytime fragment that is a small data unit such as a title of a segment or a description of a director, good performance of Zlib can not generally be expected.

MPEG-7

Motion Picture Expert Group—Standard 7 (MPEG-7), formally named “Multimedia Content Description Interface,” is the standard that provides a rich set of tools to describe multimedia content. MPEG-7 offers a comprehensive set of audiovisual description tools for the elements of metadata and their structure and relationships), enabling the effective and efficient access (search, filtering and browsing) to multimedia content. MPEG-7 uses XML schema language as the Description Definition Language (DDL) to define both descriptors and description schemes. Parts of MPEG-7 specification such as user history are incorporated in TV Anytime specification.

Generating Visual Rhythm

Visual Rhythm (VR) is a known technique whereby video is sub-sampled, frame-by-frame, to produce a single image (visual timeline) which contains (and conveys) information about the visual content of the video. It is useful, for example, for shot detection. A visual rhythm image is typically obtained by sampling pixels lying along a sampling path, such as a diagonal line traversing each frame. A line image is produced for the frame, and the resulting line images are stacked, one next to the other, typically from left-to-right. Each vertical slice of visual rhythm with a single pixel width is obtained from each frame by sampling a subset of pixels along the predefined path. In this manner, the visual rhythm image contains patterns or visual features that allow the viewer/operator to distinguish and classify many different types of video effects, (edits and otherwise) including: cuts, wipes, dissolves, fades, camera motions, object motions, flashlights, zooms, and so forth. The different video effects manifest themselves as different patterns on the visual rhythm image. Shot boundaries and transitions between shots can be detected by observing the visual rhythm image which is produced from a video. Visual Rhythm is further described in commonly-owned, copending U.S. patent application Ser. No. 09/911,293 filed Jul. 23, 2001 (Publication No. 2002/0069218).

Interactive TV

The interactive TV is a technology combining various mediums and services to enhance the viewing experience of the TV viewers. Through two-way interactive TV, a viewer can participate in a TV program in a way that is intended by content/service providers, rather than the conventional way of passively viewing what is displayed on screen as in analog TV. Interactive TV provides a variety of kinds of interactive TV applications such as news tickers, stock quotes, weather service and T-commerce. One of the open standards for interactive digital TV is Multimedia Home Platform (MHP) (in the united states, MHP has its equivalent in the Java-Based Advanced Common Application Platform (ACAP), and Advanced Television Systems Committee (ATSC) activity and in OCAP, the Open Cable Application Platform specified by the OpenCable consortium) which provides a generic interface between the interactive digital applications and the terminals (for example, DVR) that receive and run the applications. A content producer produces an MHP application written mostly in JAVA using a set of MHP Application Program Interface (API) set. The MHP API set contains various API sets for primitive MPEG access, media control, tuner control, graphics, communications and so on. MHP broadcasters and network operators then are responsible for packaging and delivering the MHP application created by the content producer such that it can be delivered to the users having an MHP compliant digital appliances or STBs. MHP applications are delivered to STBs by inserting the MHP-based services into the MPEG-2 TS in the form of Digital Storage Media-Command and Control (DSM-CC) object carousels. A MHP compliant DVR then receives and process the MHP application in the MPEG-2 TS with a Java virtual machine.

Real-Time Indexing of TV Programs

A scenario, called “quick metadata service” on live broadcasting, is described in the above-referenced U.S. patent application Ser. No. 10/369,333 filed Feb. 19, 2003, and U.S. patent application Ser. No. 10/368,304 filed Feb. 18, 2003 where descriptive metadata of a broadcast program is also delivered to a DVR while the program is being broadcast and recorded. In the case of live broadcasting of sports games such as football, television viewers may want to selectively view and review highlight events of a game as well as plays of their favorite players while watching the live game. Without the metadata describing the program, it is not easy for viewers to locate the video segments corresponding to the highlight events or objects (for example, players in case of sports games or specific scenes or actors, actresses in movies) by using conventional controls such as fast forwarding.

As disclosed herein, the metadata includes time positions such as start time positions, duration and textual descriptions for each video segment corresponding to semantically meaningful highlight events or objects. If the metadata is generated in real-time and incrementally delivered to viewers at a predefined interval or whenever new highlight event(s) or object(s) occur or whenever broadcast, the metadata can then be stored at the local storage of the DVR or other device for a more informative and interactive TV viewing experience such as the navigation of content by highlight events or objects. Also, the entirety or a portion of the recorded video may be re-played using such additional data. The metadata can also be delivered just one time immediately after its corresponding broadcast television program has finished, or successive metadata materials may be delivered to update, expand or correct the previously delivered metadata. Alternatively, metadata may be delivered prior to broadcast of an event (such as a pre-recorded movie) and associated with the program when it is broadcast. Also, various combinations of pre-, post-, and during broadcast delivery of metadata are hereby contemplated by this disclosure.

One of the key components for the quick metadata service is a real-time indexing of broadcast television programs. Various methods have been proposed for video indexing, such as U.S. Pat. No. 6,278,446 (“Liou”) which discloses a system for interactively indexing and browsing video; and, U.S. Pat. No. 6,360,234 (“Jain”) which discloses a video cataloger system. These current and existing systems and methods, however, fall short of meeting their avowed or intended goals, especially for real-time indexing systems.

The various conventional methods can, at best, generate low-level metadata by decoding closed-caption texts, detecting and clustering shots, selecting key frames, attempting to recognize faces or speech, all of which could perhaps synchronized with video. However, with the current state-of-art technologies on image understanding and speech recognition, it is very difficult to accurately detect highlights and generate semantically meaningful and practically usable highlight summary of events or objects in real-time for many compelling reasons:

First, as described earlier, it is difficult to automatically recognize diverse semantically meaningful highlights. For example, a keyword “touchdown” can be identified from decoded closed-caption texts in order to automatically find touchdown highlights, resulting in numerous false alarms.

Therefore, according to the present disclosure, generating semantically meaningful and practically usable highlights still require the intervention of a human or other complex analysis system operator, usually after broadcast, but preferably during broadcast (usually slightly delayed from the broadcast event) for a first, rough, metadata delivery. A more extensive metadata set(s) could be later provided and, of course, pre-recorded events could have rough or extensive metadata set(s) delivered before, during or after the program broadcast. The later delivered metadata set(s) may augment, annotate or replace previously-sent, later-sent metadata, as desired.

Second, the conventional methods do not provide an efficient way for manually marking distinguished highlights in real-time. Consider a case where a series of highlights occurs at short intervals. Since it takes time for a human operator to type in a title and extra textual descriptions of a new highlight, there might be a possibility of missing the immediately following events.

Media Localization

The media localization within a given temporal audio-visual stream or file has been traditionally described using either the byte location information or the media time information that specifies a time point in the stream. In other words, in order to describe the location of a specific video frame within an audio-visual stream, a byte offset (for example, the number of bytes to be skipped from the beginning of the video stream) has been used. Alternatively, a media time describing a relative time point from the beginning of the audio-visual stream has also been used. For example, in the case of a video-on-demand (VOD) through interactive Internet or high-speed network, the start and end positions of each audio-visual program is defined unambiguously in terms of media time as zero and the length of the audio-visual program, respectively, since each program is stored in the form of a separate media file in the storage at the VOD server and, further, each audio-visual program is delivered through streaming on each client's demand. Thus, a user at the client side can gain access to the appropriate temporal positions or video frames within the selected audio-visual stream as described in the metadata.

However, as for TV broadcasting, since a digital stream or analog signal is continuously broadcast, the start and end positions of each broadcast program are not clearly defined. Since a media time or byte offset are usually defined with reference to the start of a media file, it could be ambiguous to describe a specific temporal location of a broadcast program using media times or byte offsets in order to relate an interactive application or event, and then to access to a specific location within an audio-visual program.

One of the existing solutions to achieve the frame accurate media localization or access in broadcast stream is to use PTS. The PTS is a field that may be present in a PES packet header as defined in MPEG-2, which indicates the time when a presentation unit is presented in the system target decoder. However, the use of PTS alone is not enough to provide a unique representation of a specific time point or frame in broadcast programs since the maximum value of PTS can only represent the limited amount of time that corresponds to approximately 26.5 hours. Therefore, additional information will be needed to uniquely represent a given frame in broadcast streams. On the other hand, if a frame accurate representation or access is not required, there is no need for using PTS and thus the following issues can be avoided: The use of PTS requires parsing of PES layers, and thus it is computationally expensive. Further, if a broadcast stream is scrambled, the descrambling process is needed to access to the PTS. The MPEG-2 System specification contains an information on a scrambling mode of the TS packet payload, indicating the PES contained in the payload is scrambled or not. Moreover, most of digital broadcast streams are scrambled, thus a real-time indexing system cannot access the stream in frame accuracy without an authorized descrambler if a stream is scrambled.

Another existing solution for media localization in broadcast programs is to use MPEG-2 DSM-CC Normal Play Time (NPT) that provides a known time reference to a piece of media. MPEG-2 DSM-CC Normal Play Time (NPT is more fully described at “ISO/IEC 13818-6, Information technology—Generic coding of moving pictures and associated audio information—Part 6: Extensions for DSM-CC” (see World Wide Web at iso.org). For applications of TV-Anytime metadata in DVB-MHP broadcast environment, it was proposed that the NPT should be used for the purpose of time description, more fully described at “ETSI TS 102 812: DVB Multimedia Home Platform (MHP) Specification” (see World Wide Web at etsi.org) and “MyTV: A practical implementation of TV-Anytime on DVB and the Internet” (International Broadcasting Convention, 2001) by A. McParland, J. Morris, M. Leban, S. Ramall, A. Hickman, A. Ashley, M. Haataja, F. deJong. In the proposed implementation, however, it is required that both head ends and receiving client device can handle NPT properly, thus resulting in highly complex controls on time.

Schemes for authoring metadata, video indexing/navigation and broadcast monitoring are known. Examples of these can be found in U.S. Pat. No. 6,357,042, U.S. patent application Ser. No. 10/756,858 filed Jan. 10, 2001 (Pub. No. U.S. 2001/0014210 A1), and U.S. Pat. No. 5,986,692.

TV Video Search and DVR

Video becomes more widely available to users equipped with a variety of client devices such as Media Center PC, DTV, Internet Protocol TV (IPTV) and handheld devices, through diverse communication networks such as the Internet, wireless networks, PSTN, and broadcasting networks. In particular, DVR allows TV viewers to easily do scheduled-recording of their favorite TV programs by using EPG information, and thus it is desirable to provide an accurate start time of each program, based on which DVR starts recording. Therefore, TV viewers will be easily able to access to a huge amount of new video programs and files as the storage capacity of DVRs is growing, and TVs and STBs/DVRs connected to the Internet is becoming more popular, requiring new search schemes allowing most of normal TV viewers to easily search for the information relevant to one or more frames of TV video programs.

Most of the Internet search engines used in Google and Yahoo, for example, index and organize numerous Web pages based on textual information and search for web pages relevant to key words input by users. However, it is much more difficult to automatically index the semantic content of image/video data using current state of art image and video understanding technologies. Internet search corporations such as Yahoo and Google have been developing new schemes for searching image and video data.

In January 2005, Google, Inc. unveiled Google Video, a video search engine that lets people search the closed-captioning and text descriptions of archived videos including TV programs (see World Wide Web at video.google.com) from a variety of channels such as PBS, Fox News, C-SPAN, and CNN. It is based on texts, therefore users need to type in search terms. When users click on one of the search results, users can view still images from the video and relevant texts. For each TV program, it also shows a list of still images generated from the video stream of the program and additional information such as the date and time the program aired, but the still image corresponding to the start of each program does not always match the actual start (for example, a title image) image of the broadcast program since the start time of the program according to programming schedules is not often accurate. These problems are partly due to the fact that programming schedules occasionally will change just before a program is broadcast, especially after live programs such as a live sports game or news.

Yahoo, Inc. also introduced a video search engine (see World Wide Web at video.search.yahoo.com) that allows people to search text descriptions of archived videos. It is based on texts and users need to type in search term. One of the other video search engines, such as from Blinkx, uses a sophisticated technology that captures the video and converts the audio into text, which is then searchable by texts (see World Wide Web at blinkx.tv).

TV (or video) viewers might also want to search the local database or web pages, if connected to the Internet, for the information relevant to a TV program (or video) or its segment while watching the TV program (or video). However, the typing-in text whenever video search is needed could be inconvenient to viewers, and so it would be desirable to develop more appropriate search schemes than those used in Internet search engines such as from Google and Yahoo that are based on query input typed in by users.

Glossary

Unless otherwise noted, or as may be evident from the context of their usage, any terms, abbreviations, acronyms or scientific symbols and notations used herein are to be given their ordinary meaning in the technical discipline to which the disclosure most nearly pertains. The following terms, abbreviations and acronyms may be used in the description contained herein:

ACAP Advanced Common Application Platform (ACAP) is the result of harmonization of the CableLabs OpenCable (OCAP) standard and the previous DTV Application Software Environment (DASE) specification of the Advanced Television Systems Committee (ATSC). A more extensive explanation of ACAP may be found at “Candidate Standard: Advanced Common Application Platform (ACAP)” (see World Wide Web at atsc.org).

AL-PDU AL-PDU are fragmentation of Elementary streams into access units or parts thereof. A more extensive explanation of AL-PDU may be found at “Information technology—Coding of audio-visual objects—Part 1: Systems,” ISO/IEC 14496-1 (see World Wide Web at iso.org).

API Application Program Interface (API) is a set of software calls and routines that can be referenced by an application program as means for providing an interface between two software application. An explanation and examples of an API may be found at “Dan Appleman's Visual Basic Programmer's guide to the Win32 API” (Sams, February, 1999) by Dan Appleman.

ASF Advanced Streaming Format (ASF) is a file format designed to store and synchronized digital audio/video data, especially for streaming. ASF is renamed into Advanced Systems Format later. A more extensive explanation of ASF may be found at “Advanced Systems Format (ASF) Specification” (see World Wide Web at download.microsoft.com/download/7/9/0/790fecaa-f64a-4a5e-a430-0bccdab3f1b4/ASF_Specification.doc).ATSC Advanced Television Systems Committee, Inc. (ATSC) is an international, non-profit organization developing voluntary standards for digital television. Countries such as U.S. and Korea adopted ATSC for digital broadcasting. A more extensive explanation of ATSC may be found at “ATSC Standard A/53C with Amendment No. 1: ATSC Digital Television Standard, Rev. C,” (see World Wide Web at atsc.org). More description may be found in “Data Broadcasting: Understanding the ATSC Data Broadcast Standard” (McGraw-Hill Professional, April 2001) by Richard S. Chernock, Regis J. Crinon, Michael A. Dolan, Jr., John R. Mick, Richard Chernock, Regis Crinon. And may also be available in “Digital Television, DVB-T COFDM and ATSC 8-VSB” (Digitaltvbooks.com, October 2000) by Mark Massel. Alternatively, Digital Video Broadcasting (DVB) is an industry-led consortium committed to designing global standards that were adopted in European and other countries, for the global delivery of digital television and data services.

AV Audiovisual.

AVC Advanced Video Coding (H.264) is newest video coding standard of the ITU-T Video Coding Experts Group and the ISO/IEC Moving Picture Experts Group. An explanation of AVC may be found at “Overview of the H.264/AVC video coding standard”, Wiegand, T., Sullivan, G. J., Bjntegaard, G., Luthra, A., Circuits and Systems for Video Technology, IEEE Transactions on, Volume: 13, Issue: 7, July 2003, Pages:560-576; another may be found at “ISO/IEC 14496-10: Information technology—Coding of audio-visual objects—Part 10: Advanced Video Coding” (see World Wide Web at iso.org); Yet another description is found in “H.264 and MPEG-4 Video Compression” (Wiley) by lain E. G. Richardson, all three of which are incorporated herein by reference. MPEG-1 and MPEG-2 are alternatives or adjunct to AVC and are considered or adopted for digital video compression.

BD Blue-ray Disc (BD) is a high capacity CD-size storage media disc for video, multimedia, games, audio and other applications. A more complete explanation of BD may be found at “White paper for Blue-ray Disc Format” (see World Wide Web at bluraydisc.com/assets/downloadablefile/general_bluraydiscformat-12834.pdf). DVD (Digital Video Disc), CD (Compact Disc), minidisk, hard drive, magnetic tape, circuit-based (such as flash RAM) data storage medium are alternatives or adjuncts to BD for storage, either in analog or digital format.

BIFS Binary Format for Scene is a scene graph in the form of hierarchical structure describing how the video objects should be composed to form a scene in MPEG-4. A more extensive information of BIFS may be found at “H.264 and MPEG-4 Video Compression” (John Wiley & Sons, August, 2003) by Iain E. G. Richardson and “The MPEG-4 Book” (Prentice Hall PTR, July, 2002) by Touradj Ebrahimi, Fernando Pereira.

BiM Binary Metadata (BiM) Format for MPEG-7. A more extensive explanation of BiM may be found at “ISO/IEC 15938-1: Multimedia Context Description Interface—Part 1 Systems” (see World Wide Web at iso.ch).

BMP Bitmap is a file format designed to store bit mapped images and usually used in the Microsoft Windows environments.

BNF Backus Naur Form (BNF) is a formal metadata syntax to describe the syntax and grammar of structure languages such as programming languages. A more extensive explanation of BNF may be found at “The World of Programming Languages” (Springer-Verlag 1986) by M. Marcotty & H. Ledgard.

bslbf bit string, left-bit first. The-bit string is written as a string of 1s and 0s in the left order first. A more extensive explanation of bslbf may be found at may be found at “Generic Coding of Moving Pictures and Associated Audio Information—Part 1: Systems,” ISO/IEC 13818-1 (MPEG-2), 1994 (see World Wide Web at iso.org).

CA Conditional Access (CA) is a system utilized to prevent unauthorized users to access contents such as video, audio and so forth such that it ensures that viewers only see those programs they have paid to view. A more extensive explanation of CA may be found at “Conditional access for digital TV: Opportunities and challenges in Europe and the US” (2002) by MarketResearch.com.

codec enCOder/DECoder is a short word for the encoder and the decoder. The encoder is a device that encodes data for the purpose of achieving data compression. Compressor is a word used alternatively for encoder. The decoder is a device that decodes the data that is encoded for data compression. Decompressor is a word alternatively used for decoder. Codecs may also refer to other types of coding and decoding devices.

COFDM Coded Octal frequency division multiplex (COFDM) is a modulation scheme used predominately in Europe and is supported by the Digital Video Broadcasting (DVB) set of standards. In the U.S., the Advanced Television Standards Committee (ATSC) has chosen 8-VSB (8-level Vestigial Sideband) as its equivalent modulation standard. A more extensive explanation on COFDM may be found at “Digital Television, DVB-T COFDM and ATSC 8-VSB” (Digitaltvbooks.com, October 2000) by Mark Massel.

CRC Cyclic Redundancy Check (CRC) is a 32-bit value to check if an error has occurred in a data during transmission, it is further explained in Annex A of ISO/IEC 13818-1 (see World Wide Web at iso.org).

CRID Content Reference IDentifier (CRID) is an identifier devised to bridge between the metadata of a program and the location of the program distributed over a variety of networks. A more extensive explanation of CRID may be found at “Specification Series: S-4 On: Content Referencing” (see World Wide Web at tv-anytime.org).

CTS Composition Time Stamp is the time at which composition unit should be available to the composition memory for composition. PTS is an alternative or adjunct to CTS and is considered or adopted for MPEG-2. A more extensive explanation of CTS may be found at “Information technology—Coding of audio-visual objects—Part 1: Systems,” ISO/IEC 14496-1 (see World Wide Web at iso.org).

DAB Digital Audio Broadcasting (DAB) on terrestrial networks providing Compact Disc (CD) quality sound, text, data, and videos on the radio. A more detailed explanation of DAB may be found on the World Wide Web at worlddab.org/about.aspx. A more detailed description may also be found in “Digital Audio Broadcasting: Principles and Applications of Digital Radio” (John Wiley and Sons, Ltd.) by W. Hoeg, Thomas Lauterbach.

DASE DTV Application Software Environment (DASE) is a standard of ATSC that defines a platform for advanced functions in digital TV receivers such as a set top box. A more extensive explanation of DASE may be found at “ATSC Standard A/100: DTV Application Software Environment—Level 1 (DASE-1)” (see World Wide Web at atsc.org).

DCT Discrete Cosine Transform (DCT) is a transform function from spatial domain to frequency domain, a type of transform coding. A more extensive explanation of DCT may be found at “Discrete-Time Signal Processing” (Prentice Hall, 2nd edition, February 1999) by Alan V. Oppenheim, Ronald W. Schafer, John R. Buck. Wavelet transform is an alternative or adjunct to DCT for various compression standards such as JPEG-2000 and Advanced Video Coding. A more thorough description of wavelet may be found at “Introduction on Wavelets and Wavelets Transforms” (Prentice Hall, 1st edition, August 1997)) by C. Sidney Burrus, Ramesh A. Gopinath. DCT may be combined with Wavelet, and other transformation functions, such as for video compression, as in the MPEG 4 standard, more fully describes at “H.264 and MPEG-4 Video Compression” (John Wiley & Sons, August 2003) by lain E. G. Richardson and “The MPEG-4 Book” (Prentice Hall, July 2002) by Touradj Ebrahimi, Fernando Pereira.

DCCT Directed Channel Change Table (DCCT) is a table permitting broadcasters to recommend users to change between channels when the viewing experience can be enhanced. A more extensive explanation of DCCT may be found at “ATSC Standard A/65B: Program and System Information Protocol for Terrestrial Broadcast and Cable”, Rev. B 18 Mar. 2003 (see World Wide Web at atsc.org).

DDL Description Definition Language (DDL) is a language that allows the creation of new Description Schemes and, possibly, Descriptors, and also allows the extension and modification of existing Description Schemes. An explanation on DDL may be found at “Introduction to MPEG 7: Multimedia Content Description Language” (John Wiley & Sons, June 2002) by B. S. Manjunath, Philippe Salembier, and Thomas Sikora. More generally, and alternatively, DDL can be interpreted as the Data Definition Language that is used by the database designers or database administrator to define database schemas. A more extensive explanation of DDL may be found at “Fundamentals of Database Systems” (Addison Wesley, July 2003) by R. Elmasri and S. B. Navathe.

DirecTV DirecTV is a company providing digital satellite service for television. A more detailed explanation of DirecTV may be found on the World Wide Web at directv.com/. Dish Network (see World Wide Web at dishnetwork.com), Voom (see World Wide Web at voom.vom), and SkyLife (see World Wide Web at skylife.co.kr) are other companies providing alternative digital satellite service.

DMB Digital Multimedia Broadcasting (DMB), commercialized in Korea, is a new multimedia broadcasting service providing CD-quality audio, video, TV programs as well as a variety of information (for example, news, traffic news) for portable (mobile) receivers (small TV, PDA and mobile phones) that can move at high speeds.

DSL Digital Subscriber Line (DSL) is a high speed data line used to connect to the Internet. Different types of DSL were developed such as Asymmetric Digital Subscriber Line (ADSL) and Very high data rate Digital Subscriber Line (VDSL).

DSM-CC Digital Storage Media-Command and Control (DSM-CC) is a standard developed for the delivery of multimedia broadband services. A more extensive explanation of DSM-CC may be found at “ISO/IEC 13818-6, Information technology—Generic coding of moving pictures and associated audio information—Part 6: Extensions for DSM-CC” (see World Wide Web at iso.org).

DSS Digital Satellite System (DSS) is a network of satellites that broadcast digital data. An example of a DSS is DirecTV, which broadcasts digital television signals. DSS's are expected to become more important especially as TV and computers converge into a combined or unitary medium for information and entertainment (see World Wide Web at webopedia.com)

DTS Decoding Time Stamp (DTS) is a time stamp indicating the intended time of decoding. A more complete explanation of DTS may be found at “Generic Coding of Moving Pictures and Associated Audio Information—Part 1: Systems” ISO/IEC 13818-1 (MPEG-2), 1994 (see World Wide Web at iso.org).

DTV Digital Television (DTV) is an alternative audio-visual display device augmenting or replacing current analog television (TV) characterized by receipt of digital, rather than analog, signals representing audio, video and/or related information. Video display devices include Cathode Ray Tube (CRT), Liquid Crystal Display (LCD), Plasma and various projection systems. Digital Television is more fully described at “Digital Television: MPEG-1, MPEG-2 and Principles of the DVB System” (Butterworth-Heinemann, June, 1997) by Herve Benoit.

DVB Digital Video Broadcasting is a specification for digital television broadcasting mainly adopted in various countered in Europe adopt. A more extensive explanation of DVB may be found at “DVB: The Family of International Standards for Digital Video Broadcasting” by Ulrich Reimers (see World Wide Web at dvb.org). ATSC is an alternative or adjunct to DVB and is considered or adopted for digital broadcasting used in many countries such as the U.S. and Korea.

DVD Digital Video Disc (DVD) is a high capacity CD-size storage media disc for video, multimedia, games, audio and other applications. A more complete explanation of DVD may be found at “An Introduction to DVD Formats” (see World Wide Web at disctronics.co.uk/downloads/tech_docs/dvdintroduction.pdf) and “Video Discs Compact Discs and Digital Optical Discs Systems” (Information Today, June 1985) by Tony Hendley. CD (Compact Disc), minidisk, hard drive, magnetic tape, circuit-based (such as flash RAM) data storage medium are alternatives or adjuncts to DVD for storage, either in analog or digital format.

DVR Digital Video Recorder (DVR) is usually considered a STB having recording capability, for example in associated storage or in its local storage or hard disk. A more extensive explanation of DVR may be found at “Digital Video Recorders: The Revolution Remains On Pause” (MarketResearch.com, April 2001) by Yankee Group.

EIT Event Information Table (EIT) is a table containing essential information related to an event such as the start time, duration, title and so forth on defined virtual channels. A more extensive explanation of EIT may be found at “ATSC Standard A/65B: Program and System Information Protocol for Terrestrial Broadcast and Cable,” Rev. B, 18 Mar. 2003 (see World Wide Web at atsc.org).

EPG Electronic Program Guide (EPG) provides information on current and future programs, usually along with a short description. EPG is the electronic equivalent of a printed television program guide. A more extensive explanation on EPG may be found at “The evolution of the EPG: Electronic program guide development in Europe and the US” (MarketResearch.com) by Datamonitor.

ES Elementary Stream (ES) is a stream containing either video or audio data with a sequence header and subparts of a sequence. A more extensive explanation of ES may be found at “Generic Coding of Moving Pictures and Associated Audio Information—Part 1: Systems,” ISO/IEC 13818-1 (MPEG-2), 1994 (see World Wide Web at iso.org).

ESD Event Segment Descriptor (ESD) is a descriptor used in the Program and System Information Protocol (PSIP) and System Information (SI) to describe segmentation information of a program or event. ETM Extended Text Message (ETM) is a string data structure used to represent a description in several different languages. A more extensive explanation on ETM may be found at “ATSC Standard A/65B: Program and System Information Protocol for Terrestrial Broadcast and Cable”, Rev. B, 18 Mar. 2003” (see World Wide Web at atsc.org).

ETT Extended Text Table (ETT) contains Extended Text Message (ETM) streams, which provide supplementary description of virtual channel and events when needed. A more extensive explanation of ETM may be found at “ATSC Standard A/65B: Program and System Information Protocol for Terrestrial Broadcast and Cable”, Rev. B, 18 Mar. 2003” (see World Wide Web at atsc.org).

FCC The Federal Communications Commission (FCC) is an independent United States government agency, directly responsible to Congress. The FCC was established by the Communications Act of 1934 and is charged with regulating interstate and international communications by radio, television, wire, satellite and cable. More information can be found at their website (see World Wide Web at fcc.gov/aboutus.html).

F/W Firmware (F/W) is a combination of hardware (H/W) and software (S/W), for example, a computer program embedded in state memory (such as a Programmable Read Only Memory (PROM)) which can be associated with an electrical controller device (such as a microcontroller or microprocessor) to operate (or “run) the program on an electrical device or system. A more extensive explanation may be found at “Embedded Systems Firmware Demystified” (CMP Books 2002) by Ed Sutter.

GIF Graphics Interchange Format (GIF) is a bit-mapped graphics file format usually used for still image, cartoons, line art and illustrations. GIF includes data compression, transparency, interlacing and storage of multiple images within a single file. A more extensive explanation of GIF may be found at “GRAPHICS INTERCHANGE FORMAT (sm) Version 89a” (see World Wide Web at w3.org/Graphics/GIF/spec-gif89a.txt).

GPS Global Positioning Satellite (GPS) is a satellite system that provides three-dimensional position and time information. The GPS time is used extensively as a primary source of time. UTC (Universal Time Coordinates), NTP (Network Time Protocol) Program Clock Reference (PCR) and Modified Julian Date (MJD) are alternatives or adjuncts to GPS Time and is considered or adopted for providing time information.

GUI Graphical User Interface (GUI) is a graphical interface between an electronic device and the user using elements such as windows, buttons, scroll bars, images, movies, the mouse and so forth.

HD-DVD High Definition—Digital Video Disc (HD-DVD) is a high capacity CD-size storage media disc for video, multimedia, games, audio and other applications. A more complete explanation of HD-DVD may be found at DVD Forums (see World Wide Web at dvdforum.org/). CD (Compact Disc), minidisk, hard drive, magnetic tape, circuit-based (such as flash RAM) data storage medium are alternatives or adjuncts to HD-DVD for storage, either in analog or digital format.

HDTV High Definition Television (HDTV) is a digital television which provides superior digital picture quality (resolution). The 1080i (1920×1080 pixels interlaced), 1080p (1920×1080 pixels progressive) and 720p (1280×720 pixels progressive formats in a 16:9 aspect ratio are the commonly adopted acceptable HDTV formats. The “interlaced” or “progressive” refers to the scanning mode of HDTV which are explained in more detail in “ATSC Standard A/53C with Amendment No. 1: ATSC Digital Television Standard”, Rev. C, 21 May 2004 (see World Wide Web at atsc.org).

Huffman Coding Huffman coding is a data compression method which may be used alone or in combination with other transformations functions or encoding algorithms (such as DCT, Wavelet, and others) in digital imaging and video as well as in other areas. A more extensive explanation of Huffman coding may be found at “Introduction to Data Compression” (Morgan Kaufmann, Second Edition, February, 2000) by Khalid Sayood.

HI/W Hardware (H/W) is the physical components of an electronic or other device. A more extensive explanation on H/W may be found at “The Hardware Cyclopedia” (Running Press Book, 2003) by Steve Ettlinger.

infomercial Infomercial includes audiovisual (or part) programs or segments presenting information and commercials such as new program teasers, public announcement, time-sensitive promotion sales, advertisements, and commercials.

IP Internet Protocol, defined by IETF RFC791, is the communication protocol underlying the internet to enable computers to communicate to each other. An explanation on IP may be found at IETF RFC 791 Internet Protocol Darpa Internet Program Protocol Specification (see World Wide Web at ietf.org/rfc/rfc0791.txt).

IPTV Internet Protocol TV (IPTV) is basically a way of transmitting TV over broadband or high-speed network connections.

ISO International Organization for Standardization (ISO) is a network of the national standards institutes in charge of coordinating standards. More information can be found at their website (see World Wide Web at iso.org).

ISDN Integrated Services Digital Network (ISDN) is a digital telephone scheme over standard telephone lines to support voice, video and data communications.

ITU-T International Telecommunication Union (ITU) Telecommunication Standardization Sector (ITU-T) is one of three sectors of the ITU for defining standards in the field of telecommunication. More information can be found at their website (see World Wide Web at real.com itu.int/ITU-T).

JPEG JPEG (Joint Photographic Experts Group) is a standard for still image compression. A more extensive explanation of JPEG may be found at “ISO/IEC International Standard 10918-1” (see World Wide Web at jpeg.org/jpeg/). Various MPEG, Portable Network Graphics (PNG), Graphics Interchange Format (GIF), XBM (X Bitmap Format), Bitmap (BMP) are alternatives or adjuncts to JPEG and is considered or adopted for various image compression(s).

Kbps KiloBits Per Second is a measure of data transfer speed. Note that one kbps is 1000 bit per second.

key frame Key frame (key frame image) is a single, representative still image derived from a video program comprising a plurality of images. A more detailed information of key frame may be found at “Efficient video indexing scheme for content-based retrieval” (Transactions on Circuit and System for Video Technology, April, 2002)” by Hyun Sung Chang, Sanghoon Sull, Sang Uk Lee.

LAN Local Area Network (LAN) is a data communication network spanning a relatively small area. Most LANs are confined to a single building or group of buildings. However, one LAN can be connected to other LANs over any distance, for example, via telephone lines and radio wave and the like to form Wide Area Network (WAN). More information can be found by at “Ethernet: The Definitive Guide” (O'Reilly & Associates) by Charles E. Spurgeon.

MHz (Mhz) A measure of signal frequency expressing millions of cycles per second.

MGT Master Guide Table (MGT) provides information about the tables that comprise the PSIP. For example, MGT provides the version number to identify tables that need to be updated, the table size for memory allocation and packet identifiers to identify the tables in the Transport Stream. A more extensive explanation of MGT may be found at “ATSC Standard A/65B: Program and System Information Protocol for Terrestrial Broadcast and Cable”, Rev. B, 18 Mar. 2003 (see World Wide Web at atsc.org).

MHP Multimedia Home Platform (MHP) is a standard interface between interactive digital applications and the terminals. A more extensive explanation of MHP may be found at “ETSI TS 102 812: DVB Multimedia Home Platform (MHP) Specification” (see World Wide Web at etsi.org). Open Cable Application Platform (OCAP), Advanced Common Application Platform (ACAP), Digital Audio Visual Council (DAVIC) and Home Audio Video Interoperability (HAVi) are alternatives or adjuncts to MHP and are considered or adopted as interface options for various digital applications.

MJD Modified Julian Date (MJD) is a day numbering system derived from the Julian calendar date. It was introduced to set the beginning of days at 0 hours, instead of 12 hours and to reduce the number of digits in day numbering. UTC (Universal Time Coordinates), GPS (Global Positioning Systems) time, Network Time Protocol (NTP) and Program Clock Reference (PCR) are alternatives or adjuncts to PCR and are considered or adopted for providing time information.

MPEG The Moving Picture Experts Group is a standards organization dedicated primarily to digital motion picture encoding in Compact Disc. For more information, see their web site at (see World Wide Web at mpeg.org).

MPEG-2 Moving Picture Experts Group—Standard 2 (MPEG-2) is a digital video compression standard designed for coding interlaced/noninterlaced frames. MPEG-2 is currently used for DTV broadcast and DVD. A more extensive explanation of MPEG-2 may be found on the World Wide Web at mpeg.org and “Digital Video: An Introduction to MPEG-2 (Digital Multimedia Standards Series)” (Springer, 1996) by Barry G. Haskell, Atul Puri, Arun N. Netravali.

MPEG-4 Moving Picture Experts Group—Standard 4 (MPEG-4) is a video compression standard supporting interactivity by allowing authors to create and define the media objects in a multimedia presentation, how these can be synchronized and related to each other in transmission, and how users are to be able to interact with the media objects. A more extensive information of MPEG-4 can be found at “H.264 and MPEG-4 Video Compression” (John Wiley & Sons, August, 2003) by lain E. G. Richardson and “The MPEG-4 Book” (Prentice Hall PTR, July, 2002) by Touradj Ebrahimi, Fernando Pereira.

MPEG-7 Moving Picture Experts Group—Standard 7 (MPEG-7), formally named “Multimedia Content Description Interface” (MCDI) is a standard for describing the multimedia content data. More extensive information about MPEG-7 can be found at the MPEG home page (see World Wide Web at mpeg.tilab.com), the MPEG-7 Consortium website (see World Wide Web at mp7c.org), and the MPEG-7 Alliance website (see World Wide Web at mpeg-industry.com) as well as “Introduction to MPEG 7: Multimedia Content Description Language” (John Wiley & Sons, June, 2002) by B. S. Manjunath, Philippe Salembier, and Thomas Sikora, and “ISO/IEC 15938-5:2003 Information technology—Multimedia content description interface—Part 5: Multimedia description schemes” (see World Wide Web at iso.ch).

NPT Normal Playtime (NPT) is a time code embedded in a special descriptor in a MPEG-2 private section, to provide a known time reference for a piece of media. A more extensive explanation of NPT may be found at “ISO/IEC 13818-6, Information Technology—Generic Coding of Moving Pictures and Associated Audio Information—Part 6: Extensions for DSM-CC” (see World Wide Web at iso.org).

NTP Network Time Protocol (NTP) is a protocol that provides a reliable way of transmitting and receiving the time over the Transmission Control Protocol/Internet Protocol (TCP/IP) networks. A more extensive explanation of NTP may be found at “RFC (Request for Comments) 1305 Network Time Protocol (Version 3) Specification” (see World Wide Web at faqs.org/rfcs/rfc1305.html). UTC (Universal Time Coordinates), GPS (Global Positioning Systems) time, Program Clock Reference (PCR) and Modified Julian Date (MJD) are alternatives or adjuncts to NTP and are considered or adopted for providing time information.

NTSC The National Television System Committee (NTSC) is responsible for setting television and video standards in the United States (in Europe and the rest of the world, the dominant television standards are PAL and SECAM). More information is available by viewing the tutorials on the World Wide Web at ntsc-tv.com.

OpenCable The OpenCable managed by CableLabs, is a research and development consortium to provide interactive services over cable. More information is available by viewing their website on the World Wide Web at opencable.com.

OSD On-Screen Display (OSD) is an overlaid interface between an electronic device and users that allows to select option and/or adjust component of the display.

PAT A Program Association Table (PAT) is a table, contained in every Transport Stream (TS), providing correspondence between a program number and the Packet Identifier (PID) of the Transport Stream (TS) packets that carry the definition of that program. A more extensive explanation of PAT may be found at “Generic Coding of Moving Pictures and Associated Audio Information—Part 1: Systems,” ISO/IEC 13818-1 (MPEG-2), 1994 (see World Wide Web at iso.org).

PC Personal Computer (PC).

PCR Program Clock Reference (PCR) in the Transport Stream (TS) indicates the sampled value of the system time clock that can be used for the correct presentation and decoding time of audio and video. A more extensive explanation of PCR may be found at “Generic Coding of Moving Pictures and Associated Audio Information—Part 1: Systems,” ISO/IEC 13818-1 (MPEG-2), 1994 (see World Wide Web at iso.org). SCR (System Clock Reference) is an alternative or adjunct to PCR used in MPEG program streams.

PDA Personal Digital Assistant is handheld devices usually including data book, address book, task list and memo pad.

PES Packetized Elementary Stream (PES) is a stream composed of a PES packet header followed by the bytes from an Elementary Stream (ES). A more extensive explanation of PES may be found at “Generic Coding of Moving Pictures and Associated Audio Information—Part 1: Systems,” ISO/IEC 13818-1 (MPEG-2), 1994 (see World Wide Web at iso.org).

PID A Packet Identifier (PID) is a unique integer value used to identify Elementary Streams (ES) of a program or ancillary data in a single or multi-program Transport Stream (TS). A more extensive explanation of PID may be found at “Generic Coding of Moving Pictures and Associated Audio Information—Part 1: Systems,” ISO/IEC 13818-1 (MPEG-2), 1994 (see World Wide Web at iso.org).

PMT A Program Map Table (PMT) is a table in MPEG-2 which maps a program with the elements that compose a program (video, audio and so forth). A more extensive explanation of PMT may be found at “Generic Coding of Moving Pictures and Associated Audio Information—Part 1: Systems,” ISO/IEC 13818-1 (MPEG-2), 1994 (see World Wide Web at iso.org).

PS Program Stream (PS), specified by the MPEG-2 System Layer, is used in relatively error-free environment such as DVD media. A more extensive explanation of PS may be found at “Generic Coding of Moving Pictures and Associated Audio Information—Part 1: Systems,” ISO/IEC 13818-1 (MPEG-2), 1994 (see World Wide Web at iso.org).

PSI Program Specific Information (PSI) is the MPEG-2 data that enables the identification and de-multiplexing of transport stream packets belonging to a particular program. A more extensive explanation of PSI may be found at “Generic Coding of Moving Pictures and Associated Audio Information—Part 1: Systems,” ISO/IEC 13818-1 (MPEG-2), 1994 (see World Wide Web at iso.org).

PSIP Program and System Information Protocol (PSIP) for ATSC data tables for delivering EPG and system information to consumer devices such as DVRs in countries using ATSC (such as the U.S. and Korea) for digital broadcasting. Digital Video Broadcasting System Information (DVB-SI) is an alternative or adjunct to ATSC-PSIP and is considered or adopted for Digital Video Broadcasting (DVB) used in Europe. A more extensive explanation of PSIP may be found at “ATSC Standard A/65B: Program and System Information Protocol for Terrestrial Broadcast and Cable,” Rev. B, 18 Mar. 2003 (see World Wide Web at atsc.org).

PSTN Public Switched Telephone Network (PSTN) is the world's collection of interconnected voice-oriented public telephone networks.

PTS Presentation Time Stamp (PTS) is a time stamp that indicates the presentation time of audio and/or video. A more extensive explanation of PTS may be found at “Generic Coding of Moving Pictures and Associated Audio Information—Part 1: Systems,” ISO/IEC 13818-1 (MPEG-2), 1994 (see World Wide Web at iso.org).

PVR Personal Video Recorder (PVR) is a term that is commonly used interchangeably with DVR.

ReplayTV ReplayTV is a company leading DVR industry in maximizing users TV viewing experience. An explanation on ReplayTV may be found see World Wide Web at digitalnetworksna.com, replaytv.com.

RF Radio Frequency (RF) refers to any frequency within the electromagnetic spectrum associated with radio wave propagation.

RRT A Rate Region Table (RRT) is a table providing program rating information in an ATSC standard. A more extensive explanation of RRT may be found at “ATSC Standard A/65B: Program and System Information Protocol for Terrestrial Broadcast and Cable,” Rev. B, 18 Mar. 2003 (see World Wide Web at atsc.org).

SCR System Clock Reference (SCR) in the Program Stream (PS) indicates the sampled value of the system time clock that can be used for the correct presentation and decoding time of audio and video. A more extensive explanation of SCR may be found at “Generic Coding of Moving Pictures and Associated Audio Information—Part 1: Systems,” ISO/IEC 13818-1 (MPEG-2), 1994 (see World Wide Web at iso.org). PCR (Program Clock Reference) is an alternative or adjunct to SCR.

SDTV Standard Definition Television (SDTV) is one mode of operation of digital television that does not achieve the video quality of HDTV, but are at least equal, or superior to, NTSC pictures. SDTV may usually have either 4:3 or 16:9 aspect ratios, and usually includes surround sound. Variations of frames per second (fps), lines of resolution and other factors of 480p and 480i make up the 12 SDTV formats in the ATSC standard. The 480p and 480i each represent 480 progressive and 480 interlaced format explained in more detail in ATSC Standard A/53C with Amendment No. 1: ATSC Digital Television Standard, Rev. C 21 May 2004 (see World Wide Web at atsc.org).

SGML Standard Generalized Markup Language (SGML) is an international standard for the definition of device and system independent methods of representing texts in electronic form. A more extensive explanation of SGML may be found at “Learning and Using SGML” (see World Wide Web at w3.org/MarkUp/SGML/), and at “Beginning XML” (Wrox, December, 2001) by David Hunter.

SI System Information (SI) for DVB (DVB-SI) provides EPG information data in DVB compliant digital TVs. A more extensive explanation of DVB-SI may be found at “ETSI EN 300 468 Digital Video Broadcasting (DVB); Specification for Service Information (SI) in DVB Systems”, (see World Wide Web at etsi.org). ATSC-PSIP is an alternative or adjunct to DVB-SI and is considered or adopted for providing service information to countries using ATSC such as the U.S. and Korea.

STB Set-top Box (STB) is a display, memory, or interface devices intended to receive, store, process, decode, repeat, edit, modify, display, reproduce or perform any portion of a TV program or AV stream, including personal computer (PC) and mobile device.

STT System Time Table (STT) is a small table defined to provide the current date and time of day information in ATSC. Digital Video Broadcasting (DVB) has a similar table called a Time and Date Table (TDT). A more extensive explanation of STT may be found at “ATSC Standard A/65B: Program and System Information Protocol for Terrestrial Broadcast and Cable”, Rev. B, 18 Mar. 2003 (see World Wide Web at atsc.org).

S/W Software is a computer program or set of instructions which enable electronic devices to operate or carry out certain activities. A more extensive explanation of S/W may be found at “Concepts of Programming Languages” (Addison Wesley) by Robert W. Sebesta.

TCP Transmission Control Protocol (TCP) is defined by the Internet Engineering Task Force (IETF) Request for Comments (RFC) 793 to provide a reliable stream delivery and virtual connection service to applications. A more extensive explanation of TCP may be found at “Transmission Control Protocol Darpa Internet Program Protocol Specification” (see World Wide Web at ietf.org/rfc/rfc0793.txt).

TDT Time Date Table (TDT) is a table that gives information relating to the present time and date in Digital Video Broadcasting (DVB). STT is an alternative or adjunct to TDT for providing time and date information in ATSC. A more extensive explanation of TDT may be found at “ETSI EN 300 468 Digital Video Broadcasting (DVB); Specification for Service Information (SI) in DVB systems” (see World Wide Web at etsi.org).

TiVo TiVo is a company providing digital content via broadcast to a consumer DVR it pioneered. More information on TiVo may be found on the World Wide Web at tivo.com.

TOC Table of contents herein refers to any listing of characteristics, locations, or references to parts and subparts of a unitary presentation (such as a book, video, audio, AV or other references or entertainment program or content) preferably for rapidly locating and accessing the particular part(s) or subpart(s) or segment(s) desired.

TS Transport Stream (TS), specified by the MPEG-2 System layer, is used in environments where errors are likely, for example, broadcasting network. TS packets into which PES packets are further packetized are 188 bytes in length. An explanation of TS may be found at “Generic Coding of Moving Pictures and Associated Audio Information—Part 1: Systems,” ISO/IEC 13818-1 (MPEG-2), 1994 (see World Wide Web at iso.org).

TV Television, generally a picture and audio presentation or output device; common types include cathode ray tube (CRT), plasma, liquid crystal and other projection and direct view systems, usually with associated speakers.

TV-Anytime TV-Anytime is a series of open specifications or standards to enable audio-visual and other data service developed by the TV-Anytime Forum. A more extensive explanation of TV-Anytime may be found at the home page of the TV-Anytime Forum (see World Wide Web at tv-anytime.org).

TVPG Television Parental Guidelines (TVPG) are guidelines that give parents more information about the content and age-appropriateness of TV programs. A more extensive explanation of TVPG may be found on the World Wide Web at tvguidelines.org/default.asp.

uimsbf unsigned integer, most significant-bit first. The unsigned integer is made up of one or more 1s and 0s in the order of most significant-bit first (the left-most-bit is the most significant bit). A more extensive explanation of uimsbf may be found at may be found at “Generic Coding of Moving Pictures and Associated Audio Information—Part 1: Systems,” ISO/IEC 13818-1 (MPEG-2), 1994 (see World Wide Web at iso.org).

UTC Universal Time Co-ordinated (UTC), the same as Greenwich Mean Time, is the official measure of time used in the world's different time zones.

VBI Vertical Blanking Interval (VBI). Textual information such closed-caption text and EPG data can be delivered through one or more lines of the VBI of analog TV broadcast signal.

VCR Video Cassette Recorder (VCR). DVR is alternatives or adjuncts to VCR.

VCT Virtual Channel Table (VCT) is a table which provides information needed for the navigating and tuning of a virtual channels in ATSC and DVB. A more extensive explanation of VCT may be found at “ATSC Standard A/65B: Program and System Information Protocol for Terrestrial Broadcast and Cable,” Rev. B, 18 Mar. 2003 (see World Wide Web at atsc.org).

VOD Video On Demand (VOD) is a service that enables television viewers to select a video program and have it sent to them over a channel via a network such as a cable or satellite TV network.

VR The Visual Rhythm (VR) of a video is a single image or frame, that is, a two-dimensional abstraction of the entire three-dimensional content of a video segment constructed by sampling certain groups of pixels of each image sequence and temporally accumulating the samples along time. A more extensive explanation of Visual Rhythm may be found at “An Efficient Graphical Shot Verifier Incorporating Visual Rhythm”, by H. Kim, J. Lee and S. M. Song, Proceedings of IEEE International Conference on Multimedia Computing and Systems, pp. 827-834, June, 1999.

VSB Vestigial Side Band (VSB) is a method for modulating a signal. A more extensive explanation on VSB may be found at “Digital Television, DVB-T COFDM and ATSC 8-VSB” (Digitaltvbooks.com, October 2000) by Mark Massel.

WAN A Wide Area Network (WAN) is a network that spans a wider area than does a Local Area Network (LAN). More information can be found by at “Ethernet: The Definitive Guide” (O'Reilly & Associates) by Charles E. Spurgeon.

W3C The World Wide Web Consortium (W3C) is an organization developing various technologies to enhance the Web experience. More information on W3C may be found at see World Wide Web at w3c.org.

XML eXtensible Markup Language (XML) defined by W3C (World Wide Web Consortium), is a simple, flexible text format derived from SGML. A more extensive explanation of XML may be found at “XML in a Nutshell” (O'Reilly, 2004) by Elliotte Rusty Harold, W. Scott Means.

XML Schema A schema language defined by W3C to provide means for defining the structure, content and semantics of XML documents. A more extensive explanation of XML Schema may be found at “Definitive XML Schema” (Prentice Hall, 2001) by Priscilla Walmsley.

Zlib Zlib is a free, general-purpose lossless data-compression library for use independent of the hardware and software. More information can be obtained on the World Wide Web at gzip.org/zlib.

Prior-Art Techniques Related to the Present Disclosure

DVR can record many videos or TV programs in its local or associated storage. To select and play a program among the recorded programs of a DVR, the DVR usually provides a recorded list where each recorded program is represented at least with a title of the program in textual form. The recorded list might provide more textual information such as date and time of recording start, duration of a recorded program, channel number where the recorded program is or was broadcast, and possible other data. This conventional interface of the recorded list of DVR has the following limitations. First, it might not be easy to readily identify one program from others by the briefly listed list information. With a large number of recorded programs, the brief list may not provide sufficiently distinguishing information to facilitate rapid identification of a particular program. Second, it might be hard to infer the contents of programs only with textual information, such as their titles. If some visual clues of programs are available before playing the program, it might be helpful for users to decide which program they will choose to play. Third, users might want to memorize some programs in order to play or replay them later for some reasons, for example, they may not want to view the whole program yet, they want to view some portion of the program again, or they want to let their family members view the program. With a conventional interface, users have to memorize some of the textual information regarding the programs of their interest to find or revisit the programs later.

If some visual clues relating to the programs are provided in an advanced interface as disclosed herein, users can more easily identify and memorize the programs with their visual clues or combination of visual clues and textual information rather than only relying on the textual information. Also, the users can infer the contents of the programs without additional textual information such as a synopsis, before playing them, as visual clues (which may include associated audio or audible clues and/or associated other clues, including thumbnail images, icons, figures, and/or text) are far more directly related to the actual program than merely descriptive text.

In the web sites for on-line movie theaters and DVD titles, there are lists of movies and DVD titles that are or may be used to stimulate consumers to view a movie or purchase the DVD titles or other programs. In the lists, each movie or DVD title or other program is usually represented as associated with a thumbnail image that can be made by scaling down a movie poster of the movie or a cover design of the DVD title. The movie posters and the cover designs of DVD titles not only appeal to customer's curiosity but also allow the customers to distinguish and memorize the movies and DVD titles from their large archive more readily than merely descriptive text alone.

The movie posters and the cover designs of DVD titles usually have the following common characteristics. First, they seem to be a single image onto which some textual information is superimposed. The textual information usually includes the title of a movie or DVD or other program at least. The movie posters and the cover designs of DVD titles are usually intended to be self-describing. That is, without any other information, consumers can get enough information or visual impression to identify one movie/DVD title/program from others.

Second, the movie posters and the cover designs of DVD titles are shaped differently than the captured images of movies or TV programs. The movie posters and the cover designs of DVD titles appear to be much thinner-looking than the captured images. These visual differences are due to their aspect ratios. The aspect ratio is a relationship between the width and height of an image. For example, analog NTSC television has a standard aspect ratio of 1.33:1. In other words, the width of the captured image of a television screen is 1.33 times greater than its height. Another way to denote this is 4:3, meaning 4 units of width for every 3 units of height. However, the width and height of ordinary movie posters are 27 and 40 inches, respectively. That is, the aspect ratio of ordinary movie posters is 1:1.48 (which would be approximately 4:6 aspect ratio). Also, the cover designs of ordinary DVD titles have an aspect ratio of 1:1.4 (which would be 4:5.6 aspect ratio). Generally speaking, the movie posters and the cover designs of DVD titles have included images that appear to be “thinner” looking, and conversely, the captured images of movies and television screens have included images that appear to be “wider” looking than the movie/DVD posters.

Third, the movie posters and the cover designs of DVD titles are produced through a human operator's authoring efforts such as determining and capturing a significant or distinguishable screen image (or developing a composite image, as by overlapping a recognizable image on to a distinguishable scene), cropping a portion or object from the image, superimposing the portion or object onto other captured image(s) or colored background, formatting and laying out the captured image or the cropped portion or objects with some textual information (such as the title of a movie/DVD/program and the names of main actors/actresses), and adjusting background color and font color/style/size and so on. These efforts to produce effective posters and cover designs require cost, time and manpower.

The current graphic user interface (GUI) of Windows™ operating system provides views of a folder containing image files and video files by showing reduced-sized thumbnail images for the image files and reduced-sized thumbnail images captured from the video files along with their respective file names, and the existing GUI of most of currently available DVRs provides a list of recorded TV programs by using only textual information. (Thus, prior used and disclosed use of captured thumbnail images for DVR and PC do not have the effective form, aspect and “feel” or GUI of posters and cover designs.)

### BRIEF DESCRIPTION (SUMMARY)

According to this disclosure, the conventional and previously disclosed interface(s) of a recorded list of DVR which utilizes textual information to describe recorded programs and the GUI of Windows™ operating system can be improved when each recorded program or image/video file is represented with a combination of the textual information relative to a program along with an additional thumbnail image (or other visual or graphic image, which may be a still or an animated or short-run of video, with or without associated data, such as audio) related to the program or image/video file. The thumbnail image might be a screen shot captured from a frame of the recorded program and may be a modified screen shot, as by modifying aspect ratios and adding or deleting material to more effectively reflect a movie poster or DVD cover design GUI effect. This advanced interface provides the representation of audiovisual (recorded) list of a DVR or PC or the like by associating with a “poster-thumbnail” of each program (also herein called “poster-type thumbnail” or “poster-looking thumbnail”) because DVR users and movie viewers have already been accustomed to movie posters and cover designs of DVD titles at off-line movie theaters, DVD rental shops or diverse web sites for movies/movie trailers and DVD titles.

In the present disclosure, the poster-thumbnail of a TV program or video means at least a reduced-size thumbnail image of a whole frame image captured from the program (which can be obtained by manipulating the captured frame comprising a combination of one or more of analysis, cropping, resizing or other visual enhancement to appear more poster-like) and, optionally, some associated data related to the program (in the form of textual information or graphic information or iconic information such as program title, start time, duration, rating (if available), channel number, channel name, symbol relating to the program, and channel logo which may be disposed on or near the thumbnail image. As used herein, the term “on or near” includes totally or partially overlaid or superimposed onto the thumbnail image or closely adjacent to the thumbnail image, as discussed in greater detail hereinbelow. Associated data can also include audio.

In commonly-owned, copending U.S. patent application Ser. No. 10/365,576 filed Feb. 12, 2003, the concept of having a thumbnail image plus text adjacent the thumbnail image was discussed. In the present disclosure, the concept of having additional associated data such as textual, graphic or iconic information adjacent to or superimposed onto the thumbnail image is discussed.

One embodiment of a poster-thumbnail disclosed herein comprises a captured thumbnail image which is automatically manipulated by a combination of one or more of analysis, cropping, resizing or other visual enhancement.

Another embodiment of a poster-thumbnail disclosed herein comprises a manipulated captured thumbnail image with other associated data such as textual, graphic, iconic or audio items embedded or superimposed on the thumbnail image.

Another embodiment of a poster-thumbnail disclosed herein comprises an animated or short-run video in a thumbnail size. Combinations of the various embodiments are also possible.

According to this disclosure, the interface for the list of recorded programs of a DVR can also be improved such that an “animated thumbnail” of a program can be utilized along with associated data of the program, instead of or in combination with a static thumbnail. The animated thumbnail (which may have a adjusted aspect ratio or not, and may have superimposed or cropped images or text or not, and which may have an associated audio or other data not visually displayed on the thumbnail image) is a “virtual thumbnail” that may seem to be a slide show of thumbnail images captured from the program with or without associated audio or text or related information. In an embodiment disclosed herein, when the animated thumbnail is designated or selected on GUI, it will play a short run of associated audio or scrolling text (horizontally or vertically) or other dynamic related information. By just watching the animated thumbnail of a program, users can roughly preview a portion of the program before selecting or playing the program. Furthermore, the animated thumbnail is dynamic, thus it can catch more attention from users especially when there is but a single animated thumbnail on a screen. The thumbnail images utilized in an animated thumbnail can be captured dynamically, as by hardware decoder(s) or software image capturing module(s) whenever the animated thumbnail needs to be played. It is also possible that the captured thumbnail images are made into a single animated image file such as an animated GIF (Graphics Interchange Format), and the file can be repeatedly used whenever it needs to be played. As noted, the animated thumbnail may also be augmented or manipulated or have associated data.

One of the technical issues of these new interfaces for a DVR and the like is how to generate the poster-thumbnail or animated thumbnail automatically from a recorded program on a DVR. It is within the scope of this disclosure that the poster- or animated thumbnail of a broadcast program is made automatically or manually by a broadcaster or a third-party company, and then it is delivered to a DVR such as through ATSC-PSIP (or DVB-SI), VBI, data broadcasting channel, back channel or other manner. For the purposes of this disclosure, the term “back channel” is used to refer to any wired/wireless data network such as Internet, Intranet, Public Switched Telephone Network (PSTN), Digital Subscriber Line (DSL), Integrated Services Digital Network (ISDN), cable modem and the like.

There are disclosed herein new graphical user interfaces for navigation for a potential selection of a list of videos or other programs having video or graphic images using poster-thumbnails and/or animated thumbnails. While it is an object of this disclosure to introduce the novel usage of poster-thumbnails and animated thumbnails generally, what is disclosed is algorithmic methods to generate poster-thumbnails and animated thumbnails automatically from a given video file or broadcast/recorded TV program, and system(s) configuration adapted for use and display of these poster-thumbnails and animated thumbnails in a GUI.

These new user interfaces with poster-thumbnails or animated thumbnails can be utilized for diverse DVR GUI applications such as a recorded list of programs, a scheduled list of programs, a banner image of an upcoming program, and the like. Also, the new interfaces might be applied to VOD sites and web sites such as video archives, webcasting, and other graphic image files (such as “foil” or computerized or stored slide presentations). Such instant disclosure may be especially useful in the video viewing applications where many video files, streams or programs are successively archived and serviced, but there is no poster or representative artistic image of the videos otherwise available.

This disclosure provides for poster-thumbnail and/or animated thumbnail development and/or usage to effectively navigate for potential selection between a plurality of images or programs/video files or video segments. The poster- and animated thumbnails are presented in a GUI on adapted apparatus to provide an efficient system for navigating, browsing and/or selecting images or programs or video segments to be viewed by a user. The poster and animated thumbnails may be automatically produced without human-necessary editing and may also have one or more various associated data (such as text overlay, image overlay, cropping, text or image deletion or replacement, and/or associated audio).

According to the disclosure, a method of listing and navigating multiple video streams, comprises: generating poster-thumbnails of the video streams, wherein a poster-thumbnail comprises a thumbnail image and one or more associated data which is presented in conjunction with the thumbnail image; and presenting the poster-thumbnails of the video streams; wherein the one or more associated data is positioned on or near the thumbnail image. The step of generating poster-thumbnails of the video streams may comprise generating a thumbnail image of a given one of the video streams; obtaining one or more associated data related to the given one of the video streams; and combining the one or more associated data with the thumbnail image of the given one of the video streams. The video streams may be TV programs being broadcast or TV programs recorded in a DVR. The associated data for the TV programs may be EPG data, channel logo or a symbol of the program. When the associated data comprises textual information, presenting the textual information may comprise: determining font properties of the textual information; determining a position for presenting the textual information with the thumbnail image; and presenting the textual information with the thumbnail image.

According to the disclosure, apparatus for listing and navigating multiple video streams, comprises: means for generating poster-thumbnails of the video streams, wherein a poster-thumbnail comprises a thumbnail image and one or more associated data which is presented in conjunction with the thumbnail image; and means for presenting the poster-thumbnails of the video streams; wherein the one or more associated data is selected from the group consisting of textual information, graphic information, iconic information, and audio; and wherein the one or more associated data is positioned on or near the thumbnail image. The video streams may be TV programs being broadcast or TV programs recorded in a DVR. The associated data for the TV programs may be EPG data, channel logo or a symbol of the program.

According to the disclosure, a system for listing and navigating multiple video streams, comprises: a poster thumbnail generator for generating poster/animated thumbnails of the video streams; means for storing the multiple video streams; and a display device for presenting the poster thumbnails. The poster/animated thumbnail generator may comprise: a thumbnail generator for generating thumbnail images; an associated data analyzer for obtaining one or more associated data; and a combiner for combining the one or more associated data with the thumbnail images. The thumbnail generator may comprise: a key frame generator for generating at least one key frame representing a given one of the video streams; and a module selected from the group consisting of: an image analyzer for analyzing the at least one key frame; an image cropper for cropping the at least one key frame; an image resizer for resizing the at least one key frame; and an image post-processor for visually enhancing the at least one key frame. The combiner may further comprise means for combining, selected from the group consisting of adding, overlaying, and splicing the one or more associated data on or near the thumbnail image. The display device for presenting the poster thumbnails may comprise: means for displaying the poster-thumbnail images for user selection of a video stream; and means for providing a GUI for the user to browse multiple video streams.

### BRIEF DESCRIPTION OF THE DRAWINGS

Reference will be made in detail to embodiments of the disclosure, examples of which are illustrated in the accompanying drawings. The drawings are intended to be illustrative, not limiting, and it should be understood that it is not intended to limit the disclosure to the illustrated embodiments. The FIGs. are as follows:

FIG. 1A is a block diagram illustrating a system for digital broadcasting with EPG information and metadata service where media content, such as in the form of MPEG-2 transport streams and its descriptive and/or audio-visual metadata, are delivered to a viewer with a DVR, according to the present disclosure.

FIG. 1B is a block diagram illustrating a system for generating poster-thumbnails and/or animated thumbnails in a DVR, according to the present disclosure.

FIG. 1C is a block diagram illustrating a module for a poster/animated thumbnail generator, according to the present disclosure.

FIG. 2A is a screen image illustrating an example of a conventional GUI screen for providing a list of programs recorded in hard disks of a DVR, according to the prior art.

FIG. 2B is a screen image illustrating as example of a conventional GUI screen for providing a list of files with thumbnail images in Windows™ operating system for PC, according to the prior art.

FIGS. 3A, 3B, 3C, and 3D illustrate examples of thinner-looking poster-thumbnails generated from a given frame captured from a program or a video stream, according to the present disclosure.

FIGS. 4A and 4B illustrate examples of wider-looking poster-thumbnails generated from a given frame, captured from a program or a video stream, according to the present disclosure.

FIG. 4C illustrates examples of poster-thumbnails generated from two or more frames, captured from a program or a video stream, according to an embodiment of the prevent disclosure.

FIG. 4D illustrates an exemplary poster-thumbnail having associated data such as textual or graphic or iconic information which is positioned on or near the thumbnail image, according to an embodiment of the prevent disclosure.

FIGS. 5A, 5B, 5C, 5D, 5E, and 5F illustrate examples of poster-thumbnails resulting from FIGS. 3A, 3B, 3C, 3D, 4A, and 4B respectively, according to the present disclosure.

FIGS. 6A, 6B, 6C, and 6D are illustrations of four exemplary GUI screens for browsing programs of a DVR, according to the present disclosure.

FIGS. 7A and 7B are exemplary flowcharts illustrating an overall method for generating a poster-thumbnail for a given video stream or broadcast/recorded TV program automatically, according to an embodiment of the present disclosure.

FIGS. 8A and 8B are illustrations of a way to crop intelligently, according to the location, size and number of faces, according to the present disclosure.

FIGS. 9A and 9B illustrate exemplary GUI screens for browsing recorded programs of a DVR, according to an embodiment of the present disclosure.

FIG. 10 is an exemplary flowchart illustrating an overall method for generating an animated thumbnail for a given video stream or broadcast/recorded TV program automatically, according to an embodiment of the present disclosure.

FIG. 11A is a block diagram illustrating a system for providing DVRs with metadata including the actual start times of current and past broadcast programs, according to an embodiment of the present disclosure.

FIG. 11B is a block diagram illustrating a system for detecting actual start times of current broadcast programs by using an AV pattern detector, according to an embodiment of the present disclosure.

FIG. 12 is an exemplary flowchart illustrating the detection process done by the AV pattern detector, according to an embodiment of the present disclosure.

FIG. 13 is a block diagram illustrating a client DVR system that can play a recorded program from an actual start time of the program, if the scheduled start time is updated through EPG or metadata accessible from a back channel after the scheduled recording of the program starts or ends, according to an embodiment of the present disclosure.

FIG. 14 is an exemplary flowchart illustrating a process of adjusting the recording duration during scheduled-recording of a program when the actual start time and/or duration of the program is provided through EPG after the recording starts or ends, according to an embodiment of the present disclosure.

FIG. 15 is an exemplary flowchart illustrating a playback process of a recorded program when the scheduled start time and duration of the program is updated through EPG after the recording starts or ends, according to an embodiment of the present disclosure.

### DETAILED DESCRIPTION

The following description includes preferred, as well as alternate, embodiments of the system, method and apparatus disclosed herein. The description is divided into three sections, with section headings which are provided merely as a convenience to the reader. It is specifically intended that the section headings not be considered to be limiting in any way.

In the description that follows, various embodiments are described largely in the context of a familiar user interface, such as the Windows™ operating system and GUI environment. It should be understood that although certain operations, such as clicking on a button, selecting a group of items, drag-and-drop and the like, are described in the context of using a graphical input device, such as a mouse or TV remote control, it is within the scope of the disclosure (and specifically contemplated) that other suitable input devices, such as remote control, keyboard, voice recognition or control, tablets, and the like, could alternatively be used to perform the described functions. Also, where certain items are described as being highlighted or marked, so as to be visually distinctive from other (typically similar) items in the graphical interface, that any suitable means of highlighting or marking the items can be employed, and that any and all such alternatives are within the intended scope of the disclosure.

A variety of devices may be used to process and display delivered content(s), such as, for example, a STB which may be connected inside or associated with user's TV set. Typically, today's STB capabilities include receiving analog and/or digital signals from broadcasters who may provide programs in any number of channels, decoding the received signals and displaying the decoded signals.

Media Localization

To represent or locate a position in a broadcast program (or stream) that is uniquely accessible by both indexing systems and client DVRs is critical in a variety of applications including video browsing, commercial replacement, and information service relevant to specific frame(s). To overcome the existing problem in localizing broadcast programs, a solution is disclosed in the above-referenced U.S. patent application Ser. No. 10/369,333 filed Feb. 19, 2003, using broadcasting time as a media locator for broadcast stream, which is a simple and intuitive way of representing a time line within a broadcast stream as compared with the methods that require the complexity of implementation of DSM-CC NPT in DVB-MHP and the non-uniqueness problem of the single use of PTS. Broadcasting time is the current time a program is being aired for broadcast. Techniques are disclosed herein to use, as a media locator for broadcast stream or program, information on time or position markers multiplexed and broadcast in MPEG-2 TS or other proprietary or equivalent transport packet structure by terrestrial DTV broadcast stations, satellite/cable DTV service providers, and DMB service providers. For example, techniques are disclosed to utilize the information on the current date and time of day carried in the broadcast stream in the system_time field in STT of ATSC/OpenCable (usually broadcast once every second) or in the UTC_time field in TDT of DVB (could be broadcast once every 30 seconds), respectively. For Digital Audio Broadcasting (DAB), DMB or other equivalents, the similar information on time-of-day broadcast in their TSs can be utilized. In this disclosure, such information on time-of-day carried in the broadcast stream (for example, the system_time field in STT or other equivalents described above) is collectively called “system time marker”. It is noted that the broadcast MPEG-2 TS including AV streams and timing information including system time marker should be stored in DVRs in order to utilize the timing information for media localization.

An exemplary technique for localizing a specific position or frame in a broadcast stream is to use a system_time field in STT (or UTC_time field in TDT or other equivalents) that is periodically broadcast. More specifically, the position of a frame can be described and thus localized by using the closest (alternatively, the closest, but preceding the temporal position of the frame) system_time in STT from the time instant when the frame is to be presented or displayed according to its corresponding PTS in a video stream. Alternatively, the position of a frame can be localized by using the system_time in STT that is nearest from the bit stream position where the encoded data for the frame starts. It is noted that the single use of this system_time field usually do not allow the frame accurate access to a stream since the delivery interval of the STT is within 1 second and the system_time field carried in this STT is accurate within one second. Thus, a stream can be accessed only within one-second accuracy, which could be satisfactory in many practical applications. Note that although the position of a frame localized by using the system_time field in STT is accurate within one second, an arbitrary time before the localized frame position may be played to ensure that a specific frame is displayed.

Another method is disclosed to achieve (near) frame-accurate access or localization to a specific position or frame in a broadcast stream. A specific position or frame to be displayed is localized by using both system_time in STT (or UTC_time in TDT or other equivalents) as a time marker and relative time with respect to the time marker. More specifically, the localization to a specific position is achieved by using system_time in STT that is a preferably first-occurring and nearest one preceding the specific position or frame to be localized, as a time marker. Additionally, since the time marker used alone herein does not usually provide frame accuracy, the relative time of the specific position with respect to the time marker is also computed in the resolution of preferably at least or about 30 Hz by using a clock, such as PCR, STB's internal system clock if available with such accuracy, or other equivalents.

Alternatively, the localization to a specific position may be achieved by interpolating or extrapolating the values of system_time in STT (or UTC_time in TDT or other equivalents) in the resolution of preferably at least or about 30 Hz by using a clock, such as PCR, STB's internal system clock if available with such accuracy, or other equivalents.

Another method is disclosed to achieve (near)frame-accurate access or localization to a specific position or frame in a broadcast stream. The localization information on a specific position or frame to be displayed is obtained by using both system_time in STT (or UTC_time in TDT or other equivalents) as a time marker and relative byte offset with respect to the time marker. More specifically, the localization to a specific position is achieved by using system_time in STT that is a preferably first-occurring and nearest one preceding the specific position or frame to be localized, as a time marker. Additionally, the relative byte offset with respect to the time marker maybe obtained by calculating the relative byte offset from the first packet carrying the last byte of STT containing the corresponding value of system_time.

Another method for frame-accurate localization is to use both system_time field in STT (or UTC_time field in TDT or other equivalents) and PCR. The localization information on a specific position or frame to be displayed is achieved by using system_time in STT and the PTS for the position or frame to be described. Since the value of PCR usually increases linearly with a resolution of 27 MHz, it can be used for frame accurate access. However, since the PCR wraps back to zero when the maximum bit count is achieved, we should also utilize the system_time in STT that is a preferably nearest one preceding the PTS of the frame, as a time marker to uniquely identify the frame.

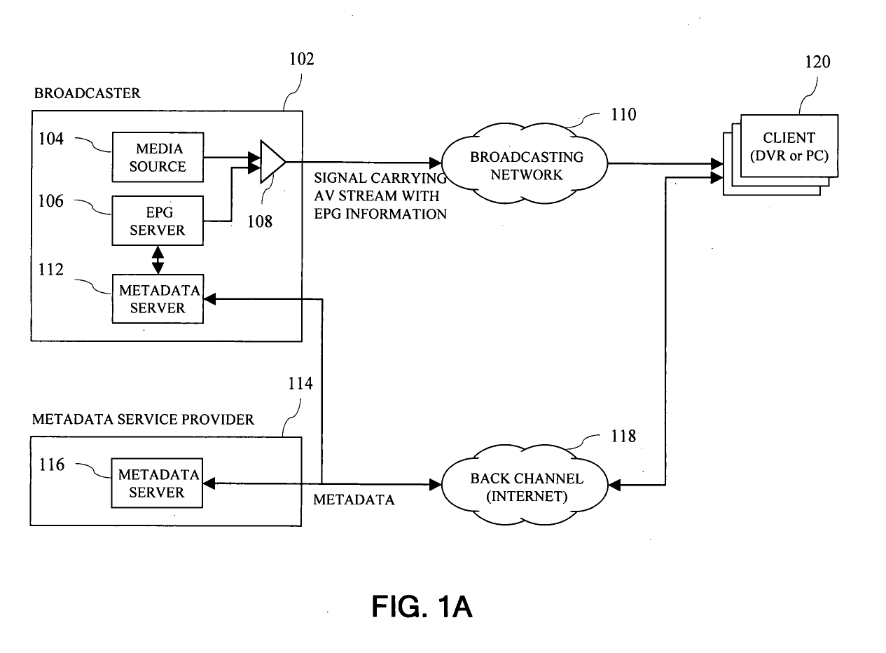

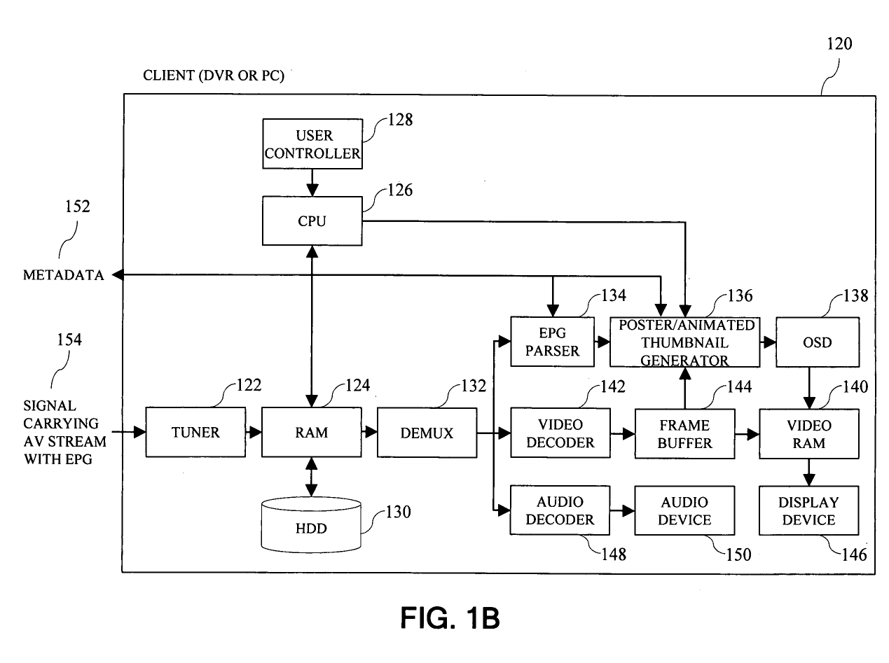

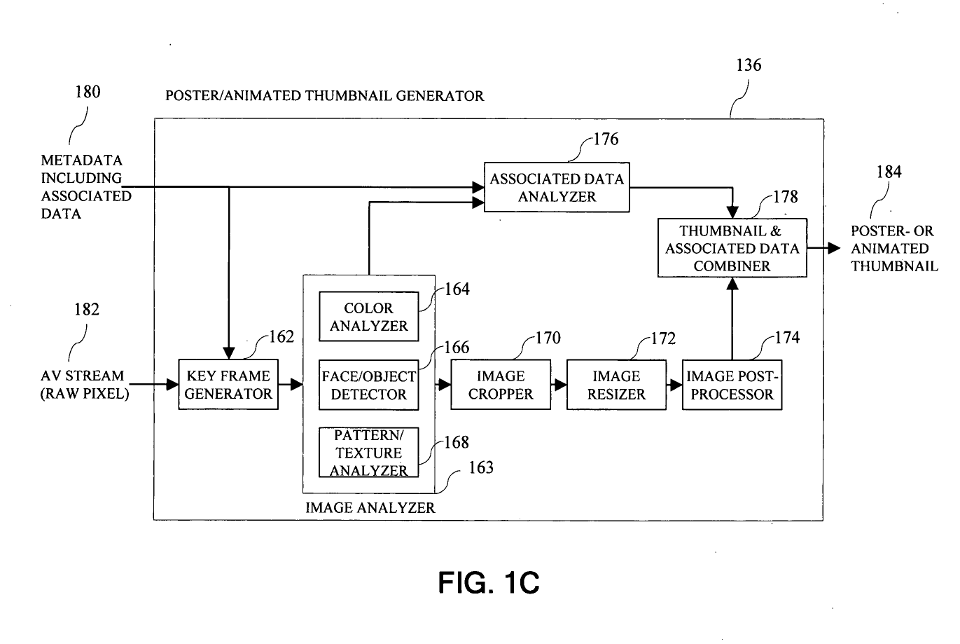

FIG. 1A is a block diagram illustrating a system for digital broadcasting with EPG information and metadata service where media content and its descriptive and/or audio-visual metadata, are delivered to viewers with a DVR or PC. The AV streams from a media source 104 and the EPG information stored at an EPG server 106 are multiplexed into digital streams, such as in the form of MPEG-2 transport streams (TSs), by a multiplexer 108. A broadcaster 102 broadcasts the signal carrying AV streams with EPG information to DVR clients 120 through a broadcasting network 110 such as satellite, cable, terrestrial and broadband network. The EPG information can be delivered in the form of PSIP for ATSC or SI for DVB or a proprietary format through VBI of an analog channel. The EPG information can be also delivered to DVR clients 120 through an interactive back channel 118 (such as the Internet). Also, descriptive and/or audio-visual metadata (such as in the form of either TV Anytime, or MPEG-7 or other equivalent) relating to the broadcast AV streams/programs can be generated and stored at metadata servers 112 of the broadcaster 102, and/or metadata servers 116 of one or more metadata service providers 114. The metadata including EPG information can be then delivered to DVR clients 120 through the interactive back channel 118. Alternatively, the metadata stored at the metadata server 112 or 116 can be multiplexed into the broadcast AV streams by the multiplexer 108, and then delivered to DVR clients 120.

FIG. 1B is a block diagram illustrating a system for generating poster-thumbnails and animated thumbnails in a DVR such as shown in FIG. 1A as 120. The system includes modules for receiving and decoding broadcast streams (for example, tuner 122, demultiplexer 132, video and audio decoders 142 and 148), in addition to modules commonly used in DVR or PC (for example, CPU 126, hard disk 130, RAM 124, user controller 128) as well as modules for generating poster-thumbnails and animated thumbnails (for example, poster/animated thumbnail generator 136). A tuner 122 receives broadcast signal 154 from the broadcasting network 110 in FIG. 1A such as satellite, cable, terrestrial and broadband network, and demodulates the broadcast signal. The demodulated signal is delivered to a buffer or random access memory (RAM) 124 in the form of bit streams, such as MPEG-2 TS, and stored at a hard disk or storage 130 if the stream needs to be recorded (the stream corresponding to a predetermined amount of time (for example, 30 minutes) is always recorded in DVR for time-shifting). The stream is delivered to a demultiplexer 132 when it needs to be decoded. The demultiplexer 132 separates the stream into a video stream, an audio stream and a PSIP stream for ATSC (or SI stream for DVB). The ATSC-PSIP stream (or DVB-SI stream) from the demultiplexer 132 is delivered to an EPG parser 134 which could be implemented in either in software or hardware. The EPG parser 134 extracts EPG data or programming information such as program title, start time, duration, rating (if available), genre, synopsis of a program, channel number and channel name. The metadata 152 can also be acquired from the back channel 118 in FIG. 1A wherein the metadata 152 includes associated data related to broadcast video streams or TV programs such as EPG data, graphic data, iconic data (for example, program symbol and channel logo) and audio. A video stream is delivered to a video decoder 142, decoded to raw pixel data, such as in the form of values of RGB or YCbCr. The decoded video stream is also delivered to a frame buffer 144. An audio stream is transferred to an audio decoder 148 and decoded, and then the decoded audio is supplied to an audio device 150 comprising audio speakers. When CPU 126 accesses a video stream, the CPU 126 can capture frames, and supply them to the poster/animated thumbnail generator 136 which could be implemented in either software or hardware. If the CPU 126 cannot access the video stream, due to scrambling of audio and video streams, for example, the frame buffer 144 can supply captured frame images from the hardware video decoder 142 to a poster/animated thumbnail 136. The poster/animated thumbnail generator 136 generates thumbnail images of a video stream with its captured frames, receives associated data relating to the video stream (EPG data from the EPG parser 134, and/or metadata 152 if available through the back channel 118) which is added, overlaid, superimposed or spliced on or near (hereafter, “combined with”) the thumbnail images of the video stream, thus generating poster-thumbnails or animated thumbnails. It is noted that associated data can be textual information, graphic information, iconic information, and even audio related to programs. Alternatively, the poster/animated thumbnail generator 136 can request and receive key frame images (or media locators for key frame images), thumbnail images, or even pre-made poster/animated thumbnails through the back channel 118 in FIG. 1A. The on-screen-display (OSD) 138 is for a graphical user interface to display the visual and associated data from the poster/animated thumbnail generator 136 and other graphical data such as menu selection. The video RAM 140 combines the graphical display data from the OSD 138 with the decoded frames from the frame buffer 144, and supplies them to a display device 146.

FIG. 1C is a block diagram illustrating a module for a poster/animated thumbnail generator such as shown in FIG. 1B as 136. An associated data analyzer 176 receives the EPG data from the EPG parser 134 in FIG. 1B and/or the metadata 180 including associated data related to programs thorough the back channel 118 in FIG. 1A. The associated data analyzer 176 then analyzes the associated data (EPG data and/or the metadata for a program) and select one or more associated data which is most important for users to identify or select a program. For example, in order to combine the thumbnail image of a program with its program title, the associated data analyzer 176 calculates the length of characters and the number of words of the program title, and adjusts the textual data if the program title is too long, and analyzes characteristic of the program such as mood and genre, and determine the text font properties such as color, style and size by using the data from a color analyzer module 164, face/object detector module 166 and pattern/texture analyzer module 168. The raw pixel data 182 from the frame buffer 144 in FIG. 1B is supplied to a key frame generator 162. The key frame generator 162 generates a key frame(s), and the generated key frame(s) is delivered to the image analyzer 163 comprising of the color analyzer 164, face/object detector 166, pattern/texture analyzer 168 and other image analysis modules. The color analyzer 164 determines a dominant color for the part of key frames on which the texts are to be overlaid, which is used to determine the font color. The face/object detector 166 detects faces and objects on a key frame, and the pattern/texture analyzer 168 analyzes the pattern or texture of a key frame. An image cropper 170 and image resizer 172 crops and resizes the key frame image, respectively, by using the information from the color analyzer 164, face/object detector 166 and pattern/texture analyzer 168. The cropped and resized image is supplied to an image post-processor 174 that enhances the visual quality of (hereafter, “visually enhances”) the cropped and resized image by using existing image processing and graphics techniques such as contrast enhancement, brightening/darkening, boundary/edge detection, color processing, segmentation, spatial filtering, and background synthesis to make the resulting image visually more pleasing to viewers. If a predefined area planned for a poster-thumbnail is partially covered by the cropped and resized image(s), a remaining area might be filled or synthesized with background whose color, pattern and/or texture can be also determined by using the information from the image analyzer. The image post-processor 174 thus generates a thumbnail image(s) of a program. Thus, the key frame from the key frame generator 162 is manipulated by a combination of analysis, cropping, resizing and visual enhancement. A thumbnail and associated data combiner 178 combines the one or more associated data from the associated data analyzer 176 with the thumbnail image from the image post-processor 174, and a combined poster-thumbnail 184 is delivered to the OSD 138 in FIG. 1B. It should be noted that the key frame generator 162 needs the start time and duration of the broadcast program, in order to generate an appropriate key frame(s) belonging to the program of interest. The actual start time and duration of the program, if there is discrepancy between actual start time and the start time of the EPG data delivered to the key frame selector 162, might be provided to the key frame generator 162 through the metadata 180 as shown in FIG. 1C. It is noted that, instead of using the key frame to generate the thumbnail image from the image post-processor 174, other representative visual or graphic image relevant to the video stream, for example, obtained from the back channel can be used to generate a poster-/animated thumbnail.

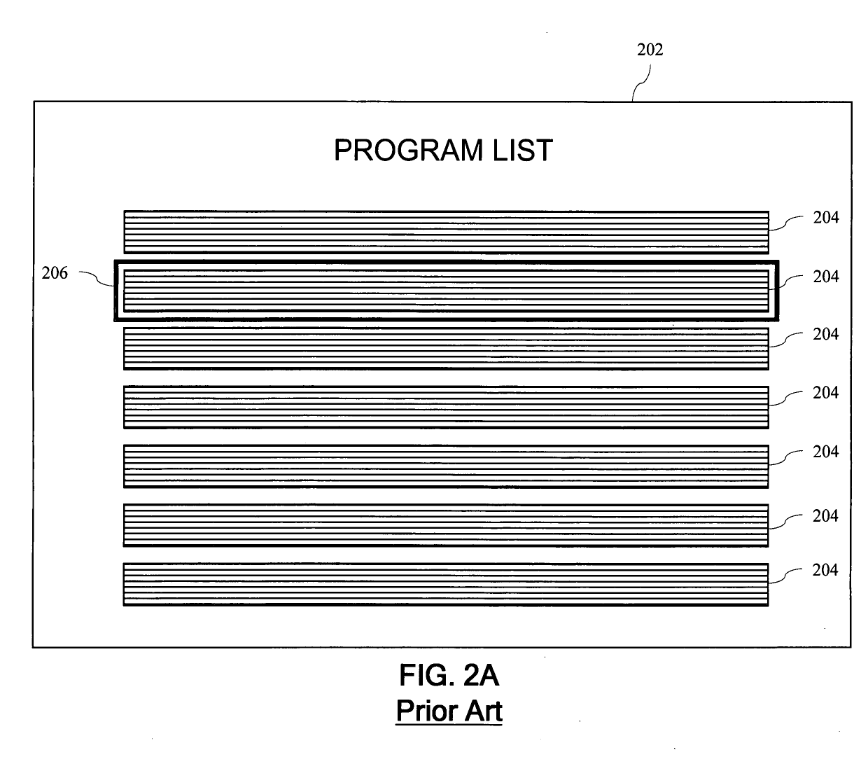

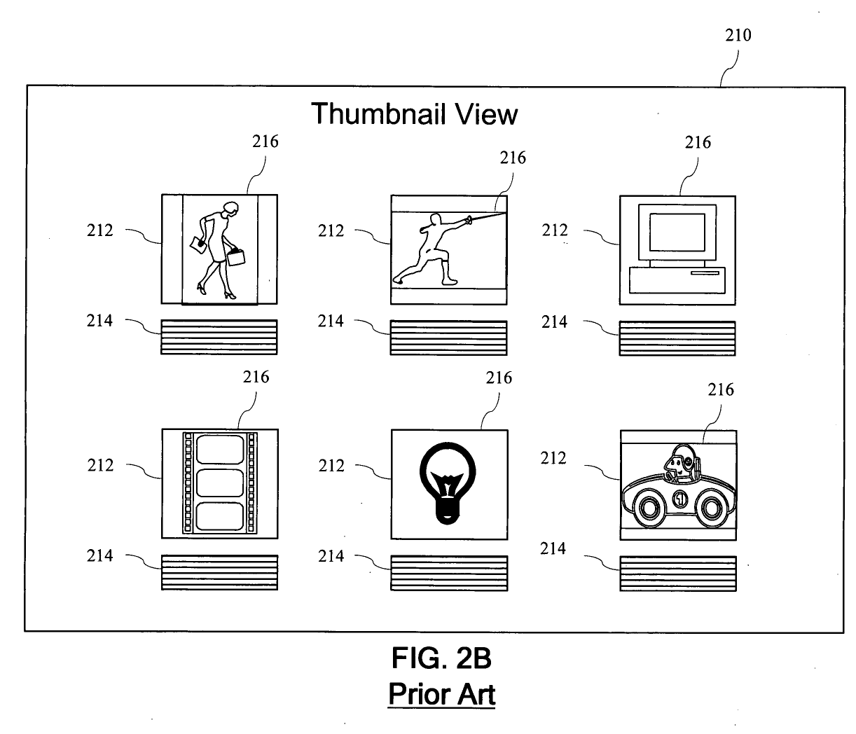

FIG. 2A is a screen image illustrating an example of a conventional GUI screen for providing a list of programs recorded in an associated storage, such as a hard disk(s) of a DVR, wherein like numbers correspond to like features. In the figure, the seven recorded programs represented by the text fields 204 are listed on a display screen 202. For each of a plurality of recorded programs, information of a program such as title, recording date and time (or equivalently start time), duration and channel number of the program is displayed in each text field 204. Using a control device such as a remote control, a user selects a program to play by moving a cursor indicator 206 (shown as a visually-distinctive, heavy line surrounding a field) upward or downward, in the program list. This can be done by scrolling though the text fields 204. The highlighted text field may be then activated to play the associated program.

FIG. 2B is a screen shot illustrating an example of a conventional GUI screen for showing a thumbnail view of video and image files in a folder in Windows™ operating system of Microsoft corporation, wherein like numbers correspond to like features. In the figure, the six files represented by the text fields 214 and the thumbnail images 216 in image fields 212 are listed on a display screen 210. File names are located in the text field 214. The thumbnail images 216 are linearly scaled/resized images in case of still image files, such as in the form of JPEG, GIF and BMP, and captured and linearly scaled frame images in case of video files such as MPEG and ASF files. An image field 212 is a shape of a square, so parts of image field not covered by the thumbnail image 216 are left blank. When a thumbnail image is selected by using a mouse, the video file can be played on a new window by double-clicking the thumbnail image.

1. Poster-Thumbnails

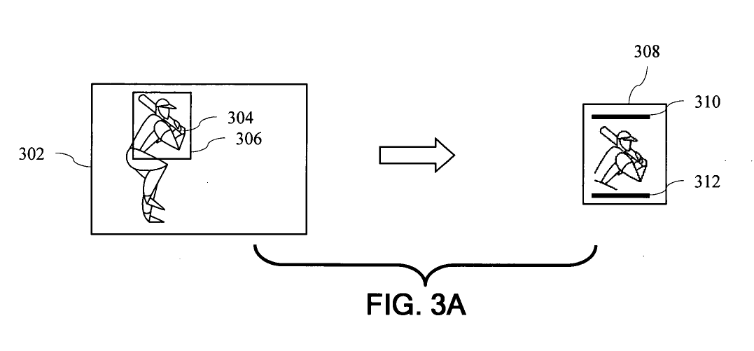

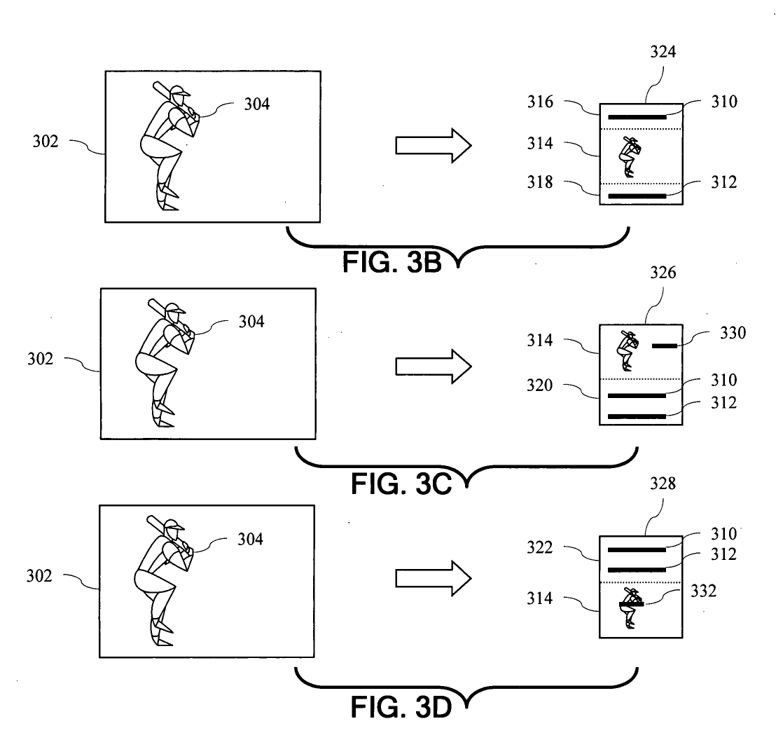

FIGS. 3A, 3B, 3C, and 3D illustrate examples of thinner-looking poster-thumbnails generated from a given frame captured from a TV program or a video stream. In the figures, an image 302 is a captured frame where a baseball batter 304 is standing to hit a ball. FIG. 3A illustrates an example of a thinner-looking poster-thumbnail 308 that is generated by cropping, resizing, and overlaying. In the figure, the thinner-looking rectangular area of interest 306 is cropped from the captured frame 302, and the cropped area is resized to fit in a predefined size of a thinner-looking poster-thumbnail 308. The associated data 310 and 312 can be located on any area above, below, beside and/or on the resized cropped area. The associated data can be textual information or graphic information or iconic information or the like such as a title of the program, start time, duration, rating, channel number, channel name, names of main actors/actresses, symbol relating to the program, and channel logo. In the figure, the associated data 310 and 312 are located on the upper and lower part of the poster-thumbnail, respectively.

As compared to FIG. 3A, FIGS. 3B, 3C, and 3D, wherein like numbers correspond to like features, illustrate examples of thinner-looking poster-thumbnails that are generated by resizing, overlaying and background synthesis, without cropping. In FIG. 3B, the captured frame 302 is resized to fit in a predefined size of a thinner-looking poster-thumbnail 324 such that the width of the resized captured frame 314 is equal to that of the poster-thumbnail 324. Then, the resized captured frame 314 is located at the middle of the poster-thumbnail 324. The background color of the poster-thumbnail 324 is determined to match well (or to contrast or other visual effect) with the resized captured frame 314. In the figure, the background color of the poster-thumbnail 324 is determined to be white because the resized captured frame 314 also has a white background, thus the whole thinner-looking poster-thumbnail 324 seems to be a single image. Alternatively, the background colors of the regions of 314, 316, and 318 of the poster-thumbnail 324 may vary, such as red, green and blue, respectively, to show contrasts or effects. Finally, the associated data 310 and 312 may be positioned onto an upper part 316 and a lower part 318 of the predefined area for the poster-thumbnail 324. FIGS. 3C and 3D are similar to FIG. 3B except that the resized captured frame 314 is located at the top (FIG. 3C) and the bottom (FIG. 3D) of the thinner-looking poster-thumbnails 326 and 328, respectively, and the associated data 310 and 312 are located onto a lower part 320 (FIG. 3C) and a upper part 322 (FIG. 3D) of the predefined area for the poster-thumbnails 326 and 328, respectively. As noted below for wider-looking poster-thumbnails, additional associated data 330 and 332 may also be positioned over or replace part of the resized frame image, even for thinner-looking poster-thumbnails.

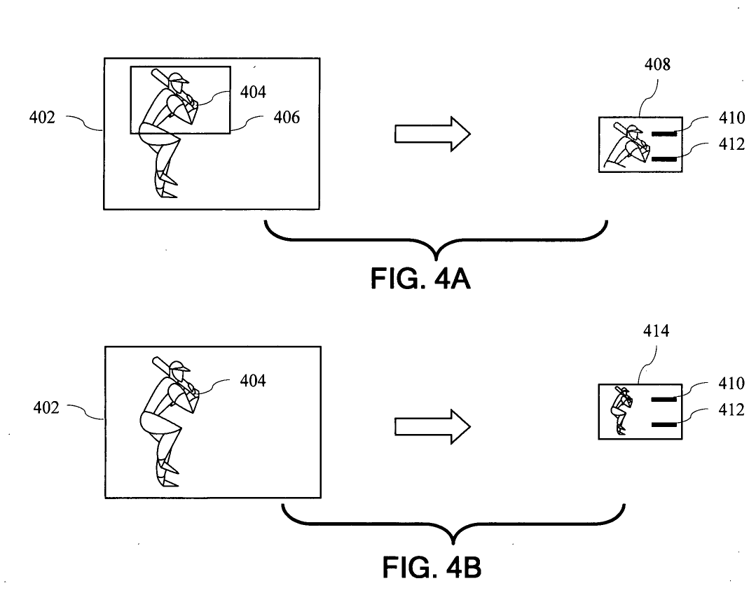

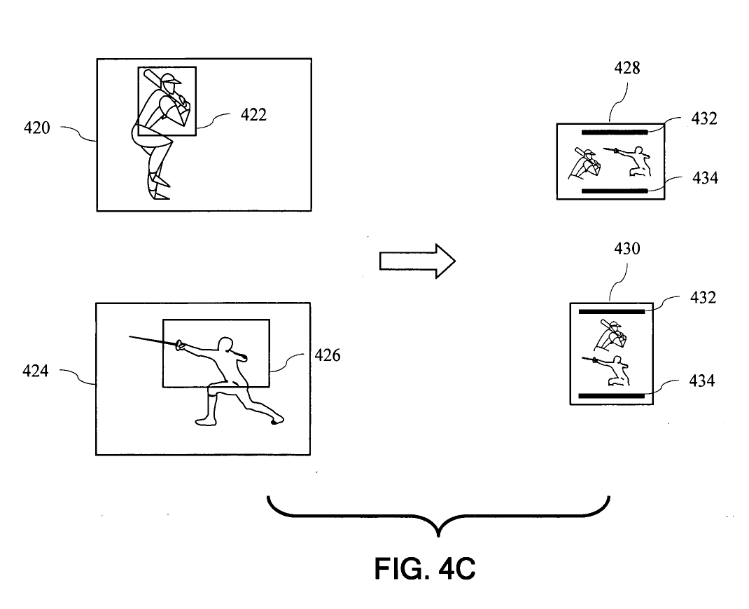

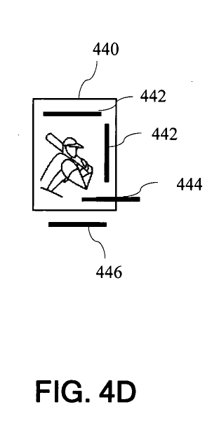

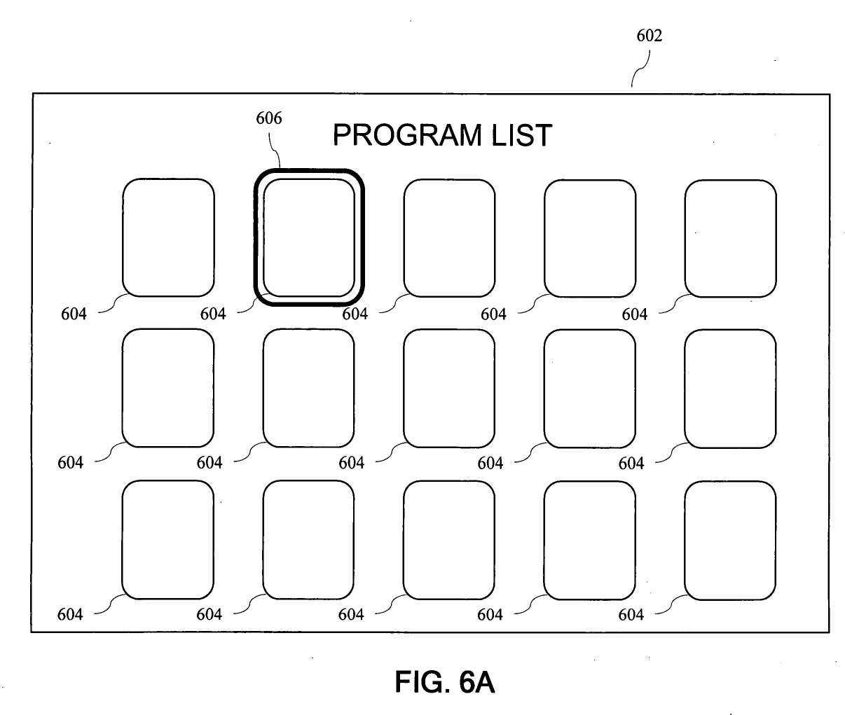

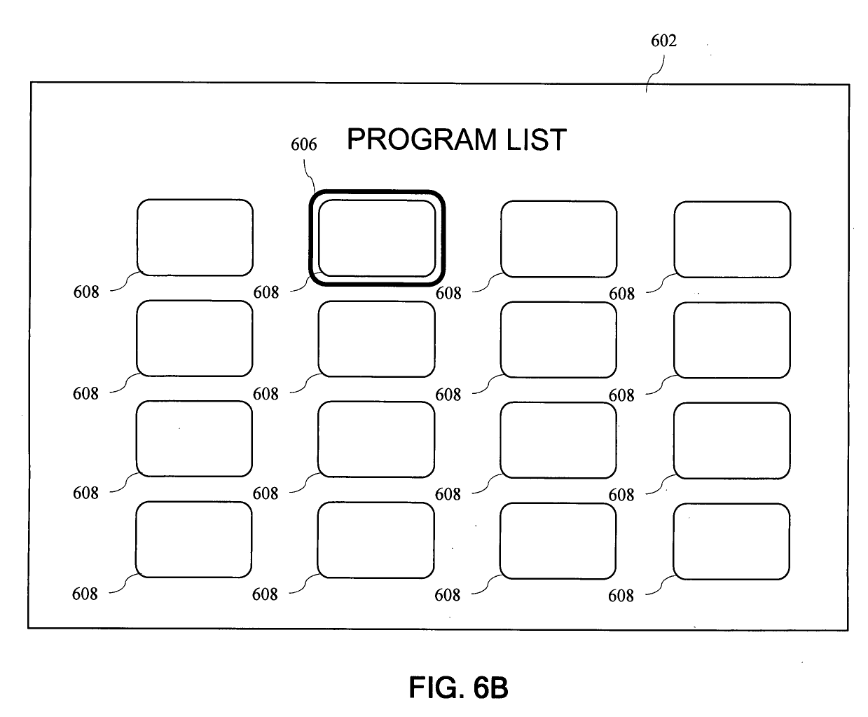

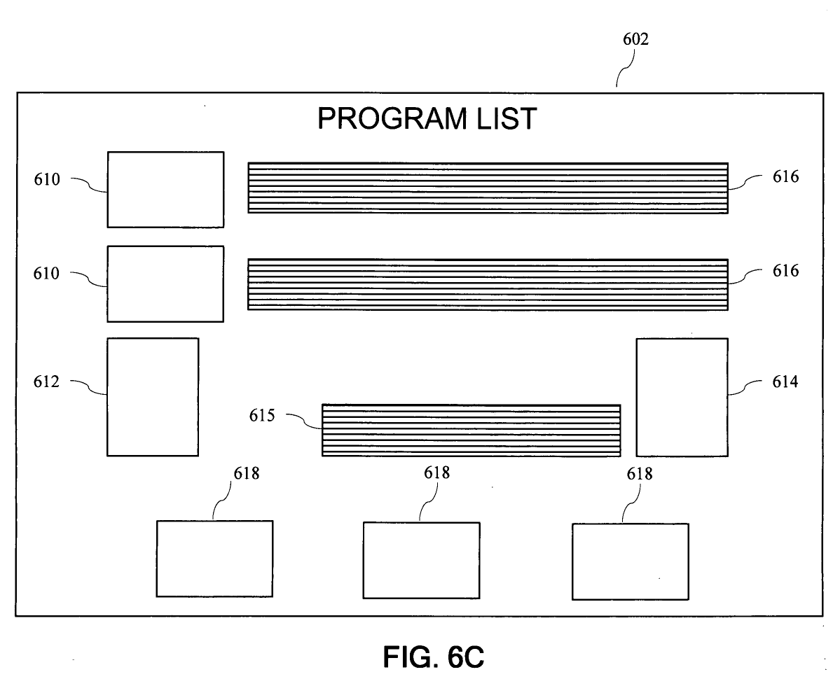

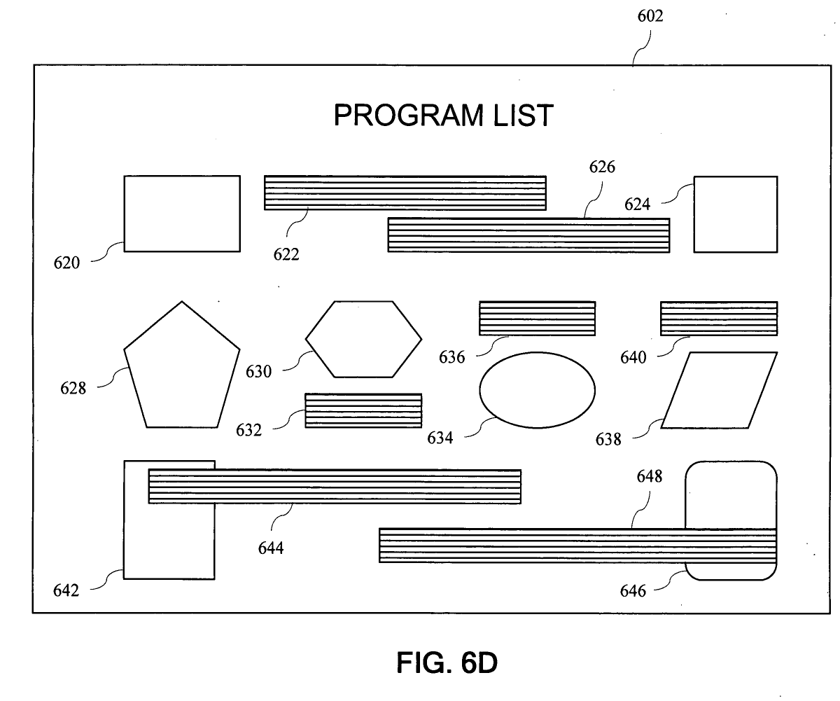

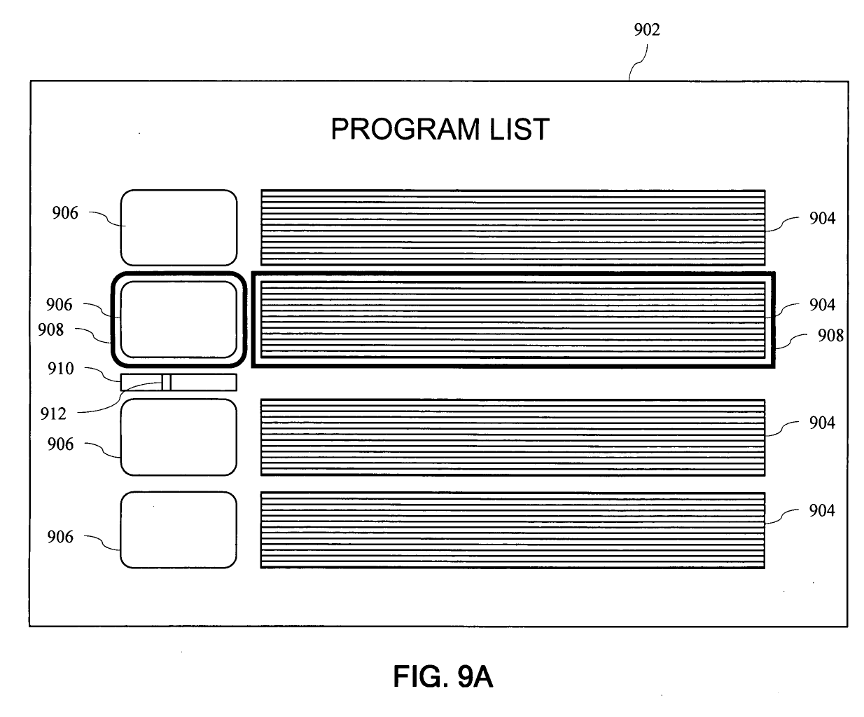

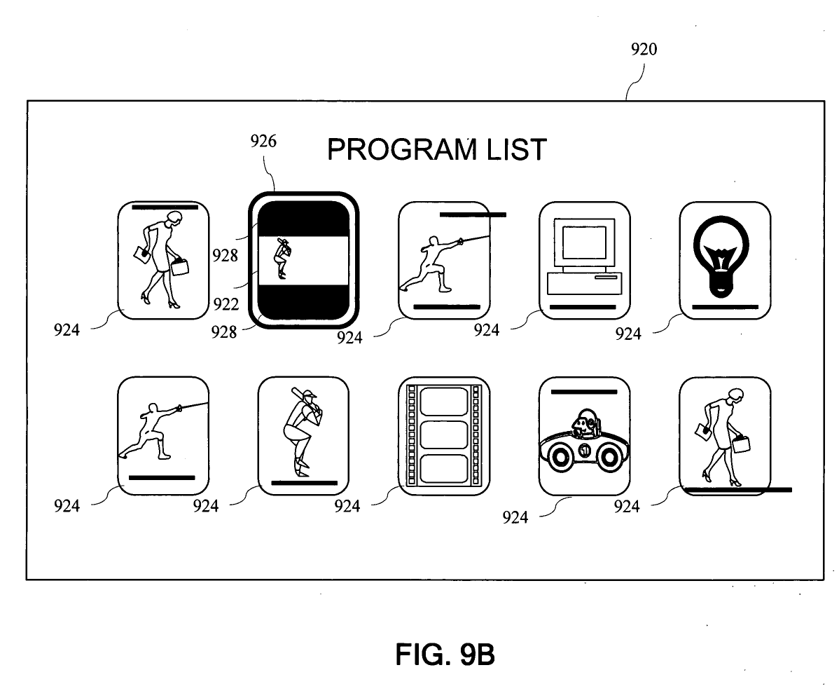

FIGS. 4A and 4B illustrate examples of wider-looking poster-thumbnails generated from a given frame image, captured from a program or a video stream, wherein like numbers correspond to like features. In the figures, the image 402 is a captured frame where a baseball batter 404 is standing to hit a ball. FIG. 4A illustrates an example of a wider-looking poster-thumbnail that is generated by one or all of cropping, resizing, and superimposing. In the figure, the wider-looking rectangular area of interest 406 is cropped from the captured frame 402, and the cropped area may be (if necessary) resized to fit in a predefined size of a wider-looking poster-thumbnail 408. Finally, the associated data 410 and 412 can be located (as by superimposing, or overlaying, or replacing portions of the area 406) on any predefined area(s) for the poster-thumbnail 408. In the figure, the associated data 410 and 412 are located on the right-upper and right-lower part of the poster-thumbnail 408, respectively, but any location and any number of lines and characters of text are appropriate, and hereby disclosed. FIG. 4B illustrates another example of a wider-looking poster-thumbnail that is generated by one or both of resizing and superimposing but without cropping. In the figure, the captured frame 402 (or essentially the entire frame intended for view)—as, for example, the round-cornered thumbnail images used in FIGS. 6A, 6B, 9A, and 9B or for letter-box format thumbnail images, is resized to fit in a predefined size of a wider-looking poster-thumbnail 414. Finally, the associated data 410 and 412 can be located on any predefined area(s) for the poster-thumbnail 414, and is shown superimposed onto the resized captured frame, located on a right-upper and right-lower part of the poster-thumbnail 414, respectively.

FIG. 4C illustrates examples of poster-thumbnails that are generated from two or more frames, captured from a program or a video stream, according to an embodiment of the prevent disclosure. In the figure, the cropped regions 422 and 426 from the captured frames 420 and 424, respectively, are combined into a single poster-thumbnail 428 or 430, which could be either a thinner-looking or wider-looking poster-thumbnail. In FIG. 4C, only two images are used for generating a poster-thumbnail, but three or more images can be combined or utilized. It is noted that a poster-thumbnail can be generated by combining two or more poster-thumbnails, for example in the thumbnail and associated data combiner 178 in FIG. 1C. The associated data 432 and 434 can be located (as by superimposing or overlaying) on appropriate area(s) of the poster-thumbnails 428 and 430.

FIG. 4D illustrates an exemplary poster-thumbnail having associated data which is positioned on or near the thumbnail image. The associated data 442 is totally overlaid on the thumbnail image 440, and the associated data 444 is partially overlaid on the thumbnail image 440 while the associated data 446 is closely adjacent to the thumbnail image 440.

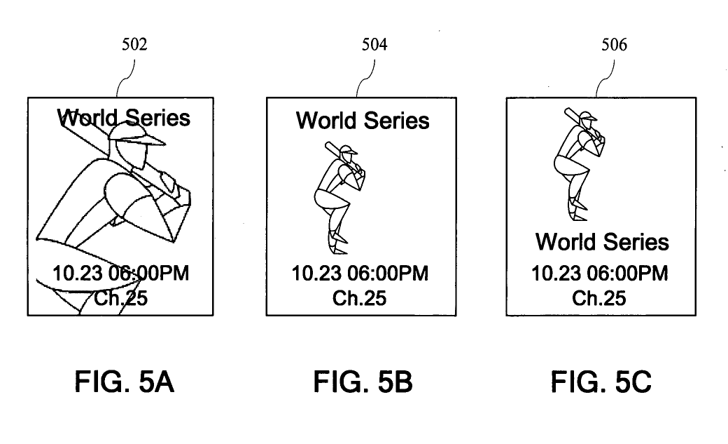

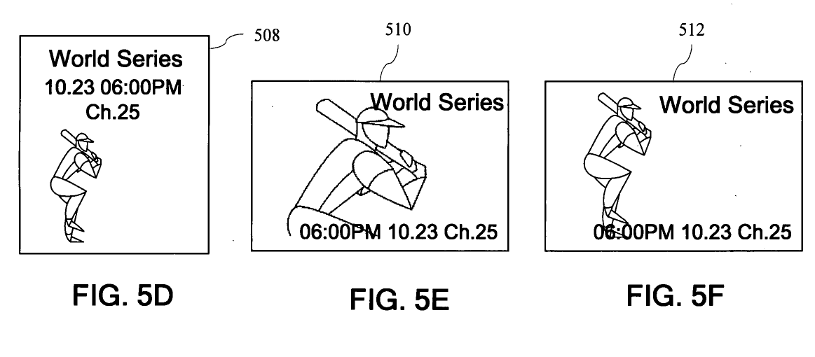

FIGS. 5A, 5B, 5C, 5D, 5E, and 5F illustrate examples of poster-thumbnails resulting from FIG. 3A at 502, from FIG. 3B at 504, from FIG. 3C at 506, from FIG. 3D at 508, from FIG. 4A at 510, and from FIG. 4B at 512, respectively. In all poster-thumbnails shown, there are two kinds of textual information usually displayed. One is for the title of the recorded program entitled “World Series”, the other is for the broadcast date and time of broadcast (or equivalently start time), and channel number, for example, “10.23 06:00 PM Ch.25”. However, more or less or different (or none) textual (or visual) information such as channel logo, rating, genre and duration of actual viewing (as pie chart) may be displayed as text or visual image/icon on, in or associated with the poster-thumbnail(s) as disclosed herein. Note also that two lines of text (as shown at FIGS. 3A, 3B, 3C, and 3D) may be expanded into three (or more, not shown) lines as at 502, 504, 506 and 508, respectively, while the two lines of text (as shown at FIGS. 4A and 4B) may stay as two displayed lines (or less, not shown) as at 510 and 512, respectively. Additionally, such poster-thumbnails may be any shape, including rectangles (shown), triangles, squares, hexagons, octagons, and the like (with or without curved or rounded edges as shown for the rectangles) as well as circles, ellipses and the like—all in centered or thinner or wider or angled orientations and configurations as desired.

FIGS. 6A and 6B are illustrations of two exemplary GUI screens for browsing programs of a DVR, wherein like numbers correspond to like features. In FIG. 6A, fifteen thinner-looking poster-thumbnails 604 are displayed on a single screen 602 where each of the three rows has five poster-thumbnails, respectively. In FIG. 6B, sixteen wider-looking poster-thumbnails 608 are also displayed on a single screen 602 where each four row has four poster-thumbnails, respectively. In the figures, a poster-thumbnail surrounded by a cursor indicator 606 (shown as a visually-distinctive, heavy line) represents a program that a user selected or wants to play. The cursor indicator 606 can be moved upward, downward, left or right as by using a control device such as a remote control. In FIGS. 6A and 6B, there is no textual information shown such as the field 204 of FIG. 2A. However, it should be noted that the GUI screens utilizing the poster-thumbnails are not limited to the ones in the figures, but can be freely modified such that any one or more poster-thumbnail(s) may have an appropriate additional associated data field, such as a textual field for information including synopsis, the cast, time, date, duration and other information. It should be noted that the textual data in the additional associated data field can be the same or similar or different data superimposed onto its corresponding poster-thumbnail. The additional text or other data could be in a space below/above/beside/on the poster-thumbnail. Also, they could be highlighted or selected. And, as described, poster-thumbnail(s) may be of any preferred shapes and orientation (for example, thin versus wide) and configured on GUI as preferred.

FIG. 6C is an illustration of another exemplary GUI screen having poster-thumbnails with or without additional associated data, or all combinations and permutations. In FIG. 6C, wider-looking poster-thumbnails 610 with additional associated data 616, thinner-looking poster-thumbnail 612 without additional associated data, a thinner-looking poster-thumbnail 614 with additional associated data 615, and wider-looking poster-thumbnails 618 without additional associated data are mixed on a single screen 602. Additional associated data (for example, notes and separated “Text”) with visual space between (that is “closer” to a poster-thumbnail) is associated with the poster-thumbnail.

FIG. 6D is an illustration of another exemplary GUI screen having diverse shaped poster-thumbnails with or without additional associated data in the form of textual information or graphic information or iconic information. In the figure, a sharp-cornered wider-looking poster-thumbnail 620 and a sharp-cornered square poster-thumbnail 624 have their additional associated data 622 and 626 beside corresponding poster-thumbnails, respectively. A pentagonal poster-thumbnail 628 is displayed without additional associated data. The additional associated data 632 of a hexagonal poster-thumbnail 630 is in a space below the poster-thumbnail 630. The additional associated data 636 and 640 of a circular (or oval) poster-thumbnail 634 and a parallelogram poster-thumbnail 638 are in a space above the poster-thumbnails 634 and 638, respectively. Also, the additional associated data 644 and 648 of a sharp-cornered thinner-looking poster-thumbnail 642 and a round-cornered thinner-looking poster-thumbnail 646 are in a space (thus, partially overlaying) on their poster-thumbnails 642 and 646, respectively.

In FIGS. 6A, 6B, 6C, and 6D, the poster-thumbnails listed in the present program list might be ordered according to the following characteristics or inverse characteristics such as the least watched positions at the top of the list, or the most often viewed positions at the top of the list. Many other ordering or categorizing schemes are explicitly considered, such as grouping of programs by like or similar topic; common actor(s), directors, film studios, authors, producers, and the like; date or period of release; common items or artifacts displayed in the program; and any other pre-selected or later selected (as by the user dynamically) criteria. The total time of playback for individual programs can be also used: The programs can be sorted in the order of recently accessed/played as well as the number of accesses. If a user watches a recorded program for a long time, it signifies that the recorded program is of interest to the user and therefore may be listed at the top above other programs. In order to keep track of the total amount of playback time for each respective program, the DVR or PC keeps a user history of how long a user has viewed each program and the list is presented accordingly based on the total time of playback for each program. More particularly, some listing order or grouping criteria may include:
By genre information that is provided by broadcasters or service providers
By favorites designated by users such as specific actor/director/production company/production period (for example, 1950-1959)
By user preference (for example, Sam may have a different order than Joe)
By internal characteristics (for example, I like Humphrey Bogart, so prioritize by number of minutes he is visible in movie)
By related movies (for example, when select “Alien I”, then sequels of Alien II, III, and IV pop up is next in order if exists)
By temporal (for example, during holidays, promote specials)
By primary language or available languages such as dubbing or subtitles
By age/copyright of film
By awards (for example, Oscar winners of 2004, 2003, 2002, etc)
By popularity (for example, the highest grossing films of 2004, 2003, 2002, etc)
By date and time of recording or broadcasting
By date and time of first or last viewing
By the number of viewings or the number of the most often viewed
By duration or duration of actual viewing
By alphabetic order of titles
By channel number of programs
By program series (for example, CSI, NYPD, etc)
   All being ordered by one or more titles of the characteristics (at least original ordering), users should be able to override and/or modify an order if they want. Listing order or grouping criteria can be also automatically varied according to the total number of programs, series or genres available.

In FIGS. 6A, 6B, 6C, and 6D, the poster-thumbnails may have various borders. In such a case, the number of borders, shape(s), pattern(s), border color(s) and texture(s) of borders can be changed according to characteristics such as genre of video, favorites by designation, user preference, dominant color of the thumbnail image, and many other criteria.

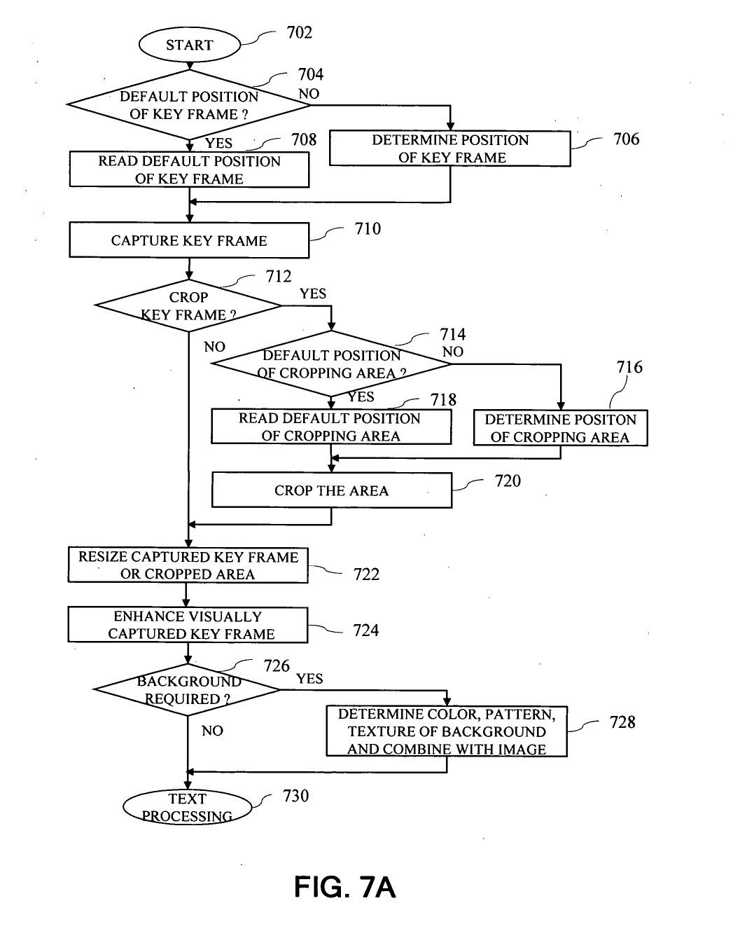

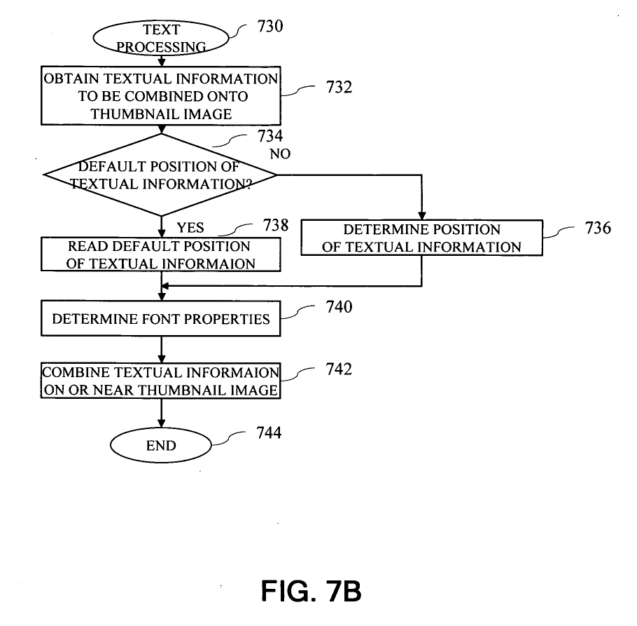

FIGS. 7A and 7B are flowcharts illustrating an exemplary overall method for automatically generating a poster-thumbnail for a given video stream or broadcast/recorded TV program wherein textual information is only considered as associated data. The generation process of a poster-thumbnail of a video stream comprises generating a thumbnail image of a video stream, obtaining one or more associated data relating to the video stream, and combining the one or more associated data with the thumbnail image of the video stream. Furthermore, generating a thumbnail image of a video stream further comprises generating at least one key frame for the video stream and manipulating the at least one key frame by cropping, resizing and other visual enhancement.

In FIG. 7A, the process for generating a poster-thumbnail starts at step 702. In order to generate a poster-thumbnail of a video or related program, at least one captured image of a key frame of the video is required. A key frame is a single, still image derived from a program comprising a plurality of image, best representing the video program, for example. A key frame can be generated by setting some fixed position or time point of the video as a position of the key frame. For example, any frame such as the first or 30^{th} frame from the beginning of the video, or a frame located at the middle of the video can be a key frame. In these cases, the generated key frame can hardly represent the whole content of a video semantically well. To get a better key frame that can semantically represent the whole content of a video, a more systematic way is needed to find the position of a key frame even though it requires more computations. There have been a variety of existing algorithms for key frame generation problem(s), such as Hyun-Sung Chang, Sanghoon Sull, and Sang-Uk Lee, “Efficient Video Indexing Scheme for Content-Based Retrieval,” IEEE Trans. Circuits and Systems for Video Technology, vol. 9, pp. 1269-1279, December 1999. It is noted that a key frame(s) can be generated from a reduced-size frame image sequence of the video to reduce computation, especially for HDTV streams. A key frame for a TV program should not be generated from commercials if commercials are inserted into the program. To avoid generating a key frame from the part of the video or program corresponding to commercials, some existing commercial detection algorithms, such as Rainer Lienhart, Christoph Kuhmiinch and Wolfgang Effelsberg, “On the detection and recognition of television commercials,” in Proc. of IEEE International Conference on Multimedia Computing and Systems, pp. 509-516, June 1997 can be utilized. A check for a default position of key frame 704 is made to determine whether one or combination of such algorithms will be utilized or not. If such algorithms are to be utilized, the position of a key frame is determined by executing one or combination of algorithms in step 706, and the control then goes to step 710. Otherwise, a default position of a key frame is read at step 708. At step 710, a key frame at a default or determined position is captured. Alternatively, key frame image(s) of a program itself or positional information of key frame(s) of a program can be delivered, through a broadcasting network or back channel (such as the Internet), to DVR or PC in the form of metadata such as in either TV Anytime, or MPEG-7 or other equivalent. Alternatively, key frame image(s) of a program itself or positional information of key frame(s) of a program can be supplied by TV broadcasters through EPG information or back channel (such as the Internet). In these cases, the steps from 704 through 710 (when the key frame image(s) itself is supplied) or from 704 through 708 (when the positional information of key frame(s) is supplied) can be omitted, respectively.

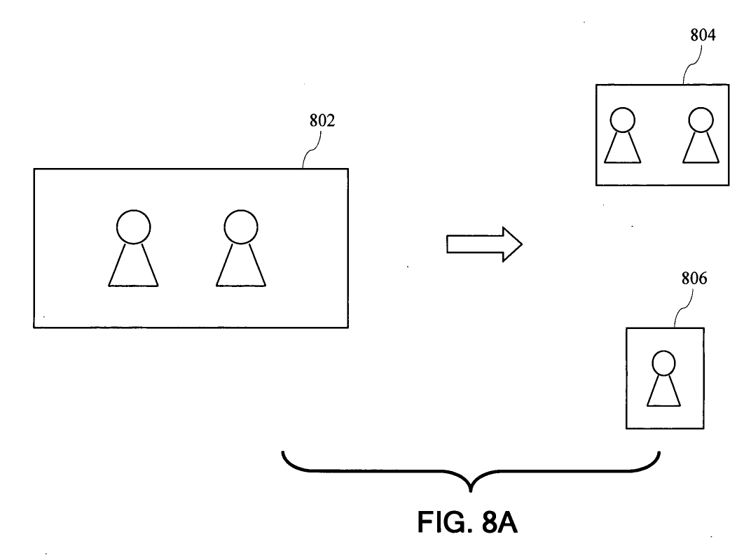

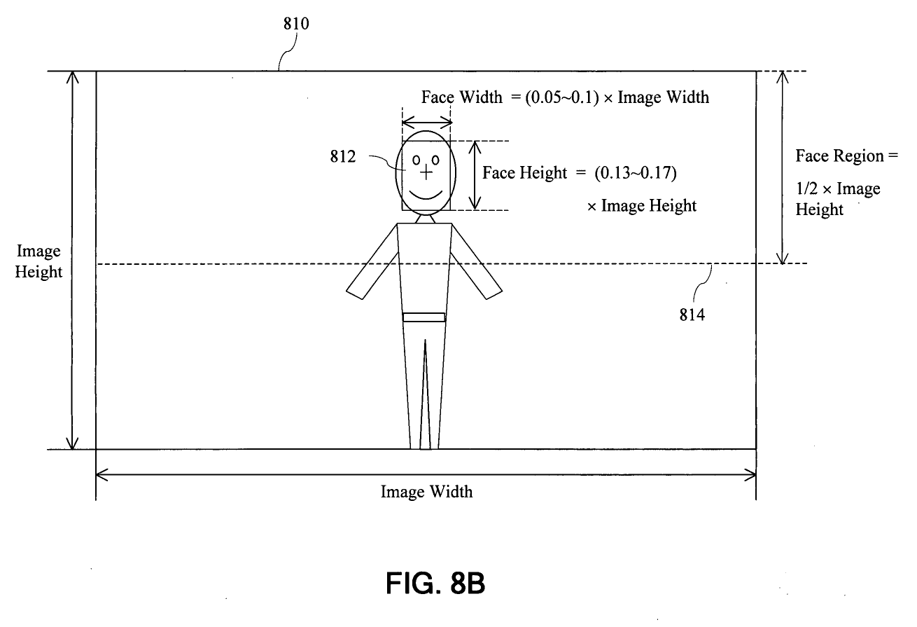

After obtaining a captured image(s) of a key frame(s), the captured key frame(s) is manipulated by a combination of analysis, cropping, resizing and visual enhancement. If the process of cropping key frame is not to be performed, the control goes to step 722 through step 712. Otherwise, the control goes to step 714 through 712. If the fixed position for cropping area in the key frame is to be used with default values, the default position is read at step 718 and the control goes to step 720. If an appropriate cropping position is to be determined automatically or intelligently, the control goes to step 716. In the step, the cropping area can be determined by analyzing the captured key frame image, for example, by automatically detecting face/object of interests, and then calculating a rectangular area that would include the detected face/object at least. The area may have an aspect ratio of a movie poster or DVD title (thinner-looking size), but may have another aspect ratio such as that of a captured screen size (wider-looking size). An aspect ratio of the rectangular area can be determined automatically by analyzing the locations, sizes, and the number of detected faces. FIGS. 8A and 8B illustrate examples of automatically determining the position of cropping area using face detection as discussed in greater detail hereinbelow.

The thumbnail image can have any aspect ratio, but it is desirable to avoid cropping meaningful regions out too much. It is disclosed herein that, according to subjective tests conducted by a group of people, the aspect ratio of width to height for a thumbnail image should be between 1:0.6 and 1:1.2, considering the percentage of cropped area for a video frame broadcast usually in 16:9 (corresponding to 1:0.5625) aspect ratio in particular. A wider-looking thumbnail image wider than 1:0.6 is wasteful for a display screen, and a thinner-looking thumbnail image narrower than 1:1.2 has too limited area for showing visual content of the captured video frame and associated data. (It will be understood that 1:1.2 is “smaller” than 1:0.6, and that 1:0.6 is “greater” than 1:1.2, since in both cases the “1” is the numerator of a corresponding fraction and the “0.6” and “1.2” are numerators of corresponding fractions.)

It is noted that the cropping can be also performed either by linearly or nonlinearly sampling pixels from a region to be cropped out. In this case, a cropped area looks like as using fish-eye lens. After determining the position of a cropping area, the control then goes to step 720. At step 720, a rectangular area located at a default or determined position is cropped.

At step 722, the captured image from step 710 or the cropped area of the captured image from step 720 is resized to fit in a predefined size of a poster-thumbnail. The size of a poster-thumbnail is not constrained except that their width and/or height should be less than those of the captured image of a key frame. That is, the poster-thumbnail can have any size and any aspect ratio whether it is thinner-looking, wider-looking or even a perfect square or other shape(s). However, if the size of a captured, cropped and/or resized image is too small, a poster-thumbnail may not provide sufficiently distinguishing information to viewers to facilitate rapid identification of a particular program. According to subjective tests conducted by a group of people, the pixel height of a captured image should preferably be ⅛ (one eighth) in case of 1080i(p) digital TV format, ¼ (one fourth) in case of 720p digital TV format, and ⅓ (one third) in case of 480i(p) digital TV format, of pixel height of a full frame image of the video stream broadcast in the corresponding digital TV format, corresponding to 130-180 pixels while the width of a captured, cropped and/or resized image is also appropriately adjusted for a given aspect ratio. Further, the reduction of the 1080i or 720p frame images by ⅛ (one eight) or ¼ (one fourth) can be implemented computationally efficiently as disclosed in commonly-owned, copending U.S. patent application Ser. No. 10/361,794 filed Feb. 10, 2003.

At step 724, the captured, cropped and/or resized image can be visually enhanced, if necessary, by using one of the existing image processing and graphics techniques such as contrast enhancement, brightening/darkening, boundary/edge detection, color processing, segmentation, spatial filtering, and background synthesis. A more extensive explanation of image processing techniques may be found in “Digital Image Processing” (Prentice Hall, 2002) by Gonzalez and Woods, and “Computer Graphics” (Addison Wesley, 2^{nd} Edition) by James D. Foley, Andries van Dam, Steven K. Feiner, and John F. Hughes.

The captured and manipulated image used for the poster-thumbnail may cover or fill the entirety of the predefined area planned for the poster-thumbnail, or the manipulated image may only cover or fill a portion of the predefined area, or the manipulated image may exceed the predefined area (such as when corners are rounded for sharp-cornered image(s). For examples, FIGS. 3A and 4A show the poster-thumbnails fully covered by their resized images, but FIGS. 3B, 3C, and 3D show the predefined poster-thumbnail areas partially covered by their resized images. In case where the resized image partially covers its poster-thumbnail, the resized image should be visually enhanced by filling or synthesizing the remaining area with background. The color(s), pattern(s), and texture(s) of background can be predetermined or determined by analyzing dominant color(s), pattern(s) and texture(s) of the resized image (or the captured image at step 710 or the cropped area of the captured image at step 720). The pattern(s) and texture(s) of background can be selected as the ones best fit for those of the resized image so as for the combined image of the background and the resized image to appear as a single image. The color and texture analysis can be done by applying existing algorithms, such as in B. S. Manjunath, J. R. Ohm, V. V. Vinod, and A. Yamada, “Color and Texture descriptors,” IEEE Trans. Circuits and Systems for Video Technology, Special Issue on MPEG-7, vol. 11, no. 6, pp. 703-715, June 2001. A check 726 is provided for this purpose. The check 726 is made to determine if additional background is required for a poster-thumbnail. If so, the color(s), pattern(s) and texture(s) of background are determined (adjusted), and the determined background and the resized image are combined into a single thumbnail image at step 728. The control then goes to step 730 where a text processing for a poster-thumbnail is executed in the steps shown in FIG. 7B. If the background is not required at the check 726, the control also goes to step 730. It is noted that the order of cropping and resizing operations can be interchanged to generate a thumbnail image with minor modification of the flowchart shown in FIG. 7A.

In FIG. 7B, the text processing for a poster-thumbnail starts at step 730. At step 732, any associated data (for example, textual information in FIG. 7B) to be added, overlaid, superimposed or spliced on or near (or “combined with”) the thumbnail image generated by using the method described in FIG. 7A, is received from an EPG or a back channel. The textual information can be any type that is related to the program. But, for space limitations of a poster-thumbnail, the most important information needed for users to identify or select a program from the list of poster-thumbnails is determined and combined with a thumbnail image. The information preferably includes the title of a program at least, and can optionally include date and time of recording, duration, and channel number of the program, actor/actress, director, and other such information that can be obtained from EPG or metadata or closed-caption text delivered through broadcasting network or back channel or the like. It should be noted that the textual information can be translated into other language if multiple language support is required, and/or could be provided by audio means and/or by colors, patterns, textures, and the like of thumbnail images, their backgrounds and/or borders.

After obtaining the textual information, the position of textual information on a poster-thumbnail is to be determined if the position is not fixed with default values. As an example of a fixed position, a title of a program can always be located at the top of the predefined area planned for a poster-thumbnail, and the date/time/channel number also always located at the bottom of the area (as shown at 502 and 504 in FIG. 5A and FIG. 5B, respectively). For an example of dynamic positioning, text combined onto the area may be used to avoid blocking key scene fixture(s) of the thumbnail image such as the face of an actor, and text may be allowed to fill-in around using multiple lines or hyphenation. Key scene fixture(s) such as face and text can be detected by applying the existing methods for detecting face, object and text such as in Seong-Soo Chun, Hyeokman Kim, Jung-Rim Kim, Sangwook Oh, and Sanghoon Sull, “Fast Text Caption Localization on Video Using Visual Rhythm,” Lecture Notes in Computer Science, VISUAL 2002, pp. 259-268, March 2002. Alternatively, combined text may deliberately obscure or over-write area(s) of the frame or image, as for example, to change the effective language of a sign or banner in the frame or image, or to update information on the sign or banner. A check 734 is for this purpose. The check 734 is made to determine if the position of textual information on a poster-thumbnail is fixed with default values or dynamically determined according to context of the thumbnail image. If the position is dynamically determined, the control then goes to step 736. In step 736, the position of textual information is determined as by finding key scene fixtures from the thumbnail image. The control then goes to step 740. Otherwise, the default position of textual information on the thumbnail image is read at step 738, before passing the control to step 740.

At step 740, the text font properties such as color, style, and size are determined according to the characteristics of a program such as genre of a program, favorites by designation, user preference, dominant color of key frame or cropped area, length of textual information, the size of a poster-thumbnail, and/or other information presentation. Further, one or more than one font property may vary on the text for a single frame or poster-thumbnail. For example, font color of textual information can be assigned such that the font color assigned to a title will be a color visually contrasting to the dominant color(s) of the key frame or a color modified by increasing (or decreasing) saturation of dominant color(s), and font color assigned to the date and time may be another color matching with the background color of a poster-thumbnail, and font color assigned to channel number may be always fixed with red. For another example, font style can be assigned such that font style assigned to a title will be a hand-writing style if the genre of a program is historic, and font style assigned to channel number may be fixed with Arial. The font size can be determined according to the length of textual information and the size of a poster-thumbnail. The readability of text can be improved by adding the outline (or shadow, emboss or engrave) effect to the font where the color of the effect to the font visually contrasting with the font color, for example, by using bright outline effect for dark font. It should be noted that the textual information represented by the fonts having determined font properties should be kept readable at their position on the resized frame or image from step 724 or on the frame or image resulting from combining the resized image with background from step 728.

At step 742, the textual information represented by the fonts according to predetermined default or dynamically determined font properties is combined on or near the thumbnail image from step 728. This resulting image becomes a poster-thumbnail. The generation process of a poster-thumbnail ends at step 744.

The generation process of this form of poster-thumbnail of a broadcast program in FIGS. 7A and 7B will be usually executed by or within a DVR or PC. However, it might also be possible that the poster-thumbnail is made automatically or manually by a broadcaster or a third-party company, and then delivered to a DVR through EPG information or back channel (such as the Internet). It is also noted that, for VOD scenario wherein the video streams are stored at remote VOD servers accessible through a back channel, poster-thumbnails can be generated in advance automatically or manually, and poster-thumbnail is transferred to viewer whenever needed. In these scenarios, the generation process will be executed at the broadcaster or VOD service provider or third-party company, though the process might be somewhat changed.

It is noted that the process of generating a poster-thumbnail is not limited to a video. For example, a poster-thumbnail can be generated from still images or photos taken by digital cameras or camcorders by utilizing textual information associated with photos, such as file name, file size, date or time created, annotation, and the like. It is also noted that poster-thumbnails that were pre-generated and stored in the associated storage can be utilized instead of generating poster-thumbnails whenever needed.

FIG. 8A illustrates examples of a wider-looking poster-thumbnail 804 and a thinner-looking poster-thumbnail 806 generated from a frame or image 802 by using one of the existing methods for face detection such as the method cited below. In the figure, the wider-looking poster-thumbnail 804 appears to provide more visual information representing the image compared to thinner-looking poster-thumbnail 806 since a meaningful region corresponding to another person is cropped out in case of the thinner-looking thumbnail 806.

FIG. 8B illustrates how to determine an aspect ratio of the rectangular area for an image containing a person who is standing. For example, after detecting a face in an image, it is considered that a person is standing if the following conditions are satisfied: i) width of the detected face 812 is between 5% and 10% of width of image 810, ii) the height of the face 812 is between 13% and 17% of height of image 810, and iii) the face region is located above the half line 814 of the image 810. Thus, by analyzing the relative size and position of a face with respect to an image, information such as whether a person is standing or sitting or the number of people can be estimated to determine an appropriate aspect ratio for the rectangular area for poster-thumbnail. For example, a thinner-looking poster-thumbnail will be suitable if a single person is standing while a wider-looking poster-thumbnail will be preferable if there are two or more people present in the image. The face/object detection can be performed by applying one of the existing face/object detection algorithms, such as J. Cai, A. Goshtasby, and C. Yu, “Detecting human faces in color images,” in Proc. of International Workshop on Multi-Media Database Management Systems, pp. 124-131, August 1998, and Ediz Polat, Mohammed Yeasin and Rajeev Sharma, “A 2D/3D model-based object tracking framework,” Pattern Recognition 36, pp. 2127-2141, 2003.

2. Animated thumbnails

FIGS. 9A and 9B illustrate exemplary GUI screens for browsing recorded TV programs of a DVR, according to this disclosure, wherein like numbers correspond to like features. In FIG. 9A, four programs are listed on a single screen 902. Textual information of a recorded program such as the title, recording date and time, duration and channel of the program is displayed in each text field 904, whether or not the same or similar or different data may be displayed on the visual field 906. Along with the textual information relating to the recorded program, a visual content characteristic of a recorded program may be displayed in one or more of each visual field 906. The visual content characteristic of a recorded program may be any image or video related with the program such as a thumbnail image, a poster-thumbnail, an animated thumbnail or even a video stream shown in a small size. Therefore, for each of the plurality of recorded programs, the text fields 904 display textual information relating to the programs, and the visual fields 906 display visual content characteristics relating to the programs (but may also have text superimposed onto the image(s)). For each program, the visual field 906 is preferably paired with a corresponding text field 904. Each visual field 906 is associated with (and shown as displayed adjacent, on the same horizontal level) a corresponding text field 904 so that the nexus (association) of the two fields is readily apparent to the user without loosing focus of attention. Using a control device, such as a remote control, a user may select a program to play by moving a cursor indicator 908 (shown as a visually-distinctive, heavy line surrounding a selected field 904 or 906 or both) upwards or downwards, in the program list. This can be done by scrolling though the visual fields 906, and/or the text fields 904. With this new interface, a user can easily select the program(s) to play by just glancing at the visual content characteristic(s) of each recorded program.

In the case where an animated thumbnail will be displayed on the visual field 906, a still thumbnail image representing each recorded program is often initially displayed in each of the four visual fields 906, respectively. After the cursor indicator 908 remains on a program for a specified amount of time (for example, one or two seconds) or a selector (such as a button) is activated by the viewer, a slide show of the program designated by the cursor 908 begins to play at its visual field. In the slide show, a series of thumbnail images captured from the program will be displayed one by one at another specified time interval. The slide show will be more informative to users if each thumbnail image is visually different from others. Alternatively, a short-run video scene may be played in the visual field. The three other visual fields 906 of the programs except the one having the cursor 908 will still display their own static thumbnail images respectively. If a user wants to preview the content of other recorded program/video stream(s), the user may select the video stream of interest by moving the cursor 908 upwards or downwards. This thus enables fast navigation through multiple video streams. Of course, more than one visual field 906 may be animated at one time, but that may prove distracting to the viewers.

Similarly, where a small-sized video of a program is displayed on the visual field 906, a still thumbnail image representing each recorded program is usually and preferably initially displayed in the four visual fields 906, respectively. After the cursor indicator 908 remains on a program for a specified amount of time or a selector (such as a button) is activated by the viewer, the thumbnail image highlighted through the cursor 908 is replaced by a small-sized video that will immediately start to be played. The three other visual fields 906 of the programs except the one having the cursor 908 will still preferably (but not exclusively) display their own still thumbnail images, respectively. The small-sized video can be played, rewound, forwarded or jumped by pressing an arbitrary button on a remote control. For example, the Up/Down button in a remote control could be utilized to scroll between different video streams in a program list and the Left/Right button could be utilized to fast forward or rewind the highlighted video stream indicated by the cursor 908. By displaying the small-sized video at the same position as where the still thumbnail image was displayed, the video is displayed adjacent and associated (shown in FIG. 9A, on the same horizontal level as the text field 904) so that the nexus (association) of the two fields is readily apparent to the user without loosing focus of attention.

In both cases of animated thumbnail or small-sized video, a progress bar 910 can be provided for a visual field 906 currently highlighted by the cursor indicator 908. The progress bar 910 indicates the portion of the video being played within the video stream highlighted by the cursor 908. The overall extent (width, as viewed) of the progress bar is representative of the entire duration of the video. The size of a slider 912 within in the progress bar 910 may be indicative of the size of a segment of the video being displayed, or may be of a fixed size. And, the position of the slides 912 may be indicative of the relative placement of the displayed portion of video within the animated thumbnail file.

A multiple of programs/streams can be played at the same time even though they are not selected or highlighted by a cursor indicator. If processing speed is sufficient, the display screen can simultaneously run many variously animated thumbnails or small-sized videos of the same or of different video sources. However, displaying multiple dynamic components such as the animated thumbnails or small-sized videos in a single screen might make users lose their focus on a specific program having a current cursor.

The order of the programs listed in the presented program list might be ordered according to the characteristics or inverse characteristics that might be applied to order the poster-thumbnails 604 and 608 in FIGS. 6A and 6B, respectively.

Fields including 904 and 906 in the FIG. can be overlaid or embedded on/over a video played on a full screen. Also, the fields may be off-screen, for example, in black area above/below letter box format. Furthermore, the fields may replace or augment portion of video, for example, may replace text in video by overlay/blackout of other area. One example is to replace Korean text on banner in video with English translation, rather than only subtitle translation. Combination of above three might be possible, or two fields can be combined or permuted.

Note that the GUI screens utilizing the animated thumbnails or small-sized videos are not limited to the ones in the figures, but can be freely modified such that the text field(s) could be in space(s) on/below/above/beside/on the visual field that will run animated thumbnails or small-sized videos. One of the possible modifications can be illustrated such as FIG. 6C where each poster-thumbnail is replaced with an animated thumbnail or small-sized video. Also, they could be highlighted or selected.

In FIG. 9B, nine thinner-looking poster-thumbnails 924 and one animated thumbnail or small-sized video 922 with cursor indicator 926 are listed on a single screen 920. It is disclosed herein that a poster-thumbnail changes to an animated thumbnail 922 when the poster-thumbnail is selected by a user and is displayed at the same position as its corresponding poster-thumbnail without invoking a new display window (i.e., in the current/same display window), letting viewers not to lose their focus of attention. Further, an animated thumbnail displays images or frames that are linearly resized from an original video file or program without cropping frames of the video file or changing its original aspect ratio, resulting in more pleasing and informative visual experience to viewers. It is noted that the uncovered region 928 of the animated thumbnail 922 shown in letter box format can be filled out by blank screen or textual (visual) information.

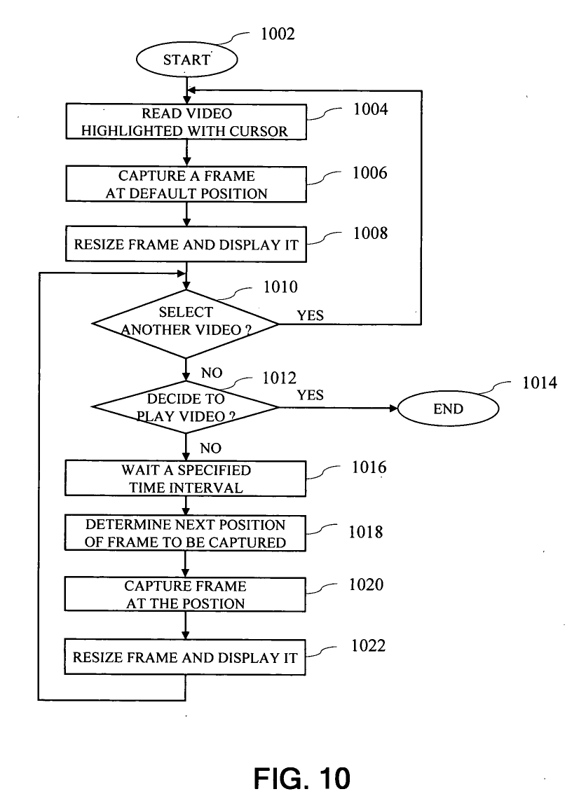

FIG. 10 is an exemplary flowchart illustrating an overall method of generating an animated thumbnail for a given video file or broadcast/recorded TV program automatically, according to an embodiment of the present disclosure. Referring to FIGS. 9A, 9B and 10, the generation process starts at step 1002. The video highlighted with cursor indicator 908 in the interface 902 or cursor indicator 926 in the interface 920 in is read by the process at step 1004. In order to generate an animated thumbnail of a video, a series of captured thumbnail images of the video is required. Initially, a frame at default position is captured at step 1006. The default position can be any one within the video such as the first or 30^{th} frame from the beginning of the video. At step 1008, the captured frame is resized to fit in a predefined size of an animated thumbnail, and displayed on the highlighted visual field 906. A check 1010 is made to determine if a user selects another program by moving a cursor indicator 908 upward or downward (or 926 upward, downward, left or right) using a control device such as a remote control, in the program list of the interface. If so, the control goes to step 1004. Otherwise, another check 1012 is made to determine if a user wants to play the current highlighted video or not. If so, the generation process stops at step 1014. Otherwise, the process will wait a specified time interval, for example, one or two seconds at step 1016. The next position of frame is determined at step 1018, and is captured at the determined position at step 1020. For example, a series of frames are sampled at temporally regular positions such as at every 60^{th} frame (that is, at every two seconds) from the beginning to the end. Alternatively, frames are sampled at random position generated by a random number generator. Alternatively, more appropriate frames can be sampled by analyzing the contents of a video, for example, based on one of the existing algorithms for key frame generation and clustering, such as Hyun-Sung Chang, Sanghoon Sull, and Sang-Uk Lee, “Efficient Video Indexing Scheme for Content-Based Retrieval,” IEEE Trans. Circuits and Systems for Video Technology, vol. 9, pp. 1269-1279, December 1999. At step 1022, the captured frame is resized to fit for a predefined size of an animated thumbnail, and displayed on the highlighted visual field 906 (or 922). Finally, the control goes back to the check 1010 in order to determine whether another next frame is required or not. It is noted that the aspect ratio of the video is preferably maintained without cropping (yet scaled down in size) for generating and displaying animated thumbnails of the video. It is also noted that animated thumbnails that were pre-generated in DVR or PC and stored in its associated storage can be utilized instead of generating poster-thumbnails whenever needed.

In broadcasting environment, a series of positional information of key frames of a program can be supplied by TV broadcasters through EPG information or back channel (such as the Internet). In this case, the flowchart in FIG. 10 can be modified by replacing the step 1018 with a new step of “reading a position of next frame to be captured from EPG or back channel.”

The generation process of an animated thumbnail of a broadcast program in FIG. 10 will be executed at a DVR or PC. However, it might also be possible that an animated thumbnail is made automatically or manually by a broadcaster (VOD service provider) or a third-party company, and then it is delivered to a DVR (or STB) through EPG information or back channel (such as the Internet). If it occurs, the delivered animated thumbnail might be in a form of an animated GIF file rather than a series of captured thumbnail images for delivering efficiency. In this scenario, the generation process will be executed at the broadcaster or VOD service provider or third-party company though the generation process might be slightly changed.

It should be noted that poster-thumbnails and animated thumbnails can be used to provide an efficient system for navigating, browsing and/or selecting video bookmarks or infomercials to be viewed by a user. A video bookmark (multimedia bookmark) comprising a captured reduced image and media locator is used for a user to access a video file or TV program without accessing the beginning of the video file. Thus, poster-thumbnails and animated thumbnails can be generated to show content characteristics of video bookmarks wherein user annotation and the like for video bookmarks can be also used for the textual information for poster-thumbnails and animated thumbnails in addition to file name, program title and the like disclosed herein. More complete description of a multimedia bookmark may be found in U.S. patent application Ser. No. 09/911,293 filed Jul. 23, 2001. An infomercial could be any relatively short duration AV program which is inserted into (interrupts) the flow of another AV program of longer duration, including audiovisual (or part) programs or segments presenting information and commercials such as new program teasers, public announcement, time-sensitive promotion sales, advertisements, and the like. Poster-thumbnails and animated thumbnails can be also generated to show a list of infomercials. More complete description may be found in commonly-owned, copending U.S. patent application Ser. No. 11/069,830 filed Mar. 1, 2005.

3. Actual Broadcast Start Times of TV Programs

In the broadcasting environment, EPG provides programming information on current and future TV programs such as start time, duration and channel number of a program to be broadcast, usually along with a short description of title, synopsis, genre, cast and the like. A start time of a program provided through EPG is used for the scheduled recording of the program in a DVR system. However, the scheduled start times of TV programs provided by broadcasters do not exactly match the actual start times of broadcast TV programs. A worse problem is that the program description sometimes does not correspond to the actual broadcast program. These problems are partly due to the fact that programming schedules occasionally will be delayed or change just before a program is broadcast, especially after live programs such as a live sports game or news.

As noted in commonly-owned, copending U.S. patent application Ser. No. 09/911,293 filed 23 Jul. 2001, the second problem (with current DVRs) is related to discrepancy between the two time instants: the time instant at which the DVR starts the scheduled-recording of a user-requested TV program, and the time instant at which the TV program is actually broadcast. Suppose, for instance, that a user initiated DVR request for a TV program scheduled to go on the air at 11:30 AM, but the actual broadcasting time is 11:31 AM. In this case, when the user wants to play the recorded program, the user has to watch the unwanted segment at the beginning of the recorded video, which lasts for one minute. This time mismatch could bring some inconvenience to the user who wants to view only the requested program. However, the time mismatch problem can be solved by using metadata delivered from the server, for example, reference frames/segment representing the beginning of the TV program. The exact location of the TV program, then, can be easily found by simply matching the reference frames with all the recorded frames for the program.

Thus, the recorded video in a DVR corresponding to the scheduled recording of a program according to the EPG start time might contain the last portion of a previous program and, even worse, the recorded video in a DVR might miss the last portion of the program to be recorded if the recording duration is not long enough to cover the unexpected delay of the start of broadcasting the program. For example, suppose that the soap drama “CSI” is scheduled from 10:00 PM to 11:00 PM on channel 7, but it actually starts to be aired at 10:15 PM. If the program is recorded in a DVR according to its scheduled start time and duration, the recorded video will have a leading 15 minute-long segment irrelevant to the CSI. Also, the recorded video will not have the last critical 15 minute-long segment that usually contains the most highlighted or conclusive scenes although the problem of missing the last segment of a program to be recorded can be somewhat alleviated by setting extra recording time at the beginning and end in some existing DVRs.

When a recorded video in a DVR contains a video segment irrelevant to the program at the beginning of the recorded video, in order to watch the program from its beginning, DVR users have to locate the actual starting point of the program by using conventional VCR controls such as fast forward and rewind, which might be an annoying and time-consuming process.

Furthermore, in order to generate a semantically meaningful poster- or animated thumbnail of a broadcast program recorded in a DVR, the frame(s) belonging to the program to be recorded should be chosen for the key frame(s) utilized to generate the thumbnail image, at least. In other words, the thumbnail image might be worthless if the key frame(s) used to generate the thumbnail image is chosen from the frames belonging to other programs temporally adjacent to the program to be recorded, for example, a frame belonging to the leading 15 minute-long segment of the recorded video for CSI, which is irrelevant to the CSI.

In order to avoid the situations such as manually searching the recorded video for the start of the program when viewers want to watch the program, or automatically choosing a key frame from frames belonging to a leading segment irrelevant to the program when generating a poster- or animated thumbnail of the program, it is desirable that the actual start time and duration of each broadcast program should be available in a DVR system. However, the actual start time of a broadcast program often can not be determined before the program is broadcast. Therefore, it is usually the case that the actual start times of most programs can be provided to DVR only after they start to be broadcast.

Furthermore, if the actual start time of a current broadcast program is provided to a DVR while the program is being recorded on the DVR, the scheduled start time of the program can be updated to the actual start time provided, thus the whole program being able to be recorded on the DVR. For example, if the actual start time of the CSI (10:15 PM) is provided to a DVR while the CSI is being recorded, the recording can be extended to 11:15 PM, not finished at 11:00 PM. That is, the last 15 minute-long segment of the CSI that might be missed can be recorded on the DVR though the leading 15 minute-long segment of the recorded CSI, which is irrelevant to the CSI, can not be avoided to be recorded.

For most of regularly broadcast TV programs such as soap dramas, talk shows and news, each program has its own predefined introducing audiovisual segment called a title segment in the beginning of the program. The title segment has a short duration (for example, 10 or 20 seconds), and is usually not changed until the program is discontinued to launch a new program. Also, most movies have a fixed-title segment that shows its distributor such as 20th Century Fox or Walt Disney. For some TV soap dramas, a new episode starts to be broadcast just after one or more blanking frames with its title or logo or rating information such as PG-13 superimposed on a fixed part of the frames, and then a title segment follows and the episode continues. Thus, it is disclosed that the actual start time of a target program can be automatically obtained by detecting the part of broadcast signal matching a fixed AV pattern of the title segment of the target program.

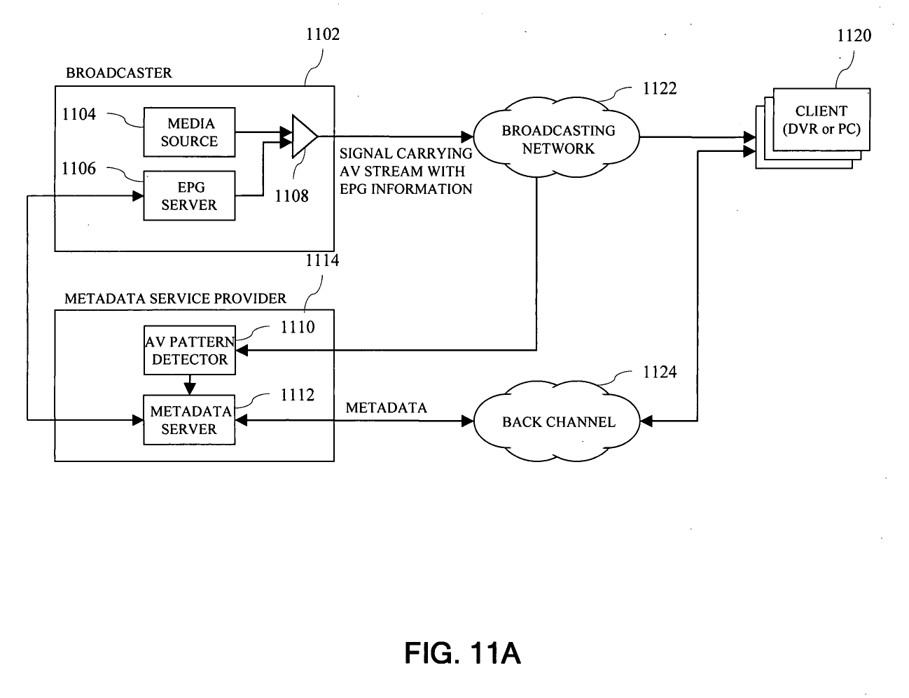

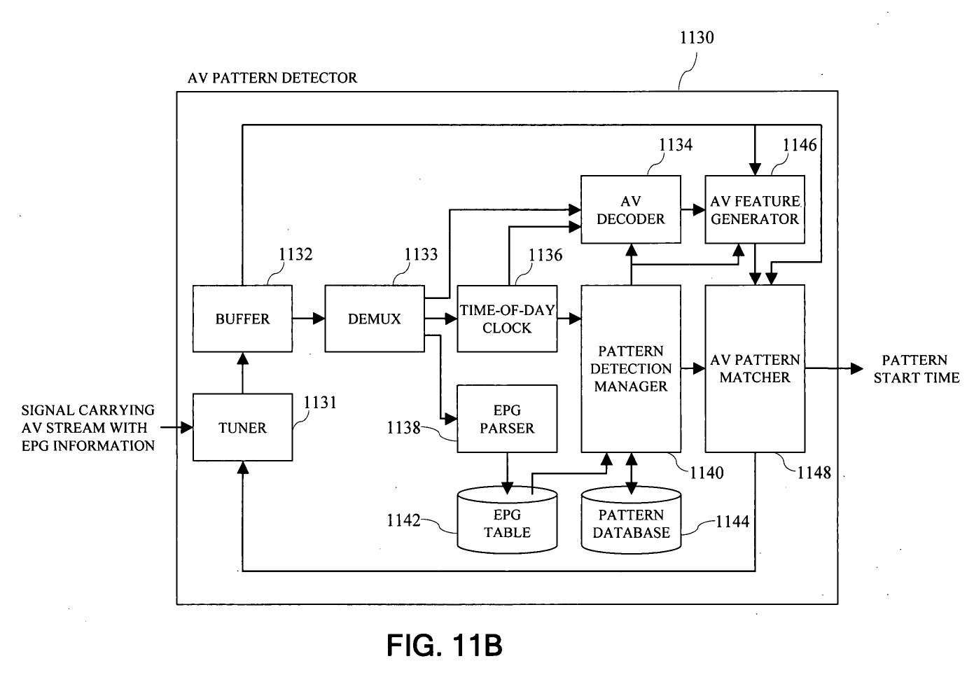

FIG. 11A is a block diagram illustrating a system for providing DVRs with metadata including the actual start times of current and past broadcast programs, according to an embodiment of the present disclosure. The AV streams from a media source 1104 and EPG information stored at an EPG server 1106 are multiplexed into digital streams, such as in the form of MPEG-2 transport streams (TSs), by a multiplexer 1108. A broadcaster 1102 broadcasts the AV streams with EPG information to DVR clients 1120 through a broadcasting network 1122. The EPG information is delivered in the form of PSIP for ATSC or SI for DVB. The EPG information can be also delivered to DVR clients 1120 through an interactive back channel 1124 by metadata servers 1112 of one or more metadata service providers 1114. Also, descriptive and/or audio-visual metadata (such as in the form of either TV Anytime, or MPEG-7 or other equivalent) relating to the broadcast AV streams can be generated and stored at metadata servers 1112 of one or more metadata service providers. An AV pattern detector 1110 monitors the broadcast stream through the broadcasting network 1122, detects the actual start times of broadcast programs, and delivers the actual start times to the metadata server 1112. The pattern detector 1110 also utilizes the EPG and system information delivered through the broadcasting network 1122. It is noted that the EPG information can be also delivered to the pattern detector 1110 through a communication network. The metadata including the actual start times of current and past broadcast programs is then delivered to DVR clients 1120 through the back channel 1124. Alternatively, the metadata stored at metadata server 1112 can be multiplexed into the broadcast AV streams by multiplexer 1108, for example, through a data broadcasting channel or EPG, and then delivered to DVR clients 1120. Alternatively, the metadata stored at metadata server 1112 can be delivered through VBI using a conventional analog TV channel, and then delivered to DVR clients 1120.

FIG. 11B is a block diagram illustrating a system for automatically detecting the actual start time of a target program in an AV pattern detector 1130 (that corresponds to the element 1110 in FIG. 11A), according to an embodiment of the present disclosure. Referring to FIGS. 11A and 11B, the AV pattern detector 1130 monitors the broadcast AV streams delivered through the broadcasting network 1122. A broadcast signal is tuned to a selected channel frequency, demodulated in the tuner 1131, and demultiplexed into an AV stream and a PSIP stream for ATSC (or SI stream for DVB) in the demux (de-multiplexer) 1133. The demultiplexed AV stream is decoded by the AV decoder 1134. The demultiplexed ATSC-PSIP stream (or DVB-SI) is sent to a time of day clock 1136 where the information on the current date and time of day (from STT for ATSC-PSIP or from TDT for DVB-SI) is extracted and used to set the time-of-day clock 1136 in the resolution of preferably at least or about 30 Hz. The EPG parser 1138 extracts the EPG data such as channel number, program title, start time, duration, rating (if available) and synopsis, and stores the information into the EPG table 1142. It is noted that the EPG data can be also delivered to the AV pattern detector 1130 through a communication network connected to an EPG data provider. The EPG data from the EPG table 1142 is also used to update the programming information on each program archived in a pattern database 1144 through the pattern detection manager 1140.

The pattern database 1144 archives such information on each broadcast program as program identifier, program name, channel number, distributor (in case of a movie), duration of a title segment in terms of seconds or frame numbers or other equivalents, and AV features of the title segment such as a sequence of frame images, a sequence of color histograms for each frame image, a spatio-temporal visual pattern (or visual rhythm) of frame images, and the like. The pattern database 1144 can also archive the optional information on scheduled start time and duration. It is noted that a title segment of a program can be automatically identified by detecting the most frequently-occurring identical frame sequence broadcast around the scheduled start time of the program for a certain period of time.

A pattern detection manager 1140 controls the overall detection process for the target program. The pattern detection manager 1140 retrieves the programming information of the target program such as program name, channel number, scheduled start time and duration from the EPG table 1142. The detection manager 1140 always obtains the current time from the time-of-day clock 1136. When the current time reaches a start time point of a pattern-matching time interval for the target program, the pattern detection manager 1140 requests the tuner 1131 to tune to the channel frequency of the target program. The pattern-matching time interval for the target program includes the scheduled start time of the target program, for example, from 15 minutes before the scheduled start time to 15 minutes after the scheduled start time. The pattern detection manager 1140 requests the AV decoder 1134 to decode the AV stream and associate or timestamp each decoded frame image with the corresponding current time from the time-of-day clock 1136, for example, by superimposing the time-stamp color codes into frame images as disclosed in U.S. patent application Ser. No. 10/369,333 filed Feb. 19, 2003 (Publication No. 2003/0177503). If frame accuracy is required, the value of PTS of the decoded frame of the AV stream should be also utilized for timestamping. The pattern detection manager 1140 also requests an AV feature generator 1146 to generate AV features of the decoded frame images. At the same time, the pattern detection manager 1144 retrieves the AV features of a title segment of the target program from the pattern database 1144, for example, by using the program identifier and/or program name as query. The pattern detection manager 1140 then sends the AV features of a title segment of the target program to an AV pattern matcher 1148, and requests the AV pattern matcher 1148 to start an AV pattern matching process.

As directed by the pattern detection manager 1140, the AV pattern matcher 1148 monitors the AV stream and detects a segment (one or more consecutive frames) in the AV stream whose sequence of frame images or AV pattern match those of a pre-determined title segment of the target program stored in a pattern database 1144, if the target program has the title segment. The pattern matching process for AV features is performed during a predefined time interval of the target program around its scheduled start time. If the title segment of the program is found in the broadcast AV stream before the end time point of the predefined time interval, the matching process is stopped. The actual start time of the target program is obtained by localizing the frame in a broadcast AV stream matching the start frame of the title segment of the target program, based on the timestamp information generated in the AV decoder 1134. Alternatively, instead of matching AV features, the broadcast AV stream encoded in MPEG-2 directly from the buffer 1132, for example, can be matched to the bit stream of the title segment stored in the pattern database, if the same AV bit stream for the title segment is broadcast for the target program. The resulting actual start time is represented, for example, by a media locator based on the corresponding (interpolated) system_time delivered through STT (or UTC_time field through TDT or other equivalents) whereas the PTS of the matched start frame is also used for the media locator if frame accuracy is needed.

Alternatively, a human operator can manually marks the actual start time of the target program instead of the AV pattern matcher while viewing a broadcast AV stream from the AV decoder 1134. To help a human operator mark the point fast and easily, a software tool such as the highlight indexing tool disclosed in commonly-owned, copending U.S. patent application Ser. No. 10/369,333 filed Feb. 19, 2003 can be utilized instead of the AV pattern matcher 1148 with minor modification. This manual detection of actual start times of programs might be useful for irregularly or just one-time broadcast TV programs such as live concerts.

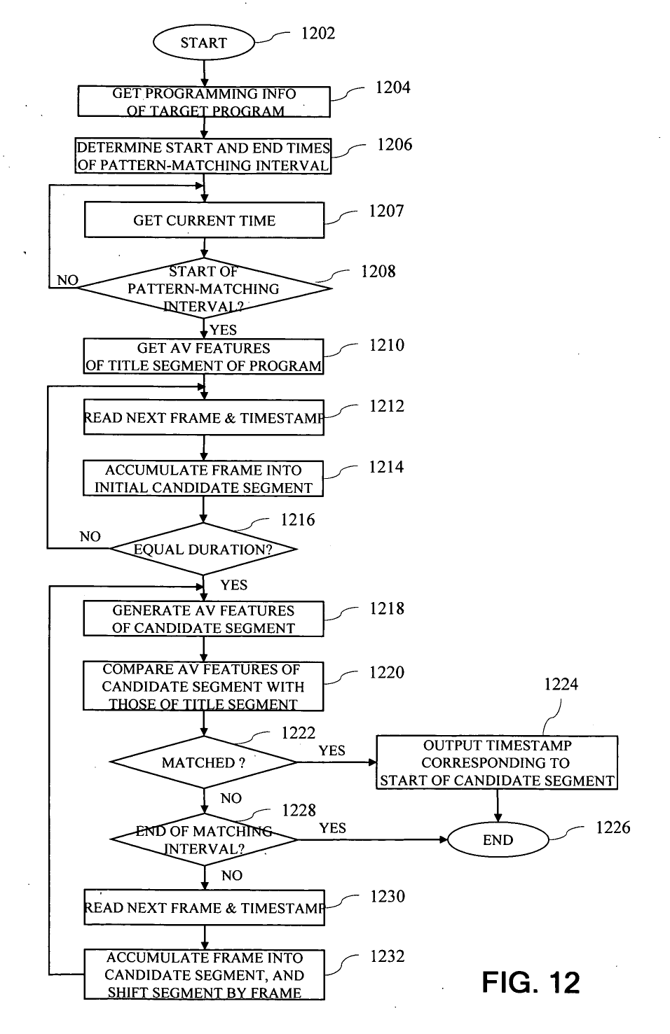

FIG. 12 is an exemplary flowchart illustrating the detection process done by the pattern detector in FIGS. 11A and 11B, according to an embodiment of the present disclosure. Referring to FIGS. 11A, 11B and 12, the detection process starts at step 1202. At step 1204, the pattern detection manager 1140 in FIG. 11B retrieves the programming information of the target program from the EPG table 1142 in FIG. 11B. At step 1206, the pattern detection manager 1140 in FIG. 11B then determines a start and end time point of a pattern-matching time interval for the target program by using a predefined interval and a scheduled start time of the target program. The pattern detection manager 1140 in FIG. 11B obtains the current time from the time-of-day clock 1136 in FIG. 11B at step 1207, and determines if the current time reaches the start time of the pattern-matching time interval of the target program at check 1208. If the check is not true, the pattern detection manager 1140 in FIG. 11B continues to obtain current time at check 1207. Otherwise, the pattern detection manager 1140 in FIG. 11B retrieves the AV features of a title segment of the target program from pattern database 1144 in FIG. 11B by using the program identifier and/or program name in EPG table as query at step 1210.

When the target program is a movie, there might be no title segment information matching with the program name (movie name) since pattern database 1144 in FIG. 11B might has no entry for the movie. Instead, the pattern database 1144 in FIG. 11B might have title segments for major movie distribution companies. In this case, the pattern detection manager 1140 in FIG. 11B searches the pattern database 1144 in FIG. 11B by using a movie company name as a query at step 1210, instead of the program identifier and/or program name. The AV feature generator 1146 in FIG. 11B then reads a frame and its timestamp (or a timestamped frame) decoded by AV decoder 1134 in FIG. 11B or directly from the buffer 1132 in FIG. 11B at step 1212, according to the request of the pattern detection manager 1140 in FIG. 11B. The AV feature generator 1146 in FIG. 11B accumulates the frame into an initial candidate segment at step 1214, and checks if the length of the candidate segment is equal to the duration of a title segment of the target program at check 1216. If it is not true, the control goes back to step 1212 where the AV feature generator 1146 in FIG. 11B reads the next frame. Otherwise, the AV feature generator 1146 in FIG. 11B generates one or more AV features of the candidate segment at step 1218.

The AV feature generator 1146 in FIG. 11B then performs an AV matching step 1220, where comparisons one or more AV features of the candidate segment are compared with those of a title segment of the target program. A check 1222 is made to determine whether the AV features of the candidate segment and the title segments are matched or not. If matched, a control goes to step 1224 where a timestamp or media locator corresponding to the start time of the candidate segment is output as an actual start time of the target program, and the detection process stops at step 1226. Otherwise, another check 1228 is made to determine whether an end time point of the candidate segment reaches that of the pattern-matching time interval. If it is true, the pattern detection process also stops at step 1226 without detecting an actual start time of the target program. Otherwise, the AV feature generator 1146 reads next frame and its timestamp (or next timestamped frame) at step 1230. The AV feature generator 1416 in FIG. 11B then accumulates the frame into the candidate segment, and shifts the candidate segment by one frame at step 1232. Then, a control goes back to step 1218 to do another AV matching with a new candidate segment.

Alternatively, the detection process in FIG. 12 can be done with an encoded bit stream of a candidate segment and that of a title segment of a target program without utilizing their AV features. The detection process in FIG. 12 can include the case with minor modification.

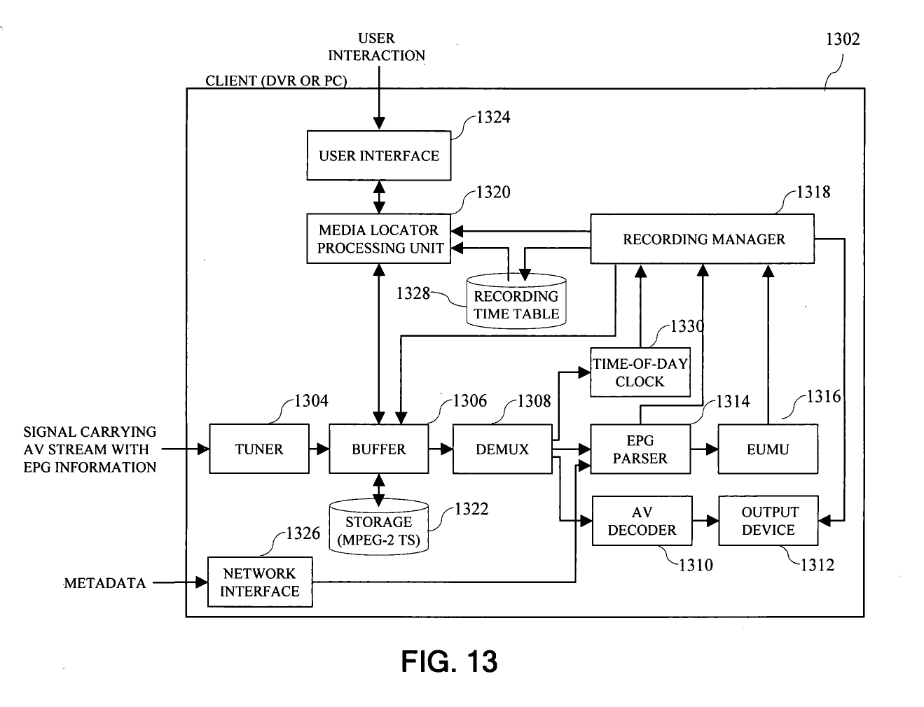

FIG. 13 is a block diagram illustrating a client DVR system that can play a recorded program from an actual start time of a program, if the scheduled start time is updated through EPG or metadata accessible from a back channel after the scheduled recording of the program starts or ends, according to an embodiment of the present disclosure. Referring to FIGS. 11A and 13, the client system 1302 (that correlates to element 1120) includes modules for receiving and decoding broadcast AV streams, in addition to modules commonly used in DVR or DVR-enabled PC as well as modules for monitoring EPG and EPG update. A tuner 1304 receives a broadcast signal from the broadcasting network 1122, and demodulates the broadcast signal. The demodulated signal is delivered to a buffer or random access memory 1306 in the form of bit stream such as MPEG-2 TS, and stored in a hard disk or storage 1322 if the stream needs to be recorded. It is noted that the broadcast MPEG-2 transport stream including AV stream and STT for PSIP (or TDT for DVB) is preferably recorded as it is broadcast, in order to allow a DVR system to play a recorded program from the actual start time of the program delivered after the scheduled recording of the program starts or ends, according to an embodiment of our present disclosure. The broadcast stream is delivered to the demultiplexer 1308. The demultiplexer 1308 separates the stream into an AV stream and a PSIP stream for ATSC (or SI stream for DVB). The AV stream is delivered to the AV decoder 1310. The decoded AV stream is delivered to an output audiovisual device 1312.

The demultiplexed ATSC-PSIP stream (or DVB-SI) is sent to a time of day clock 1330 where the information on the current date and time of day (from STT for ATSC-PSIP or from TDT for DVB-SI) is extracted and used to set the time-of-day clock 1330 in the resolution of preferably at least or about 30 Hz. The demultiplexed ATSC-PSIP stream (or DVB-SI) from the demultiplexer 1308 is delivered to an EPG parser 1314 which could be implemented in either software or hardware. The EPG parser 1314 extracts programming information such as program name, a channel number, a scheduled start time, duration, rating, and synopsis of a program. Alternatively, the metadata including EPG data might also be acquired through a network interface 1326 from the back channel 1124 in FIG. 11A such as the Internet. The programming information is saved into an EPG table which is maintained by a recording manager 1318. The recording manager 1318 which could be implemented in either software or hardware controls the scheduled recording by using the EPG table containing the latest EPG data from the EPG parser 1330 and the current time from the time-of-day clock 1330.

The EPG update monitoring unit (EUMU) 1316 which could be implemented in either software or hardware monitors the newly coming EPG data through the EPG parser 1314 and compares the new EPG data with the old table maintained by the recording manager 1318. If a program is set to a scheduled recording according to the start time and duration based on the old EPG table and the updated start time and duration are delivered before the scheduled recording starts, the EUMU 1316 notifies the recording manager 1318 that the EPG table is updated by the EPG parser 1314. Then, the recording manager 1318 modifies the scheduled recording start time and duration according to the updated EPG table. When the current time form the time-of-day clock 1330 reaches the (adjusted) scheduled start time of a program to be recorded, the recording manager 1318 starts to record the corresponding broadcast stream into the storage 1322 through the buffer 1306. The recording manager also stores the (adjusted) scheduled recording start time and duration into a recording time table 1328.

If a program is set to a scheduled recording using the old EPG table, and the updated EPG data containing the updated or actual start time and duration of the program to be recorded is delivered while the program is being recorded or after the program is recorded, the recording manager 1318 also stores the updated or actual start time and duration into the recording time table 1328. If the updated or actual start time and duration are delivered while the program is being recorded, the recording manager 1318 conservatively adjusts the recording duration by considering the actual duration of the program. The recording manager 1318 also notifies a media locator 1320 that the scheduled recording start time/duration and the actual start time/duration of the program are different. Then, the media locator processing unit 1320 reads the actual start time and duration, in the form of a media locator or timestamp, of the program from the recording table 1328, then obtains the actual start position, for example, in the form of byte file offset, pointed by the media locator or timestamp, and stores it into the storage 1322 wherein the actual start position is obtained by seeking the position of the recorded MPEG-2 TS stream of the program matching the value of STT (and PTS if frame accuracy is needed) representing the media locator. Thus, it is important to record the broadcast MPEG-2 TS including AV stream and STT (or TDT for DVB) as it is broadcast. Alternatively, the media locator processing unit 1320 can obtain and store the actual start position in real-time when a DVR user selects the recorded program for playback or the recording of the program ends. The media locator processing unit 1320 allows the user jump to the actual start position of the recorded program when a user plays back the recorded program using a user interface 1324 such as a remote controller. The media locator 1320 also allows the user to edit out the irrelevant part of the program using the actual start time and duration.

It is noted that the recording manager 1318 stores both the scheduled start time/duration of a program and the actual start time/duration of the program in the recording time table 1328, wherein the actual start time and duration are initially set to the respective values of the scheduled start time/duration (or the actual start time and duration are set to zeroes) when the scheduled recording begins. When the updated or actual start time and duration of the program are delivered while the program is being recorded or after the program is recorded, the actual start time and duration are changed to the updated or actual values. Thus, the media locator processing unit 1320 can easily check if the recording start time/duration and the actual start time/duration of the program are different when the user plays back the recorded stream.

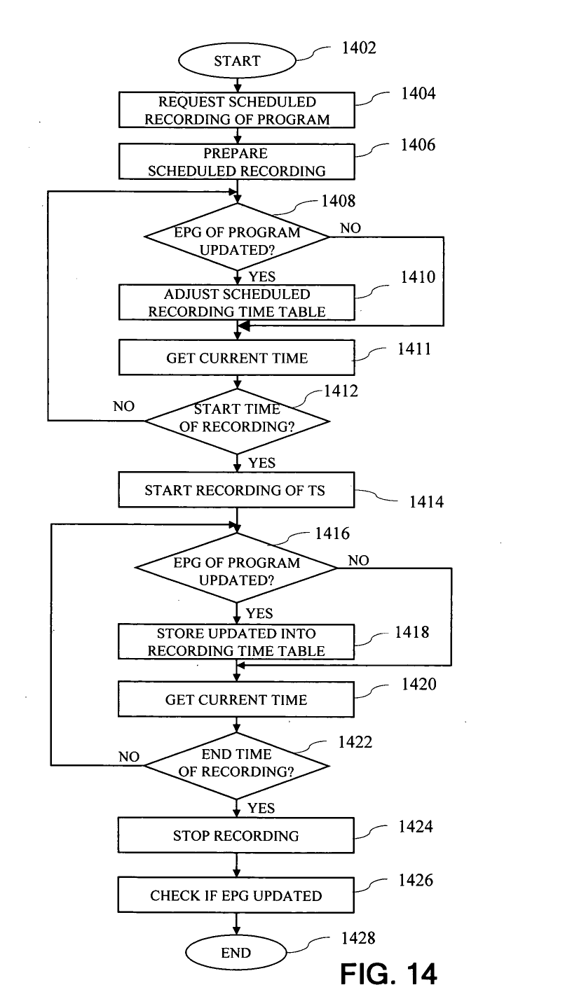

FIG. 14 is an exemplary flowchart illustrating a process of adjusting the recording duration during scheduled-recording of a program when the actual start time and/or duration of the program is provided through EPG after the recording starts, according to an embodiment of the present disclosure. Referring to FIGS. 11A, 13 and 14, the adjustment process starts at step 1402. A user requests the client system 1302 in FIG. 13 (that correlates to an element 1120 in FIG. 11A) to schedule a recording of a future program with its EPG data through an interactive EPG interface at step 1404. At step 1406, the recording manager 1318 in FIG. 13 then prepares a scheduled recording of the program wherein a start time and duration of the scheduled recording are set to a start time and duration of the program in the EPG table, respectively. At step 1408, the EPG table is checked if the start time and duration are updated. If updated, the recording manager 1318 in FIG. 13 adjusts the scheduled recording time in the recording time table 1328 in FIG. 13 using the updated EPG table at step 1408. Otherwise the process goes to step 1411 to obtain the current time from the time-of-day clock 1330 in FIG. 13 at step 1411. A check 1412 is made to determine if a current time reaches the start time of the scheduled recording. If the current time reaches the scheduled start time, the scheduled recording starts at step 1414. It is preferable to record the broadcast MPEG-2 TS including AV stream and STT (or TDT for DVB) as it is broadcast. Otherwise, a control goes back to check 1408. A check 1416 is made by the EUMU 1316 in FIG. 13 to determine if the start time and duration of the program in the EPG table is updated. If updated, the recording manager 1318 in FIG. 13 stores the updated start time and duration into the recording time table 1328 in FIG. 13 at step 1418. The current time is obtained from the time-of-day clock 1330 in FIG. 13 at step 1420, and then a check 1422 is made by the recording manager 1318 to determine if the current time reaches the updated end time of the recording. If the current time reaches the updated end time, the scheduled recording stops at step 1424. Otherwise, a control goes back to check 1412 and continues to recording. At step 1426, the EUMU 1316 in FIG. 13 continues to check if the start time and duration of the program in the EPG table are updated after the recording of the program ended. If updated, the recording manager 1318 in FIG. 13 stores the updated start time and duration into the recording time table 1328 in FIG. 13.

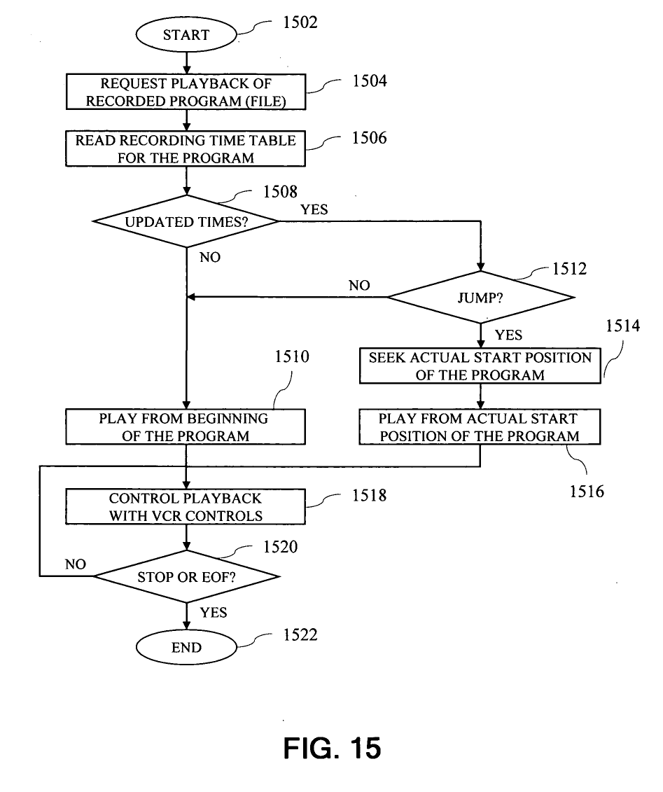

FIG. 15 is an exemplary flowchart illustrating a playback process of a recorded program when the scheduled start time and duration of the program is updated through EPG after the recording starts or ends, according to an embodiment of the present disclosure. Referring to FIGS. 11A, 13 and 15, the playback process starts at step 1502. A user requests the client system 1302 in FIG. 13 (that correlates to an element 1120 in FIG. 11A) to play back a recorded program by selecting the program (that is stored as a transport stream file in storage 1322 in FIG. 13) in a list of recorded programs at step 1504. At step 1506, the media locator processing unit 1320 in FIG. 13 reads the actual start time and duration of the selected program from the recording time table 1328 in FIG. 13. A check 1508 is made to determine if the start time and duration was updated, for example, by checking if the scheduled recording start time/duration and the actual start time/duration of the program are different. If not updated, the playback will start from the beginning of a file correspond to the program at step 1510. If updated, another check 1512 is then made to determine if the user wants to play directly from the actual start time of the program. The check can be implemented by asking the user if the user wants to jump to an actual start position of the program without playing a leading segment irrelevant to the program by displaying a pop-up window to output device 1312 in FIG. 13. If the user does not want to jump the actual start position, a control goes to step 1510 where the program is played from the beginning of the file. Otherwise, at step 1514, the media locator processing unit 1320 in FIG. 13 obtains the actual start byte position in the file, by seeking the position of the recorded MPEG-2 TS stream of the program matching the value of STT (and PTS if frame accuracy is needed) representing the updated or actual start time. The media locator processing unit 1320 in FIG. 13 then allows the user to play the program from the actual start position in the file at step 1516. After the file is played at either step 1510 or 1516, the user might control the playback with various VCR controls such as fast forward, rewind, pause and stop at step 1518. A check 1520 is made to determine if the VCR control is STOP or the playback reaches an end of the file. If it is not true, the control goes to step 1518 again where the user can do another VCR control. Otherwise, the process will stop at step 1522. Note that the user can configure the client system 1302 in FIG. 13 to always play back recorded programs directly from their actual start times if available. In this case, the check 1512 might be skipped.

It will be apparent to those skilled in the art that various modifications and variation can be made to the techniques described in the present disclosure. Thus, it is intended that the present disclosure covers the modifications and variations of the techniques, provided that they come within the scope of the appended claims and their equivalents.

What is claimed is:

1. A method of listing and navigating multiple video streams, comprising:
generating poster-thumbnails of the video streams, wherein a poster-thumbnail comprises a thumbnail image and one or more associated data which is presented in conjunction with the thumbnail image; and
presenting the poster-thumbnails of the video streams;
wherein the one or more associated data is positioned on or near the thumbnail image.

2. The method of claim 1 wherein generating poster-thumbnails of the video streams further comprises:
generating a thumbnail image of a given one of the video streams;
obtaining one or more associated data related to the given one of the video streams; and
combining the one or more associated data with the thumbnail image of the given one of the video streams.

3. The method of claim 2, wherein a pixel height of the thumbnail image is selected from the group consisting of (i) ⅛ (one eighth) or ¼ (one fourth) of the pixel height of a full frame image for the video stream broadcast with 1080i(p) digital TV format and (ii) ¼ (one fourth) of a pixel height of a full frame image for the video stream broadcast with 720p digital TV format.

4. The method of claim 2 wherein generating a thumbnail image of a given one of the video streams comprises:
generating at least one key frame of the given one of the video streams; and
manipulating the at least one key frame.

5. The method of claim 4 wherein, for a given key frame, manipulating the key frame comprises a combination of one or more of analysis, cropping, resizing and visually enhancing the key frame.

6. The method of claim 1, wherein the video streams comprise TV programs selected from the group consisting of TV programs being broadcast and TV programs recorded in a DVR.

7. The method of claim 6, wherein the one or more associated data for the TV programs is selected from the group consisting of EPG data, channel logo and a symbol of the program.

8. The method of claim 1 wherein, the one or more associated data comprises textual information, and presenting the textual information further comprises:
determining font properties of the textual information;
determining a position for presenting the textual information with the thumbnail image; and
presenting the textual information with the thumbnail image.

9. The method of claim 1, wherein an aspect ratio of width to height for a thumbnail image is selected from a group of aspect ratios which are smaller than 1:0.6 and at least 1:1.2.

10. The method of claim 1, wherein presenting poster-thumbnails of the video streams further comprises:
displaying the poster-thumbnail images for user selection of a video stream; and
providing a GUI for the user to browse multiple video streams.

11. The method of claim 10 wherein displaying the poster-thumbnails of the video streams for user selection of a video stream comprises displaying selected from the group consisting of displaying thinner-looking poster-thumbnails of the video streams on a single window and displaying wider-looking poster-thumbnails of the video streams on a single window.

12. The method of claim 10, wherein:
poster-thumbnails and one animated thumbnail or small-sized video with cursor indicator are listed on a single window.

13. The method of claim 10, wherein:
a poster-thumbnail changes to an animated thumbnail when the poster-thumbnail is selected by a user, and is displayed at the same position as its corresponding poster-thumbnail.

14. The method of claim 13, wherein:
the animated thumbnail displays images or frames that are scaled down in size from the video stream while maintaining it's original aspect ratio.

15. Apparatus for listing and navigating multiple video streams, comprising:
means for generating poster-thumbnails of the video streams, wherein a poster-thumbnail comprises a thumbnail image and one or more associated data which is presented in conjunction with the thumbnail image; and
means for presenting the poster-thumbnails of the video streams;
wherein the one or more associated data is selected from the group consisting of textual information, graphic information, iconic information, and audio; and
wherein the one or more associated data is positioned on or near the thumbnail image.

16. The apparatus of claim 15, wherein the video streams comprise TV programs selected from the group consisting of TV programs being broadcast and TV programs recorded in a DVR.

17. The apparatus of claim 15, wherein the one or more associated data for the TV program is selected from the group consisting of EPG data, channel logo and a symbol of the program.

18. A system for listing and navigating multiple video streams, comprising:
a poster thumbnail generator for generating poster/animated thumbnails of the video streams;
means for storing the multiple video streams; and
a display device for presenting the poster thumbnails.

19. The system of claim 18, wherein the poster/animated thumbnail generator comprises:
a thumbnail generator for generating thumbnail images;
an associated data analyzer for obtaining one or more associated data; and
a combiner for combining the one or more associated data with the thumbnail images.

20. The system of claim 19, wherein the thumbnail generator further comprises:
a key frame generator for generating at least one key frame representing a given one of the video streams; and
further comprising one or more modules selected from the group consisting of:
an image analyzer for analyzing the at least one key frame;
an image cropper for cropping the at least one key frame;
an image resizer for resizing the at least one key frame; and
an image post-processor for visually enhancing the at least one key frame.

21. The system of claim 19, wherein the combiner further comprises:
means for combining, selected from the group consisting of adding, overlaying, and splicing the one or more associated data on or near the thumbnail image.

22. The system of claim 18, wherein the display device for presenting the poster thumbnails further comprises:
means for displaying the poster-thumbnail images for user selection of a video stream; and
means for providing a GUI for the user to browse multiple video streams.
